(19) United States
(12) Patent Application Publication
(10) Pub. No.: US 2025/0303733 A1
(43) Pub. Date: Oct. 2, 2025

(54) FLUID DISCHARGE DEVICE

(71) Applicant: SEIKO EPSON CORPORATION, Tokyo (JP)

(72) Inventors: Masaru KOBASHI, MATSUMOTO-SHI (JP); Yuki HIRABAYASHI, SHIOJIRI-SHI (JP); Tomohiro KAWASAKI, SHIOJIRI-SHI (JP)

(21) Appl. No.: 19/091,198

(22) Filed: Mar. 26, 2025

(30) Foreign Application Priority Data
Mar. 27, 2024 (JP) 2024-051312
Jun. 5, 2024 (JP) 2024-091544
Jun. 5, 2024 (JP) 2024-091545
Jun. 5, 2024 (JP) 2024-091546

(51) Int. Cl. B41J 2/175

(52) U.S. Cl. CPC B41J 2/17596

(57) ABSTRACT

A fluid discharge device includes a first pressure adjustment valve provided in a first fluid channel and a second pressure adjustment valve provided in a second fluid channel. The first pressure adjustment valve is switchable between a first adjustment state in which a pressure downstream of the first pressure adjustment valve in the first fluid channel is adjusted to a first set pressure, and a first open state in which the pressure downstream of the first pressure adjustment valve is adjusted to a pressure higher than the first set pressure by maintaining the first fluid channel in an open state, and the second pressure adjustment valve is switchable between a second adjustment state in which a pressure upstream of the second pressure adjustment valve in the second fluid channel is adjusted to a second set pressure, and a second open state in which the pressure upstream of the second pressure adjustment valve is adjusted to a pressure lower than the second set pressure by maintaining the second fluid channel in an open state.

The present application is based on, and claims priority from JP Application Serial Number 2024-091544, filed Jun. 5, 2024, from JP Application Serial Number 2024-051312, filed Mar. 27, 2024, from JP Application Serial Number 2024-091545, filed Jun. 5, 2024, and from JP Application Serial Number 2024-091546, filed Jun. 5, 2024, the disclosure of which are hereby incorporated by reference herein in its entirety.

### BACKGROUND

### 1. Technical Field

The present disclosure relates to a fluid discharge device.

### 2. Related Art

For example, as disclosed in JP-A-2012-86535, there is a printer which is an example of a liquid discharge device that prints by discharging an ink, which is an example of a liquid, from a recording head which is an example of a liquid discharge unit. The printer includes a pressure control valve which is an example of a valve mechanism. The pressure control valve includes a valve chamber, a pressure chamber, an on-off valve, and an elastic partition wall.

An ink supplied from an ink cartridge, which is an example of a liquid storage portion, is sent to the valve chamber. When a pressure in the pressure chamber decreases, the elastic partition wall is deformed to open the on-off valve. When the on-off valve opens, a liquid flows from the valve chamber to the pressure chamber, and the liquid is sent from the pressure chamber to the recording head. At this time, an output pressure of the pressure control valve is adjusted to a set pressure necessary for the recording head. When the recording head is adjusted to a negative set pressure, for example, ink droplets can be appropriately discharged from a nozzle of the recording head.

The pressure control valve disclosed in JP-A-2012-86535 has a problem that, since the output pressure is adjusted to the set pressure, the output pressure cannot be changed from the set pressure when it is desired to change the output pressure according to a control state.

### SUMMARY

A valve mechanism that solves the above problem include: an upstream chamber into which a fluid flows via an inflow port; a downstream chamber that is located downstream of the upstream chamber and communicates with the upstream chamber via a communication port; an air chamber that can communicate with an external space; a first flexible film that separates the downstream chamber and the air chamber from each other; a second flexible film that separates the upstream chamber and the downstream chamber from each other; an opening and closing portion that can open and close the communication port; and a biasing portion that biases the first flexible film in a direction in which a volume of the downstream chamber decreases. The opening and closing portion is provided across the upstream chamber and the downstream chamber and has a shaft portion that is movable following a displacement of the first flexible film and the second flexible film, and a valve portion that is coupled to the shaft portion and opens and closes the communication port.

A valve mechanism that solves the above problem includes: an upstream chamber into which a fluid flows via an inflow port; a downstream chamber that is located downstream of the upstream chamber and communicates with the upstream chamber via a communication port; an air chamber that can communicate with an external space; a first flexible film that separates the upstream chamber and the air chamber from each other; a second flexible film that separates the upstream chamber and the downstream chamber from each other; an opening and closing portion that can open and close the communication port; and a biasing portion that biases the first flexible film in a direction in which a volume of the upstream chamber is increased. The opening and closing portion is provided across the upstream chamber and the downstream chamber and has a shaft portion that is movable following a displacement of the first flexible film and the second flexible film, and a valve portion that is coupled to the shaft portion and opens and closes the communication port.

A valve mechanism that solves the above problem includes: an upstream chamber into which a fluid flows via an inflow port; a downstream chamber that is located downstream of the upstream chamber and communicates with the upstream chamber via a communication port; an air chamber that can communicate with an external space; a first flexible film that separates the downstream chamber and the air chamber from each other; a second flexible film that separates the upstream chamber and the downstream chamber from each other; an opening and closing portion that can open and close the communication port; and a biasing portion that biases the first flexible film in a direction in which a volume of the downstream chamber is increased. The opening and closing portion is provided across the upstream chamber and the downstream chamber and has a shaft portion that is movable in response to a displacement of the first flexible film and the second flexible film, and a valve portion that is coupled to the shaft portion and opens and closes the communication port.

A valve mechanism that solves the above problem includes: an upstream chamber into which a fluid flows via an inflow port; a downstream chamber that includes a first flexible film and that is located downstream of the upstream chamber and communicates with the upstream chamber via a communication port; a second flexible film that separates the upstream chamber and the downstream chamber from each other; an opening and closing portion that can open and close the communication port; and a biasing portion that biases the first flexible film in a direction in which a volume of the downstream chamber decreases. The opening and closing portion is provided across the upstream chamber and the downstream chamber and has a shaft portion that is movable in response to a displacement of the first flexible film and the second flexible film, and a valve portion that is coupled to the shaft portion and opens and closes the communication port, and the opening and closing portion has a magnetic force.

A valve mechanism that solves the above problem includes: an upstream chamber that includes a first flexible film and into which a fluid flows via an inflow port; a downstream chamber that is located downstream of the upstream chamber and communicates with the upstream chamber via a communication port; a second flexible film that separates the upstream chamber and the downstream chamber from each other; an opening and closing portion that can open and close the communication port; and a biasing portion that biases the first flexible film in a direction in which a volume of the upstream chamber is increased. The opening and closing portion includes a shaft portion that is provided across the upstream chamber and the downstream chamber and is movable following displacement of the first flexible film and the second flexible film, and a valve portion that is coupled to the shaft portion and opens and closes the communication port, and the opening and closing portion has a magnetic force.

A valve mechanism that solves the above problem includes: an upstream chamber into which a fluid flows via an inflow port; a downstream chamber that includes a first flexible film and that is located downstream of the upstream chamber and communicates with the upstream chamber via a communication port; a second flexible film that separates the upstream chamber and the downstream chamber from each other; an opening and closing portion that can open and close the communication port; and a biasing portion that biases the first flexible film in a direction in which a volume of the downstream chamber is increased. The opening and closing portion is provided across the upstream chamber and the downstream chamber and has a shaft portion that is movable following a displacement of the first flexible film and the second flexible film, and a valve portion that is coupled to the shaft portion and opens and closes the communication port, and the opening and closing portion has a magnetic force.

A fluid flow device that solves the above problem includes: the above valve mechanism; a fluid storage portion that stores a fluid; a fluid channel coupled to the fluid storage portion and provided with the valve mechanism; a pressure varying mechanism that varies a pressure of the fluid flowing through the fluid channel; and a pressure generating unit that applies a pressure into the air chamber.

A fluid flow device that solves the above problem includes: the above valve mechanism; a fluid storage portion that stores a fluid; a fluid channel coupled to the fluid storage portion and provided with the valve mechanism; a pressure varying mechanism that varies a pressure of the fluid flowing through the fluid channel; and a magnetic force generating portion that applies a magnetic force to the opening and closing portion.

A fluid discharge device that solves the above problem includes: the above fluid flow device, and a fluid discharge unit provided in the fluid channel.

A fluid discharge device that solves the above problem includes: the above fluid flow device; and a fluid discharge unit capable of discharging the fluid. The fluid channel includes a first fluid channel having a downstream end coupled to the fluid discharge unit and a second fluid channel having an upstream end coupled to the fluid discharge unit, the first valve mechanism is located in the first fluid channel, and the second valve mechanism is located in the second fluid channel.

A fluid discharge device that solves the above problem includes: a fluid discharge unit that discharges a fluid; a first fluid storage portion that stores the fluid; a second fluid storage portion that stores the fluid; a first fluid channel that couples the first fluid storage portion and the fluid discharge unit; a second fluid channel that couples the second fluid storage portion and the fluid discharge unit; a pressure varying mechanism that varies a pressure of the fluid stored in the first fluid storage portion and the second fluid storage portion; a first pressure adjustment valve provided in the first fluid channel; and a second pressure adjustment valve provided in the second fluid channel; and a switching unit capable of switching states of the first pressure adjustment valve and the second pressure adjustment valve. The first pressure adjustment valve is switchable between a first adjustment state in which a pressure downstream of the first pressure adjustment valve in the first fluid channel path is adjusted to a first set pressure, and a first open state in which the pressure downstream of the first pressure adjustment valve is adjusted to a pressure higher than the first set pressure by maintaining a state in which the first fluid channel is opened, and the second pressure adjustment valve is switchable between a second adjustment state in which a pressure upstream of the second pressure adjustment valve in the second fluid channel is adjusted to a second set pressure, and a second open state in which the pressure upstream of the second pressure adjustment valve is adjusted to a pressure lower than the second set pressure by maintaining a state in which the second fluid channel is opened.

### BRIEF DESCRIPTION OF THE DRAWINGS

FIG. 1 is a schematic diagram of a liquid discharge device according to a first embodiment.

FIG. 2 is a schematic diagram showing a first valve mechanism that opens and closes by an air pressure.

FIG. 3 is a schematic diagram showing a second valve mechanism that opens and closes by the air pressure.

FIG. 4 is a schematic diagram showing a detailed configuration of a pressure varying mechanism and a switching unit.

FIG. 5 is a schematic diagram showing main parts of the liquid discharge device during normal circulation.

FIG. 6 is a schematic diagram showing main parts of the liquid discharge device during standby and stop.

FIG. 7 is a schematic diagram showing main parts of the liquid discharge device when a power supply is turned off.

FIG. 8 is a schematic diagram showing main parts of the liquid discharge device during cleaning.

FIG. 9 is a schematic diagram showing main parts of the liquid discharge device during a liquid removal in a liquid discharge unit.

FIG. 10 is a schematic diagram showing main parts of the liquid discharge device when air bubbles are discharged by forced circulation.

FIG. 11 is a schematic diagram of a liquid discharge device according to a second embodiment.

FIG. 12 is a schematic diagram showing a first valve mechanism that opens and closes by a magnetic force.

FIG. 13 is a schematic diagram showing a second valve mechanism that opens and closes by the magnetic force.

FIG. 14 is a schematic diagram showing a first valve mechanism that opens and closes by an electromagnetic force.

FIG. 15 is a schematic diagram showing a second valve mechanism that opens and closes by the electromagnetic force.

FIG. 16 is a schematic diagram of a liquid discharge device according to a third embodiment.

FIG. 17 is a schematic diagram showing a detailed configuration of a pressure varying mechanism and a switching unit.

FIG. 18 is a schematic diagram showing main parts of the liquid discharge device during normal circulation.

FIG. 19 is a schematic diagram showing main parts of the liquid discharge device during standby and stop.

FIG. 20 is a schematic diagram showing main parts of the liquid discharge device when a power supply is turned off.

FIG. 21 is a schematic diagram showing main parts of the liquid discharge device during cleaning.

FIG. 22 is a schematic diagram showing main parts of the liquid discharge device during cleaning.

FIG. 23 is a schematic diagram showing main parts of the liquid discharge device during a liquid removal in a liquid discharge unit.

FIG. 24 is a schematic diagram showing main parts of the liquid discharge device that performs liquid removal from within a liquid discharge unit by a reverse flow.

FIG. 25 is a schematic diagram showing main parts of the liquid discharge device that performs the liquid removal from within liquid discharge unit in both forward and reverse flows.

FIG. 26 is a schematic diagram showing main parts of the liquid discharge device when air bubbles are discharged by forced circulation.

FIG. 27 is a schematic diagram showing main parts of the liquid discharge device when air bubbles are discharged by forced circulation with a reverse flow.

FIG. 28 is a schematic diagram of a liquid discharge device according to a fourth embodiment.

FIG. 29 is a schematic diagram showing a third valve mechanism that opens and closes by the air pressure.

FIG. 30 is a schematic diagram showing a liquid discharge device according to a first modification.

FIG. 31 is a schematic diagram showing a liquid discharge device according to a second modification.

FIG. 32 is a schematic diagram showing a liquid discharge device according to a third modification.

FIG. 33 is a schematic diagram showing a liquid discharge device according to a fourth modification.

FIG. 34 is a schematic diagram showing a liquid discharge device during filter cleaning.

FIG. 35 is a schematic diagram showing a detailed configuration of a switching unit according to a fifth modification.

FIG. 36 is a schematic diagram showing a third valve mechanism that opens and closes by a magnetic force according to a sixth modification.

FIG. 37 is a schematic diagram showing a third valve mechanism that opens and closes by an electromagnetic force according to a seventh modification.

FIG. 38 is a schematic diagram showing a fourth valve mechanism that opens and closes by the air pressure according to an eighth modification.

### DESCRIPTION OF EMBODIMENTS

### First Embodiment

Hereinafter, a valve mechanism, a fluid flow device, and a fluid discharge device according to a first embodiment will be described with reference to the drawings. The fluid discharge device is, for example, an inkjet printer that discharges ink, which is an example of a fluid, onto a medium such as paper, fabric, vinyl, plastic components, or metal components to perform printing.

In the drawings, assuming that a liquid discharge device 11 is placed on a horizontal plane, a direction of gravity is represented by a Z axis, and directions along the horizontal plane are represented by an X axis and a Y axis. The X axis, the Y axis, and the Z axis are orthogonal to one another. In the following description, the direction parallel to the Z axis is also referred to as a vertical direction Z.

### Liquid Discharge Device 11

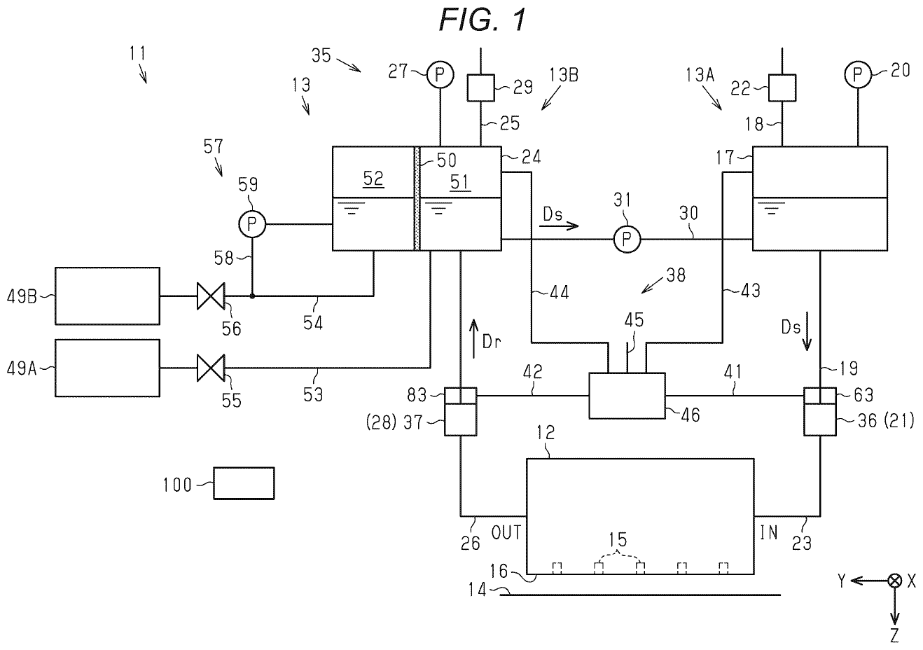

As shown in FIG. 1, the liquid discharge device 11 as an example of a fluid discharge device includes a liquid discharge unit 12 as an example of a fluid discharge unit and a liquid flowing device 13 as an example of a fluid flow device. The present embodiment is an example in which a fluid discharged by the fluid discharge device and a fluid caused to flow by the fluid flow device are liquids.

The liquid discharge unit 12 can discharge a liquid. The liquid discharge unit 12 is formed to discharge a liquid onto a medium 14. The liquid discharge unit 12 has a nozzle surface 16 in which one or more nozzles 15 open. The liquid discharge unit 12 discharges a liquid from the nozzle 15. An inside of the liquid discharge unit 12 is usually maintained at a negative pressure. This is to form a meniscus in the nozzle 15. Accordingly, the liquid discharge unit 12 can appropriately discharge the liquid. A leakage of the liquid from the nozzle 15 can be prevented.

### Liquid Flowing Device

The liquid flowing device 13 is a device that flows a liquid in a channel passing through the liquid discharge unit 12. The liquid flowing device 13 according to the embodiment may include a first liquid flowing portion 13A for flowing the liquid supplied to the liquid discharge unit 12, and a second liquid flowing portion 13B for flowing the liquid collected from the liquid discharge unit 12. The liquid flowing device 13 may supply the liquid to the liquid discharge unit 12 and collect the liquid from the liquid discharge unit 12 by causing the liquid to flow.

The liquid flowing device 13 includes a pressure varying mechanism 35. The pressure varying mechanism 35 varies a pressure of the liquid flowing through a liquid channel 19. Hereinafter, the first liquid flowing portion 13A and the second liquid flowing portion 13B will be described in order.

### Configuration of First Liquid Flowing Portion 13A

First, a configuration of the first liquid flowing portion 13A will be described. The first liquid flowing portion 13A includes a liquid storage portion 17 as an example of a fluid storage portion, the liquid channel 19 as an example of a fluid channel, and a first valve mechanism 21 as an example of a valve mechanism. The liquid storage portion 17 stores a fluid. The pressure varying mechanism 35 includes a pressurizing pump 20 that pressurizes the liquid storage portion 17. The pressurizing pump 20 varies a pressure of a liquid by pressurizing the liquid storage portion 17.

The liquid channel 19 is coupled to the liquid storage portion 17. The liquid storage portion 17 stores a liquid to be supplied to the liquid discharge unit 12. In the embodiment, the liquid storage portion 17 is referred to as the first liquid storage portion 17. The first liquid storage portion 17 is, for example, a tank capable of storing a liquid. The tank may be implemented to be capable of replenishing the liquid. The liquid storage portion 17 may include a region in which the liquid is stored and a region of air above the liquid.

The pressurizing pump 20 pressurizes the first liquid storage portion 17. For example, the pressurizing pump 20 may pressurize the inside of the first liquid storage portion 17 by feeding air into the first liquid storage portion 17. When the pressurizing pump 20 pressurizes the inside of the first liquid storage portion 17, the pressurized liquid flows out of the first liquid storage portion 17. That is, the pressurizing pump 20 varies the pressure of the liquid flowing through the first liquid channel 23 by increasing the pressure.

The pressure varying mechanism 35 may include a pressure release valve 22. The pressure release valve 22 is provided in a gas channel 18 coupled to the first liquid storage portion 17. The pressure release valve 22 communicates with an air region in the first liquid storage portion 17. When the pressure in the first liquid storage portion 17 exceeds a predetermined positive pressure, the pressure release valve 22 releases an air pressure, thereby adjusting the inside of the first liquid storage portion 17 to a predetermined positive pressure. The air and the liquid in the first liquid storage portion 17 are maintained at a constant positive pressure.

The liquid discharge unit 12 is provided in the liquid channel 19 through which the liquid flows. The liquid channel 19 couples the first liquid storage portion 17 and the liquid discharge unit 12. The liquid in the first liquid storage portion 17 is supplied to the liquid discharge unit 12 through the liquid channel 19.

In the liquid channel 19, a direction in which the liquid flows from the liquid storage portion 17 toward the liquid discharge unit 12 is defined as a supply direction Ds. The liquid channel 19 has an upstream end in the supply direction Ds coupled to the liquid storage portion 17. The liquid channel 19 has a first liquid channel 23 whose downstream end in the supply direction Ds is coupled to the liquid discharge unit 12. The first liquid channel 23 couples the first liquid storage portion 17 and the liquid discharge unit 12.

The first valve mechanism 21 is provided in the liquid channel 19. The first valve mechanism 21 is located in the first liquid channel 23. The first valve mechanism 21 is located between the liquid storage portion 17 and the liquid discharge unit 12 in the liquid channel 19, and opens and closes the liquid channel 19. That is, the first valve mechanism 21 opens and closes the first liquid channel 23. The first valve mechanism 21 is a pressure adjustment valve 36 that adjusts the pressure of the liquid supplied to the liquid discharge unit 12. In the embodiment, the pressure adjustment valve 36 is a first pressure adjustment valve 36. The first pressure adjustment valve 36 is implemented by the first valve mechanism 21. The first pressure adjustment valve 36 provided in the first liquid channel 23 adjusts an output pressure so that the inside of the liquid discharge unit 12 becomes a set positive pressure. The first pressure adjustment valve 36 has an air chamber 63.

The pressurizing pump 20 pressurizes the liquid in the first liquid storage portion 17. The pressurization causes the liquid flowing through the liquid channel 19 from the first liquid storage portion 17 toward the liquid discharge unit 12 to be pressurized.

### Configuration of Second Liquid Flowing Device 13B

Next, a configuration of the second liquid flowing portion 13B will be described. The second liquid flowing portion 13B includes a liquid storage portion 24 which is an example of the fluid storage portion, the liquid channel 19, and a second valve mechanism 28 which is an example of the valve mechanism. The liquid storage portion 24 stores a liquid. The pressure varying mechanism 35 includes a depressurizing pump 27 that depressurizes the liquid storage portion 24. The depressurizing pump 27 varies a pressure of a liquid by depressurizing the liquid storage portion 24.

The liquid channel 19 is coupled to the liquid storage portion 24. The liquid storage portion 24 stores the liquid collected from the liquid discharge unit 12. In the embodiment, the liquid storage portion 24 is referred to as a second liquid storage portion 24. The second liquid storage portion 24 is, for example, a tank capable of storing a liquid. The tank may be implemented to be capable of replenishing the liquid. The second liquid storage portion 24 may include a region in which the liquid is stored and a region of air above the liquid.

The liquid channel 19 according to the embodiment couples the liquid discharge unit 12 and the second liquid storage portion 24. That is, the liquid channel 19 couples the first liquid storage portion 17, the liquid discharge unit 12, and the second liquid storage portion 24. In the liquid channel 19 according to the embodiment, the liquid supplied from the first liquid storage portion 17 to the liquid discharge unit 12 flows, and the liquid collected from the liquid discharge unit 12 to the second liquid storage portion 24 flows.

The liquid channel 19 has a second liquid channel 26 whose upstream end is coupled to the liquid discharge unit 12. The liquid channel 19 includes the first liquid channel 23 and the second liquid channel 26. The second liquid channel 26 couples the second liquid storage portion 24 and the liquid discharge unit 12. In the liquid channel 19, a direction in which the liquid flows from the liquid discharge unit 12 toward the liquid storage portion 24 is referred to as a collection direction Dr. The upstream end of the second liquid channel 26 in the collection direction Dr is coupled to the liquid discharge unit 12. The downstream end of the second liquid channel 26 in the collection direction Dr is coupled to the second liquid storage portion 24. The second liquid channel 26 allows the liquid to flow as it is collected from the liquid discharge unit 12 to the second liquid storage portion 24.

The second valve mechanism 28 is provided in the liquid channel 19. The second valve mechanism 28 is located in the second liquid channel 26. The second valve mechanism 28 is located between the liquid storage portion 24 and the liquid discharge unit 12 in the liquid channel 19, and opens and closes the liquid channel 19. That is, the second valve mechanism 28 opens and closes the second liquid channel 26. The second valve mechanism 28 functions as a negative pressure adjustment valve that adjusts the pressure of the liquid discharge unit 12 located on the upstream side to a negative pressure. The second valve mechanism 28 is a pressure adjustment valve 37 that adjusts the pressure of the liquid in the liquid discharge unit 12. In the embodiment, the pressure adjustment valve 37 is a second pressure adjustment valve 37. The second pressure adjustment valve 37 provided in the second liquid channel 26 is implemented by the second valve mechanism 28. The second pressure adjustment valve 37 is provided in the second liquid channel 26. The second pressure adjustment valve 37 provided in the second liquid channel 26 adjusts the output pressure so that the inside of the liquid discharge unit 12 becomes a set negative pressure. The second pressure adjustment valve 37 has an air chamber 83.

The pressure varying mechanism 35 may include the depressurizing pump 27. The depressurizing pump 27 varies the pressure of the liquid stored in the second liquid storage portion 24 to a negative pressure. The depressurizing pump 27 varies the pressure of the liquid flowing through the second liquid channel 26 to a negative pressure. The depressurizing pump 27 depressurizes the second liquid storage portion 24. For example, the depressurizing pump 27 may depressurize the inside of the second liquid storage portion 24 by discharging air from the inside of the second liquid storage portion 24.

The pressure varying mechanism 35 may include a negative pressure release valve 29. The negative pressure release valve 29 is provided in a gas channel 25 coupled to the second liquid storage portion 24. The negative pressure release valve 29 communicates with an air region in the second liquid storage portion 24. When the pressure in the second liquid storage portion 24 exceeds a predetermined negative pressure to a negative side, the negative pressure release valve 29 releases the air pressure, thereby adjusting the pressure inside the second liquid storage portion 24 to a predetermined negative pressure. The air and the liquid in the second liquid storage portion 24 are maintained at a constant negative pressure.

The pressure varying mechanism 35 shown in FIG. 1 varies the pressure of the liquid stored in each of the first liquid storage portion 17 and the second liquid storage portion 24.

The pressurizing pump 20 is also used to generate a positive pressure to be supplied to the air chambers 63 and 83 of the first valve mechanism 21 and the second valve mechanism 28. The depressurizing pump 27 is also used to generate a negative pressure to be supplied to the air chambers 63 and 83 of the first valve mechanism 21 and the second valve mechanism 28. The pressurizing pump 20 and the depressurizing pump 27 have a pressure varying function of pressurizing and depressurizing of the liquid and a pressure generating function of generating a positive pressure and a negative pressure to be supplied to the air chambers 63 and 83. As described above, in the embodiment, the pressurizing pump 20 and the depressurizing pump 27 serve as the pressure varying mechanism 35 and a pressure generating unit.

The liquid flowing device 13 may include a coupling channel 30 and a liquid sending portion 31. The coupling channel 30 couples the second liquid storage portion 24 and the first liquid storage portion 17. The liquid sending portion 31 is provided in the coupling channel 30. The liquid sending portion 31 sends the liquid in the supply direction Ds from the second liquid storage portion 24 toward the first liquid storage portion 17 through the coupling channel 30.

The liquid discharge device 11 according to the embodiment employs a liquid circulation system. The liquid flowing device 13 can circulate the liquid in the supply direction Ds through a path passing through the liquid channel 19 and the coupling channel 30. That is, it is possible to circulate the liquid in a path passing through the liquid discharge unit 12. The liquid circulation has a stirring effect due to the flow of the liquid. Even when the ink, which is an example of the liquid, includes, for example, a type of ink (for example, a pigment ink) including particles of a pigment or the like that easily precipitates, it is possible to prevent the precipitation of the particles in the liquid. A liquid circulation system may be employed for another purpose other than preventing the precipitation of particles in the liquid. The purpose of the liquid circulation may be, for example, to keep the liquid warm or to remove a foreign matter from the liquid.

### Switching Unit

As shown in FIG. 1, the liquid discharge device 11 includes a switching unit 38. The switching unit 38 is implemented to switch states of the first pressure adjustment valve 36 and the second pressure adjustment valve 37. The states of the first pressure adjustment valve 36 and the second pressure adjustment valve 37 are switched by the pressure acting on the switching unit 38.

The first pressure adjustment valve 36 can be switched between a first adjustment state and a first open state by the switching unit 38. In the first adjustment state, the pressure downstream of the first pressure adjustment valve 36 in the first liquid channel 23 is adjusted to a first set pressure. In the first open state, the pressure downstream of the first pressure adjustment valve 36 is adjusted to a pressure higher than the first set pressure by maintaining the open state of the first liquid channel 23. Here, in the first open state, a flow rate of the liquid flowing through the first liquid channel 23 is also adjusted by maintaining the open state of the first liquid channel 23. The first pressure adjustment valve 36 may be switchable to a first closed state in which a closed state of the first liquid channel 23 is maintained. In the first closed state, the flow rate of the liquid flowing through the first liquid channel 23 is adjusted to zero by maintaining the closed state of the first liquid channel 23.

The second pressure adjustment valve 37 can be switched between a second adjustment state and a second open state by the switching unit 38. In the second adjustment state, the pressure upstream of the second pressure adjustment valve 37 in the second liquid channel 26 is adjusted to a second set pressure. In the second open state, the pressure upstream of the second pressure adjustment valve 37 is adjusted to a pressure lower than the second set pressure by maintaining the open state of the second liquid channel 26. Here, in the second open state, a flow rate of the liquid flowing through the second liquid channel 26 is also adjusted by maintaining the open state of the second liquid channel 26. The second pressure adjustment valve 37 may be switchable to a second closed state in which a closed state of the second liquid channel 26 is maintained. In the second closed state, the flow rate of the liquid flowing through the second liquid channel 26 is adjusted to zero by maintaining the closed state of the second liquid channel 26.

The switching unit 38 includes a first gas channel 41, a second gas channel 42, a third gas channel 43, a fourth gas channel 44, and a switching mechanism 46. The switching unit 38 may include a fifth gas channel 45.

The first gas channel 41 is coupled to the first pressure adjustment valve 36. The second gas channel 42 is coupled to the second pressure adjustment valve 37. A pressurized gas flows through the third gas channel 43. A gas pressurized by the pressurizing pump 20 may flow through the third gas channel 43. A depressurized gas flows through the fourth gas channel 44. A gas depressurized by the depressurizing pump 27 may flow through the fourth gas channel 44. The fifth gas channel 45 is open to an atmosphere. Air having an atmospheric pressure may flow through the fifth gas channel 45.

The switching mechanism 46 switches a coupling state among the gas channels 41 to 45. The switching mechanism 46 may be a selector valve. A detailed configuration of the switching mechanism 46 will be described later.

The first pressure adjustment valve 36 gets to the first adjustment state when the first gas channel 41 and the fifth gas channel 45 are coupled. That is, when the air chamber 63 is switched to the atmospheric pressure, the first pressure adjustment valve 36 gets to the first adjustment state.

The first pressure adjustment valve 36 gets to the first open state when the first gas channel 41 and the third gas channel 43 are coupled. That is, when the pressure of the air chamber 63 is switched to the positive pressure, the first pressure adjustment valve 36 gets to the first open state.

The first pressure adjustment valve 36 is switchable to the first closed state in which the closed state of the first liquid channel 23 is maintained. The first pressure adjustment valve 36 gets to the first closed state when the first gas channel 41 and the fourth gas channel 44 are coupled. That is, when the air chamber 63 is switched to the negative pressure, the first pressure adjustment valve 36 gets to the first closed state.

The second pressure adjustment valve 37 gets to the second adjustment state when the second gas channel 42 and the fifth gas channel 45 are coupled. That is, when the air chamber 83 is switched to the atmospheric pressure, the second pressure adjustment valve 37 gets to the first adjustment state.

The second pressure adjustment valve 37 gets to the second open state when the second gas channel 42 and the fourth gas channel 44 are coupled. That is, when the air chamber 83 is switched to the negative pressure, the second pressure adjustment valve 37 gets to the second open state.

The second pressure adjustment valve 37 is switchable to the second closed state in which the closed state of the second liquid channel 26 is maintained. The second pressure adjustment valve 37 gets to the second closed state when the second gas channel 42 and the third gas channel 43 are coupled. That is, when the pressure of the air chamber 83 is switched to the positive pressure, the second pressure adjustment valve 37 gets to the second closed state.

### Replenishment of Liquid and Moisture

The liquid flowing device 13 may be coupled to a liquid supply source 49A and a moisture supply source 49B. The moisture supply source 49B accommodates moisture, that is, water. The moisture supply source 49B may be a cartridge, a pack, or the like that is attachable to and detachable from the liquid discharge device 11, or may be a tank capable of replenishing a liquid.

The first liquid storage portion 17 can accommodate a liquid to be supplied to the liquid discharge unit 12. The second liquid storage portion 24 can accommodate the liquid collected from the liquid discharge unit 12.

The second liquid storage portion 24 may include a moisture permeable film 50. The moisture permeable film 50 partitions the inside of the second liquid storage portion 24 into a liquid chamber 51 and a moisturizer chamber 52. The liquid chamber 51 can accommodate a liquid. The liquid is supplied from the liquid supply source 49A to the liquid chamber 51. The moisturizer chamber 52 can accommodate a moisturizer. Moisture is supplied from the moisture supply source 49B to the moisturizer chamber 52.

The moisture permeable film 50 is a film that allows a gas to pass therethrough but does not allow a liquid to pass therethrough. Therefore, the moisture permeable film 50 separates the liquid stored in the liquid chamber 51 and the moisturizer stored in the moisturizer chamber 52 from each other so that the liquid and the moisturizer do not mix with each other. The moisture permeable film 50 is a porous film having a plurality of pores. A meniscus is generated in the pores by a surface tension of the liquid. Accordingly, the moisture permeable film 50 allows the gas to permeate but does not allow the liquid to permeate. The moisturizer moisturizes the liquid by supplying the moisture to the liquid through the moisture permeable film 50.

The liquid flowing device 13 may include a liquid supply channel 53 and a moisture supply channel 54. The liquid supply channel 53 is coupled to the liquid supply source 49A and the liquid chamber 51. The moisture supply channel 54 is coupled to the moisture supply source 49B and the moisturizer chamber 52.

The liquid flowing device 13 may include a liquid supply valve 55 and a moisture supply valve 56. The liquid supply valve 55 is located in the liquid supply channel 53. When the liquid supply valve 55 is opened, the liquid can be supplied from the liquid supply source 49A to the second liquid storage portion 24. The moisture supply valve 56 is located in the moisture supply channel 54. When the moisture supply valve 56 is opened, the moisture can be supplied from the moisture supply source 49B to the second liquid storage portion 24. Normally, the liquid supply valve 55 and the moisture supply valve 56 are closed. The liquid supply valve 55 is opened when it is necessary to supply the liquid to the second liquid storage portion 24. The moisture supply valve 56 is opened when it is necessary to supply the moisture to the second liquid storage portion 24.

The liquid flowing device 13 may include a stirring portion 57. The stirring portion 57 is attached to the second liquid storage portion 24. The stirring portion 57 stirs the moisturizer stored in the moisturizer chamber 52. As the stirring portion 57 stirs the moisturizer, a concentration of the moisturizer is made uniform. Accordingly, an increase in the concentration of the moisturizer is reduced.

The stirring portion 57 may include a stirring channel 58 and a stirring pump 59. The stirring channel 58 is coupled to the moisturizer chamber 52 and the moisture supply channel 54. The stirring pump 59 is located in the stirring channel 58. The stirring pump 59 circulates the moisturizer in the second liquid storage portion 24 through the stirring channel 58. Accordingly, the moisturizer is stirred.

The liquid discharge device 11 includes a control unit 100. The control unit 100 controls the liquid discharge unit 12, the pumps 20, 27, and 59, the liquid sending portion 31, the switching mechanism 46, and the like.

The control unit 100 is not limited to the one that performs software processing for all processing executed by itself. For example, the control unit 100 may include a dedicated hardware circuit (for example, an application specific integrated circuit (ASIC)) that performs hardware processing for at least a part of processing performed by the control unit 100. That is, the control unit 100 may be implemented as circuitry including one or more processors that operate according to a computer program (software), one or more dedicated hardware circuits that execute at least a part of various processing, or a combination thereof. The processor includes a CPU and memories such as a RAM and a ROM. The memories store program codes or commands implemented to cause the CPU to execute the processing. The memory, that is, a computer-readable medium includes any usable medium that can be accessed by a general-purpose or dedicated computer.

### Configuration of First Valve Mechanism

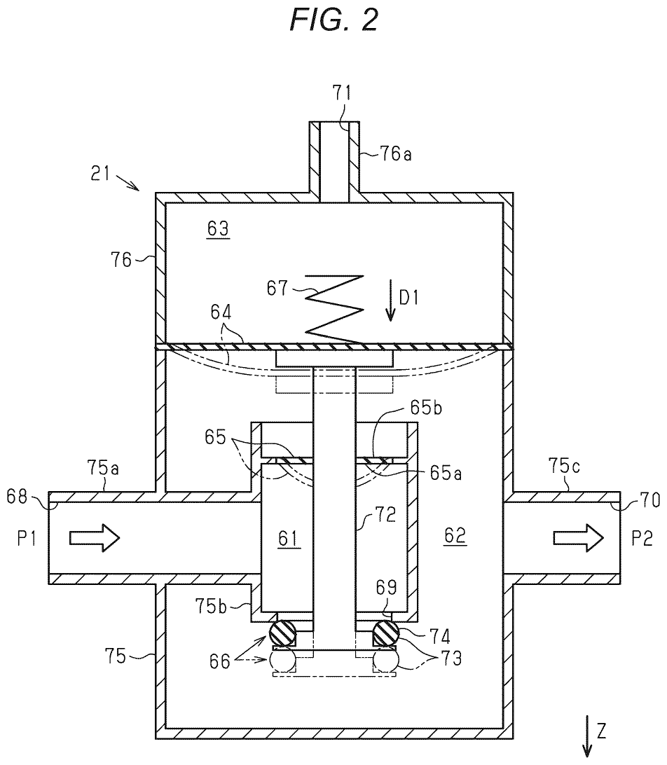

Next, a configuration of the first valve mechanism 21 will be described with reference to FIG. 2. A fluid handled by the first valve mechanism 21 according to the embodiment is a liquid.

As shown in FIG. 2, the first valve mechanism 21 includes a first upstream chamber 61 which is an example of an upstream chamber, a first downstream chamber 62 which is an example of a downstream chamber, and a first air chamber 63 which is an example of an air chamber. The first valve mechanism 21 includes a first flexible film 64, a second flexible film 65, a first opening and closing portion 66 which is an example of an opening and closing portion, and a first biasing portion 67 which is an example of a biasing portion. The first opening and closing portion 66 is movable between a first closed position indicated by a solid line in FIG. 2 and a first open position indicated by a two-dot chain line in FIG. 2. In the embodiment, a state in which the first opening and closing portion 66 is located at the first closed position is also referred to as a first closed state, and a state in which the first opening and closing portion 66 is located at the first open position is also referred to as a first open state. The fluid handled by the first valve mechanism 21 according to the embodiment is, for example, a liquid.

The fluid flows into the first upstream chamber 61 via a first inflow port 68 which is an example of an inflow port.

The first downstream chamber 62 is provided downstream of the first upstream chamber 61. The first downstream chamber 62 communicates with the first upstream chamber 61 via a first communication port 69, which is an example of a communication port, downstream of the first upstream chamber 61. The first downstream chamber 62 allows the fluid to flow out through a first outflow port 70, which is an example of an outflow port. The first outflow port 70 according to the embodiment communicates with the liquid discharge unit 12 via the first liquid channel 23.

The first air chamber 63 is implemented to communicate with an external space. The first air chamber 63 can communicate with the external space via a first ventilation port 71.

The first valve mechanism 21 has a first housing 75 having a cylindrical shape with a bottom and one end open, and a first lid body 76 having a cylindrical shape with a bottom and one end open. The first housing 75 and the first lid body 76 are bonded to each other at their opening side end portions with the first flexible film 64 sandwiched therebetween. The first housing 75 includes a first inflow tube portion 75a, a cylindrical first chamber forming portion 75b, and a first outflow tube portion 75c. The first inflow tube portion 75a communicates with the first chamber forming portion 75b. One opening of the first chamber forming portion 75b is closed by the second flexible film 65, and the other opening forms the first communication port 69.

The first upstream chamber 61 is defined by the first housing 75, the first flexible film 64, and the like. The first downstream chamber 62 is defined by the first chamber forming portion 75b, the second flexible film 65, and the like. The first air chamber 63 is defined by the first lid body 76 and the first flexible film 64. The first lid body 76 has a tube portion 76a that communicates the first air chamber 63 with the external space. The first ventilation port 71 is formed by the tube portion 76a.

The first flexible film 64 separates the first downstream chamber 62 from the first air chamber 63. The first flexible film 64 forms a part of a wall of the first downstream chamber 62. The first flexible film 64 is formed of a flexible member such as a diaphragm. The first flexible film 64 is displaced according to a difference in pressure applied to an outer surface and an inner surface.

The second flexible film 65 separates the first upstream chamber 61 and the first downstream chamber 62. The second flexible film 65 may be located on the first communication port 69. The second flexible film 65 is located between the first communication port 69 and the first flexible film 64.

The first communication port 69, the second flexible film 65, the first flexible film 64, and the first biasing portion 67 may be arranged in this order in a first direction D1. The first direction D1 may be a direction opposite to the vertical direction Z.

The first biasing portion 67 biases the first flexible film 64. The first biasing portion 67 biases the first flexible film 64 in the first direction D1 in which a volume of the first downstream chamber 62 decreases. The first biasing portion 67 is provided outside the first downstream chamber 62. The first biasing portion 67 is, for example, a compression spring.

The first biasing portion 67 may be accommodated in the air chamber 63. The first biasing portion 67 has a first end portion that is in contact with the first flexible film 64, and a second end portion on an opposite side from the first end portion is restricted by a regulating portion (not shown) to be immovable. When the first biasing portion 67 is a compression spring, the first biasing portion 67 is held in a compressed state. Therefore, the first biasing portion 67 presses the first flexible film 64 in a direction in which the volume of the first downstream chamber 62 decreases. The first biasing portion 67 presses the first flexible film 64 in the first direction D1. The first biasing portion 67 applies a force to the first opening and closing portion 66 via the first flexible film 64 in a direction to move the first opening and closing portion 66 from the first closed position indicated by the solid line in FIG. 2 to the first open position indicated by the two-dot chain line in FIG. 2.

A force based on the pressure of the air in the air chamber 63 and a biasing force of the first biasing portion 67 are applied to an outer surface of the first flexible film 64. A force based on the pressure of the fluid in the first downstream chamber 62 is applied to an inner surface of the first flexible film 64.

The first opening and closing portion 66 is implemented to open and close the first communication port 69. The first communication port 69 opens at an end portion of the first upstream chamber 61 on an opposite side from an end portion on the second flexible film 65 side. The first opening and closing portion 66 may include a first shaft portion 72, which is an example of a shaft portion, and a first valve portion 73, which is an example of a valve portion.

The first shaft portion 72 is provided across the first upstream chamber 61 and the first downstream chamber 62. The first shaft portion 72 may be inserted into the second flexible film 65. A longitudinal direction of the first shaft portion 72 may be parallel to the first direction D1. The first shaft portion 72 may have a rod shape. The first shaft portion 72 may have a columnar shape. A diameter of the first shaft portion 72 is smaller than an inner diameter of the first communication port 69.

The first shaft portion 72 is movable following displacements of the first flexible film 64 and the second flexible film 65. The first shaft portion 72 may be fixed to the first flexible film 64 and the second flexible film 65 directly or via a fixing member. One end of the first shaft portion 72 may be coupled to the first flexible film 64. The other end of the first shaft portion 72 may be coupled to the first valve portion 73.

The first valve portion 73 is coupled to the first shaft portion 72. The first valve portion 73 can open and close the first communication port 69. The first valve portion 73 moves together with the first shaft portion 72. The first shaft portion 72 displaces the second flexible film 65 and the first valve portion 73 by moving following the displacement of the first flexible film 64. That is, when the first opening and closing portion 66 moves following the displacement of the first flexible film 64, the first valve portion 73 opens and closes the first communication port 69.

The first valve portion 73 may include a first seal portion 74. The first seal portion 74 can come into close contact with the first communication port 69. The first seal portion 74 forms an outer periphery of the first valve portion 73. The first seal portion 74 may have an annular shape. The first seal portion 74 may be an O-ring having a torus shape.

As shown in FIG. 2, in the first valve mechanism 21, the second flexible film 65 receives a force corresponding to a pressure difference between a first surface 65a and a second surface 65b. The first valve portion 73 receives a force corresponding to a pressure difference between the outer surface and the inner surface. A pressure receiving area of the second flexible film 65 and a pressure receiving area of the first valve portion 73 are substantially equal to each other or a difference therebetween is small. Therefore, a force applied to the second flexible film 65 and a force applied to the first valve portion 73 are substantially offset because the forces are substantially the same in opposite directions.

Therefore, the first opening and closing portion 66 is mainly displaced according to a difference in forces applied to both surfaces of the first flexible film 64. A pressure receiving area where the first flexible film 64 receives the pressure of the fluid in the first downstream chamber 62 is higher than a pressure receiving area where the second flexible film 65 receives the pressure of the fluid in the first downstream chamber 62. Therefore, responsiveness of the opening and closing of the first valve portion 73 with respect to a change in the pressure applied to both surfaces of the first flexible film 64 is high. A force in a direction corresponding to the pressure of the air in the first air chamber 63, a biasing force of the first biasing portion 67 in the first direction D1, and a force in a direction corresponding to the pressure of the fluid in the first downstream chamber 62 are applied to the first flexible film 64. The first opening and closing portion 66 moves in a direction corresponding to a difference in forces applied to both surfaces of the first flexible film 64.

The first opening and closing portion 66 is movable between the first closed position indicated by the solid line in FIG. 2 and the first open position indicated by the two-dot chain line in FIG. 2. In FIG. 2, a direction in which the fluid flows is indicated by a white arrow.

When the first opening and closing portion 66 is in the first closed position indicated by the solid line in FIG. 2, the first valve portion 73 puts the first upstream chamber 61 and the first downstream chamber 62 out of communication with each other. When the first opening and closing portion 66 is in the first open position indicated by the two-dot chain line in FIG. 2, the first valve portion 73 allows the first upstream chamber 61 and the first downstream chamber 62 to communicate with each other.

The first valve mechanism 21 functions as a pressure adjustment valve. The pressure adjustment valve is a valve capable of switching among the first adjustment state functioning as the pressure adjustment valve, the first open state maintaining the first open state, and the first closed state maintaining the first closed state. When the first valve mechanism 21 gets to the first adjustment state, the fluid in the first upstream chamber 61 is at an input pressure P1, and the fluid in the first downstream chamber 62 is at an output pressure P2. The first valve mechanism 21 adjusts the output pressure P2 to a first set pressure SP1. Here, an input side and an output side of the valve mechanism are not in accordance with the direction in which the fluid flows, but rather a side where the pressure is adjusted is the output side and an opposite side is the input side.

### Operation of First Valve Mechanism

The first valve mechanism 21 is switched among the first adjustment state, the first open state, and the first closed state according to the pressure of air acting on the outside of the first flexible film 64. That is, the first valve mechanism 21 is switched among the first adjustment state, the first open state, and the first closed state according to the pressure of the air introduced into the first air chamber 63. Hereinafter, these three states will be described in order.

When the atmospheric pressure is applied to the outside of the first flexible film 64, the first valve mechanism 21 gets to the first adjustment state in which the pressure is adjusted. That is, when the atmospheric pressure is introduced into the first air chamber 63, the first valve mechanism 21 gets to the first adjustment state in which the pressure is adjusted. In the first adjustment state, the output pressure P2 is adjusted to the first set pressure SP1 by opening and closing the first valve portion 73 according to a change in the output pressure P2. In the embodiment, the first set pressure SP1 is set to a predetermined positive pressure.

When a positive pressure is applied to the outside of the first flexible film 64, the first valve mechanism 21 gets to the first open state in which the first valve mechanism 21 is maintained in the open state. That is, the first valve mechanism 21 gets to the first open state when the positive pressure is introduced into the first air chamber 63. In the first open state, the first flexible film 64, which has a positive pressure acting on the outer surface thereof, is displaced in a direction that reduces the volume of the first downstream chamber 62. The first opening and closing portion 66 is maintained at the open position. In the first open state, the first valve portion 73 is maintained in the first open state in which the first upstream chamber 61 and the first downstream chamber 62 communicate with each other. In the first open state, the first valve mechanism 21 maintains the open state to adjust a downstream pressure to the pressure P2 (>SP1) higher than the first set pressure SP1.

When a negative pressure is applied to the outside of the first flexible film 64, the first valve mechanism 21 gets to the first closed state in which the first valve mechanism 21 is maintained in the closed state. That is, the first valve mechanism 21 gets to the first closed state when the negative pressure is introduced into the first air chamber 63. In the first closed state, the first flexible film 64, which has a negative pressure acting on the outer surface thereof, is displaced in a direction that increases the volume of the first downstream chamber 62. The first opening and closing portion 66 is maintained at the closed position. In the first closed state, the first valve portion 73 is maintained in the first closed state in which the first upstream chamber 61 and the first downstream chamber 62 do not communicate with each other. In the first closed state, the first valve mechanism 21 maintains the closed state to adjust the flow rate of the fluid from the upstream to the downstream to zero.

Here, an operation when the first valve mechanism 21 gets to the first adjustment state will be described. When the first valve mechanism 21 shown in FIG. 2 gets to the first adjustment state, the first opening and closing portion 66 is mainly displaced according to the difference in forces applied to both surfaces of the first flexible film 64. For example, in the first adjustment state, a force in an valve opening direction due to the atmospheric pressure, a biasing force (a compression force) in the first direction D1 (a valve opening direction) due to the first biasing portion 67, and a force in a valve closing direction based on the pressure (for example, a positive pressure) of the fluid in the first downstream chamber 62 are applied to both surfaces of the first flexible film 64. Therefore, the force in the valve opening direction due to the atmospheric pressure and the biasing force in the valve opening direction due to the first biasing portion 67 act on the surface of the first flexible film 64 on the first air chamber 63 side. The first valve mechanism 21 is set so that the first opening and closing portion 66 moves from the open position to the closed position when the output pressure P2 is higher than the first set pressure SP1. That is, the first opening and closing portion 66 is set to move from the open position to the closed position when the output pressure P2 is higher than the first set pressure SP1.

When the output pressure P2 that determines the pressure of the fluid in the first downstream chamber 62 falls below the first set pressure SP1, the first flexible film 64 is displaced in the first direction D1, causing the first opening and closing portion 66 to move to the open position. The opening of the valve allows the fluid to flow from the first upstream chamber 61 to the first downstream chamber 62 through the first communication port 69. As a result, the pressure of the fluid in the first downstream chamber 62 is increased to the first set pressure SP1. By performing such an operation, the output pressure P2 downstream of the first valve mechanism 21 is adjusted to the first set pressure SP1.

### Configuration of Second Valve Mechanism

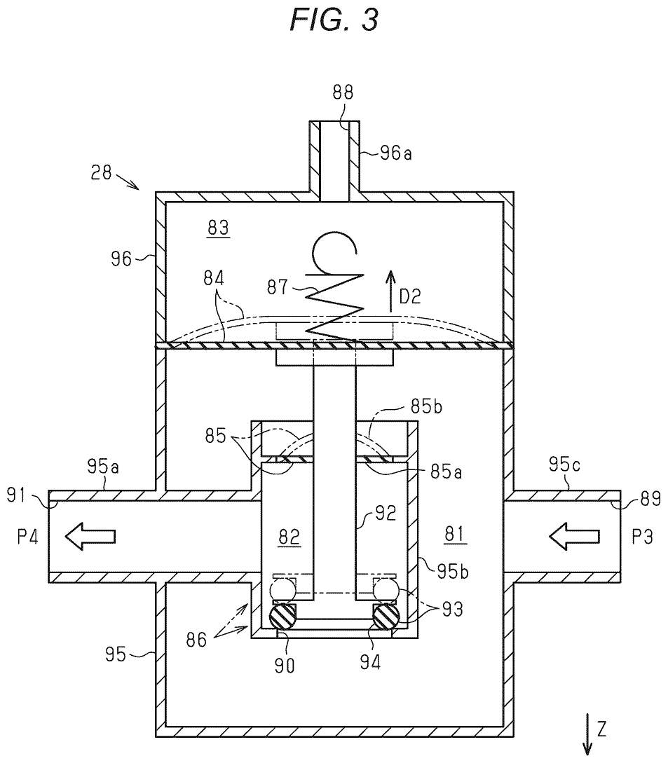

Next, a configuration of the second valve mechanism 28 will be described with reference to FIG. 3. As shown in FIG. 3, the second valve mechanism 28 includes a second upstream chamber 81 which is an example of the upstream chamber, a second downstream chamber 82 which is an example of the downstream chamber, and a second air chamber 83 which is an example of the air chamber. The second valve mechanism 28 includes a third flexible film 84 which is an example of a first flexible film, a fourth flexible film 85 which is an example of a second flexible film, a second opening and closing portion 86 which is an example of the opening and closing portion, and a second biasing portion 87 which is an example of the biasing portion. The second opening and closing portion 86 is movable between a second closed position indicated by a solid line in FIG. 3 and a second open position indicated by a two-dot chain line in FIG. 3. In the embodiment, a state in which the second opening and closing portion 86 is located at the second closed position is also referred to as a second closed state, and a state in which the second opening and closing portion 86 is located at the second open position is also referred to as a second open state. The fluid handled by the second valve mechanism 28 according to the embodiment is, for example, a liquid.

The fluid flows into the second upstream chamber 81 via a second inflow port 89 which is an example of an inflow port. The second inflow port 89 according to the embodiment is coupled to the liquid discharge unit 12 via the liquid channel 19.

The second downstream chamber 82 is provided downstream of the second upstream chamber 81. The second downstream chamber 82 communicates with the second upstream chamber 81 via a second communication port 90, which is an example of a communication port, downstream of the second upstream chamber 81. The second downstream chamber 82 allows the fluid to flow out through the second outflow port 91. The second outflow port 91 according to the embodiment communicates with the second liquid storage portion 24 via the second liquid channel 26.

The second air chamber 83 is implemented to communicate with an external space. The second air chamber 83 can communicate with the external space via a second ventilation port 88.

The second valve mechanism 28 has a second housing 95 having a cylindrical shape with a bottom and one end open, and a second lid body 96 having a cylindrical shape with a bottom and one end open. The second housing 95 and the second lid body 96 are bonded to each other at their opening side end portions with the third flexible film 84 sandwiched therebetween. The second housing 95 includes a second inflow tube portion 95a, a cylindrical second chamber forming portion 95b, and a second outflow tube portion 95c. The second inflow tube portion 95a communicates with the second chamber forming portion 95b. One opening of the second chamber forming portion 95b is closed by the fourth flexible film 85, and the other opening forms the second communication port 90.

The second upstream chamber 81 is defined by the second housing 95, the third flexible film 84, and the like. The second downstream chamber 82 is defined by the second chamber forming portion 95b, the fourth flexible film 85, and the like. The second air chamber 83 is defined by the second lid body 96 and the third flexible film 84. The second lid body 96 has a tube portion 96a communicating with the second air chamber 83. The second ventilation port 88 is formed in the tube portion 96a.

The third flexible film 84 separates the second upstream chamber 81 from the second air chamber 83. The third flexible film 84 forms a part of a wall of the second upstream chamber 81. The third flexible film 84 is formed of a flexible member such as a diaphragm. The third flexible film 84 is displaced according to a difference in pressure applied to an outer surface and an inner surface.

The fourth flexible film 85 separates the second upstream chamber 81 and the second downstream chamber 82. The fourth flexible film 85 may be located on the second communication port 90. The fourth flexible film 85 is located between the second communication port 90 and the third flexible film 84.

The second communication port 90, the fourth flexible film 85, the third flexible film 84, and the second biasing portion 87 may be arranged in this order in a second direction D2. The second direction D2 may be a direction opposite to the vertical direction Z.

The second biasing portion 87 biases the third flexible film 84. The second biasing portion 87 biases the third flexible film 84 in the second direction D2 in which the volume of the second upstream chamber 81 increases. The second biasing portion 87 is provided outside the second upstream chamber 81. The second biasing portion 87 presses the second opening and closing portion 86 via the third flexible film 84. The second biasing portion 87 is, for example, a tension spring.

The second biasing portion 87 may be accommodated in the air chamber 83. The second biasing portion 87 has a first end portion fixed to the third flexible film 84, and a second end portion on an opposite side from the first end portion supported by a hook portion (not shown) so as not to be movable. Therefore, the second biasing portion 87 gets to a state of pulling the third flexible film 84 in a direction in which the volume of the second upstream chamber 81 increases. The second biasing portion 87 pulls the third flexible film 84 in the second direction D2. The second biasing portion 87 applies a force to the second opening and closing portion 86 via the third flexible film 84 in a direction to move the second opening and closing portion 86 from the second closed position indicated by the solid line in FIG. 3 to the second open position indicated by the two-dot chain line in FIG. 3.

The second opening and closing portion 86 is implemented to open and close the second communication port 90. The second communication port 90 opens at an end portion of the second chamber forming portion 95b on an opposite side from an end portion on the fourth flexible film 85 side. The second opening and closing portion 86 may include a second shaft portion 92, which is an example of the shaft portion, and a second valve portion 93, which is an example of the valve portion.

The second shaft portion 92 is provided across the second upstream chamber 81 and the second downstream chamber 82. The second shaft portion 92 is inserted into the fourth flexible film 85. A longitudinal direction of the second shaft portion 92 may be parallel to the second direction D2. The second shaft portion 92 may have a rod shape. The second shaft portion 92 may have a columnar shape. A diameter of the second shaft portion 92 is smaller than an inner diameter of the second communication port 90.

The second shaft portion 92 is movable following displacements of the third flexible film 84 and the fourth flexible film 85. The second shaft portion 92 is fixed to the third flexible film 84 and the fourth flexible film 85 directly or via a fixing member. One end of the second shaft portion 92 may be coupled to the third flexible film 84. The other end of the second shaft portion 92 may be coupled to the second valve portion 93.

The second valve portion 93 is coupled to the second shaft portion 92. The second valve portion 93 can open and close the second communication port 90. The second valve portion 93 moves together with the second shaft portion 92. The second shaft portion 92 displaces the fourth flexible film 85 and the second valve portion 93 by moving following the displacement of the third flexible film 84. That is, when the second opening and closing portion 86 moves following the displacement of the third flexible film 84, the second valve portion 93 opens and closes the second communication port 90.

The second valve portion 93 may include a second seal portion 94. The second seal portion 94 can come into close contact with the second communication port 90. The second seal portion 94 forms an outer periphery of the second valve portion 93. The second seal portion 94 may have an annular shape. The second seal portion 94 may be an O-ring having a torus shape.

As shown in FIG. 3, in the second valve mechanism 28, the fourth flexible film 85 receives a force corresponding to a pressure difference between a third surface 85a and a fourth surface 85b. The second valve portion 93 receives a force corresponding to a pressure difference between the outer surface and the inner surface. A pressure receiving area of the fourth flexible film 85 and a pressure receiving area of the second valve portion 93 are substantially equal to each other or a difference therebetween is small. Therefore, a force applied to the fourth flexible film 85 and a force applied to the second valve portion 93 are substantially offset because the forces are substantially the same in opposite directions.

Therefore, the second opening and closing portion 86 is mainly displaced according to a difference in forces applied to both surfaces of the third flexible film 84. The pressure receiving area of the third flexible film 84 is larger than the pressure receiving area of the fourth flexible film 85. Therefore, responsiveness of the opening and closing of the second valve portion 93 with respect to a change in the pressure applied to both surfaces of the third flexible film 84 is high. A force in a direction corresponding to the pressure of the air in the second air chamber 83, a biasing force of the second biasing portion 87 in the second direction D2, and a force in a direction corresponding to the pressure of the fluid in the second upstream chamber 81 are applied to the third flexible film 84. The second opening and closing portion 86 moves in a direction corresponding to a difference in forces applied to both surfaces of the third flexible film 84.

The second opening and closing portion 86 is movable between the second closed position indicated by the solid line in FIG. 3 and the second open position indicated by the two-dot chain line in FIG. 3. In FIG. 3, a direction in which the fluid flows is indicated by a white arrow. When the second opening and closing portion 86 is in the closed position indicated by the solid line in FIG. 3, the second valve portion 93 puts the second upstream chamber 81 and the second downstream chamber 82 out of communication with each other. When the second opening and closing portion 86 is in the open position indicated by the two-dot chain line in FIG. 3, the second valve portion 93 allows the second upstream chamber 81 and the second downstream chamber 82 to communicate with each other.

The second valve mechanism 28 functions as a negative pressure adjustment valve. The negative pressure adjustment valve is a valve capable of switching among the second adjustment state functioning as the negative pressure adjustment valve, the second open state maintaining the second open state, and the second closed state maintaining the second closed state. When the second valve mechanism 28 gets to the second adjustment state, the fluid in the second upstream chamber 81 is at an output pressure P3, and the fluid in the second downstream chamber 82 is at an input pressure P4. The second valve mechanism 28 adjusts the output pressure P3 to a second set pressure SP2.

### Operation of Second Valve Mechanism

The second valve mechanism 28 is switched among the second adjustment state, the second open state, and the second closed state according to the pressure of air acting on the outside of the third flexible film 84. That is, the second valve mechanism 28 is switched among the second adjustment state, the second open state, and the second closed state according to the pressure of the air introduced into the second air chamber 83. Hereinafter, these three states will be described in order.

When the atmospheric pressure is applied to the outside of the third flexible film 84, the second valve mechanism 28 gets to the second adjustment state in which the pressure is adjusted. That is, when the atmospheric pressure is introduced into the second air chamber 83, the second valve mechanism 28 gets to the second adjustment state in which the pressure is adjusted. In the second adjustment state, the output pressure P3 is adjusted to the second set pressure SP2 by opening and closing the second valve portion 93 according to a change in the output pressure P3. In the embodiment, the second set pressure SP2 is set to a predetermined negative pressure.

When a negative pressure is applied to the outside of the third flexible film 84, the second valve mechanism 28 gets to the second open state in which the second valve mechanism 28 is maintained in the open state. That is, the second valve mechanism 28 gets to the second open state when the negative pressure is introduced into the second air chamber 83. In the second open state, the third flexible film 84, which has a negative pressure acting on the outer surface thereof, is displaced in a direction that increases the volume of the second upstream chamber 81. The second opening and closing portion 86 is maintained at the open position. In the second open state, the second valve portion 93 is maintained in the second open state in which the second upstream chamber 81 and the second downstream chamber 82 communicate with each other. In the second open state, the second valve mechanism 28 maintains the open state to adjust an upstream pressure to the pressure P3 (<SP2) lower than the second set pressure SP2.

When a positive pressure is applied to the outside of the third flexible film 84, the second valve mechanism 28 gets to the second closed state in which the second valve mechanism 28 is maintained in the closed state. That is, the second valve mechanism 28 gets to the second closed state when the positive pressure is introduced into the second air chamber 83. In the second closed state, the third flexible film 84, which has a positive pressure acting on the outer surface thereof, is displaced in a direction that reduces the volume of the second upstream chamber 81. The second opening and closing portion 86 is maintained at the closed position. In the second closed state, the second valve portion 93 is maintained in the second closed state in which the second upstream chamber 81 and the second downstream chamber 82 do not communicate with each other. In the second closed state, the second valve mechanism 28 maintains the closed state to adjust the flow rate of the fluid from the upstream to the downstream to zero.

Here, an operation when the second valve mechanism 28 gets to the second adjustment state will be described. When the second valve mechanism 28 shown in FIG. 3 gets to the second adjustment state, the second opening and closing portion 86 is mainly displaced according to the difference in forces applied to both surfaces of the third flexible film 84. For example, in the second adjustment state, a force in a valve closing direction due to the atmospheric pressure, a biasing force (a pulling force) in the second direction D2 (the valve opening direction) due to the second biasing portion 87, and a force in the valve closing direction based on the negative pressure of the fluid in the second upstream chamber 81 are applied to both surfaces of the third flexible film 84. Therefore, a pulling force in the valve opening direction acts on the surface of the third flexible film 84 on the second air chamber 83 side, against the force in the valve closing direction due to the atmospheric pressure. When the output pressure P3 is higher than the second set pressure SP2, that is, when the negative pressure of the fluid in the second upstream chamber 81 is reduced in a state in which the second opening and closing portion 86 is at the closed position, the third flexible film 84 is displaced in the second direction D2, and thus the second opening and closing portion 86 is moved to the open position. The closing of the valve allows the fluid to flow from the second upstream chamber 81 to the second downstream chamber 82 through the second communication port 90. As a result, the pressure of the fluid in the second upstream chamber 81 is adjusted to the second set pressure SP2. When the output pressure P3 is lower than the second set pressure SP2, that is, when the negative pressure of the fluid in the second upstream chamber 81 increases, the second opening and closing portion 86 moves from the open position to the closed position. As a result, the pressure of the fluid in the second upstream chamber 81 is adjusted to the second set pressure SP2. In this manner, the output pressure P3 upstream of the second valve mechanism 28 is adjusted to the second set pressure SP2.

### Configuration of Switching Unit 38

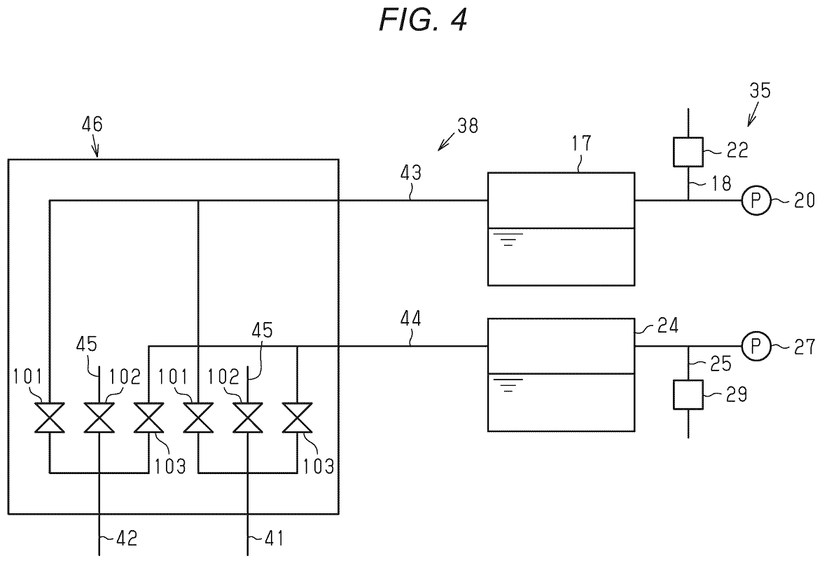

Next, a configuration of the switching unit 38 will be described with reference to FIG. 4. The switching unit 38 includes two valve groups each including a first valve 101, a second valve 102, and a third valve 103. The first valve 101, the second valve 102, and the third valve 103 may be implemented by, for example, an electromagnetic on-off valve, or may be implemented to open and close via a cam mechanism (not shown) that is rotated by power of a motor. In this case, the electromagnetic on-off valve or the motor may be driven and controlled by the control unit 100. Downstream ends of the first valve 101, the second valve 102, and the third valve 103 belonging to one set are coupled to the first gas channel 41. Downstream ends of the first valve 101, the second valve 102, and the third valve 103 belonging to the other set are coupled to the second gas channel 42. Upstream ends of the two first valves 101 are coupled to the third gas channel 43. Upstream ends of the two second valves 102 are coupled to the fifth gas channel 45 communicating with the atmosphere. Upstream ends of the two third valves 103 are coupled to the fourth gas channel 44.

The pressure of the gas in the first gas channel 41 is selected according to which of the first valve 101, the second valve 102, and the third valve 103 is opened. When the first valve 101 is opened, the pressure of the gas in the first gas channel 41 becomes a positive pressure. When the second valve 102 is opened, the pressure of the gas in the first gas channel 41 becomes the atmospheric pressure. When the third valve 103 is opened, the pressure of the gas in the first gas channel 41 becomes a negative pressure.

The pressure of the gas in the first gas channel 41 is selected according to which of the first valve 101, the second valve 102, and the third valve 103 is opened. When the first valve 101 is opened, the pressure of the gas in the first gas channel 41 becomes a positive pressure. When the second valve 102 is opened, the pressure of the gas in the first gas channel 41 becomes the atmospheric pressure. When the third valve 103 is opened, the pressure of the gas in the first gas channel 41 becomes a negative pressure.

### Functions of First Embodiment

Functions of the embodiment will be described. The inside of the first liquid storage portion 17 is pressurized to a positive pressure higher than the atmospheric pressure. The pressurized liquid in the first liquid storage portion 17 flows out to the liquid channel 19. The pressure of the liquid supplied from the first liquid storage portion 17 to the liquid discharge unit 12 is adjusted to the first set pressure SP1 by the first pressure adjustment valve 36. Therefore, the inside of the liquid discharge unit 12 is adjusted to the first set pressure SP1 which is a predetermined positive pressure lower than the pressure in the pressurized first liquid storage portion 17.

The inside of the second liquid storage portion 24 is depressurized to a negative pressure lower than the atmospheric pressure. The liquid is collected from the liquid discharge unit 12 to the second liquid storage portion 24 through the second liquid channel 26. The second pressure adjustment valve 37 provided in the second liquid channel 26 adjusts the pressure in the liquid discharge unit 12 located upstream thereof to the second set pressure SP2. Therefore, the inside of the liquid discharge unit 12 is adjusted to the second set pressure SP2 which is a predetermined negative pressure higher than the pressure in the depressurized second liquid storage portion 24.

For example, the second set pressure SP2 (<SP1) is set to a value smaller than the first set pressure SP1. Therefore, even when both the first pressure adjustment valve 36 and the second pressure adjustment valve 37 are in the adjustment state, it is possible to circulate the liquid while maintaining a predetermined negative pressure in the liquid discharge unit 12.

### Operation of Liquid Discharge Device 11

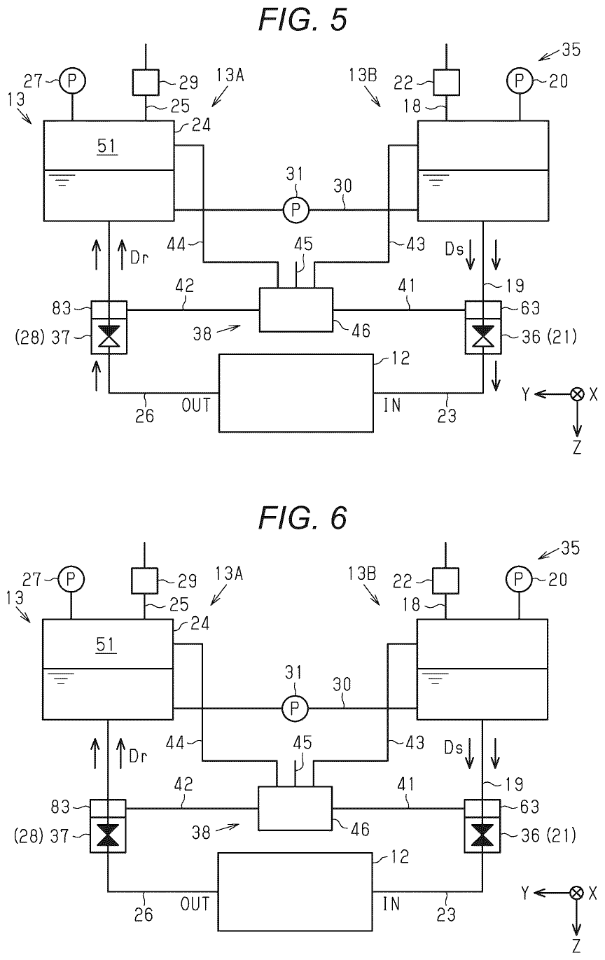

Next, an operation of the liquid discharge device 11 will be described with reference to FIGS. 5 to 10. In FIGS. 5 to 10, three states of the first pressure adjustment valve 36 and the second pressure adjustment valve 37 are distinguished by a combination of white and black valve symbols. That is, the adjustment state is indicated by black and white (for example, FIG. 5), the closed state is indicated by black (for example, FIG. 6), and the open state is indicated by white (for example, FIG. 8).

The switching mechanism 46 is switched and controlled by the control unit 100 (see FIG. 1). The switching mechanism 46 adjusts the pressure of the first air chamber 63 of the first pressure adjustment valve 36 through the first gas channel 41. The switching mechanism 46 adjusts the pressure of the second air chamber 83 of the second pressure adjustment valve 37 through the second gas channel 42. The control unit 100 controls a flow of the liquid in the liquid channel 19 by switching the states of the first pressure adjustment valve 36 and the second pressure adjustment valve 37.

FIG. 5 shows a normal circulation. The first air chamber 63 of the first pressure adjustment valve 36 is opened to the atmosphere through the first gas channel 41. The second air chamber 83 of the second pressure adjustment valve 37 is opened to the atmosphere through the second gas channel 42. As a result, the first pressure adjustment valve 36 and the second pressure adjustment valve 37 are both in the adjustment state. Therefore, the output pressure P2 of the first pressure adjustment valve 36 is adjusted to the first set pressure SP1. The output pressure P3 of the second pressure adjustment valve 37 is adjusted to the second set pressure SP2. Here, the first set pressure SP1 is a positive pressure, and the second set pressure SP2 is a negative pressure. The inside of the liquid discharge unit 12 is adjusted to a negative pressure. In addition, there is a relationship of SP1>SP2. Therefore, the liquid is circulated in a path passing through the liquid discharge unit 12. A recording operation of discharging the liquid onto the medium 14 is performed during the circulation of the liquid.

FIG. 6 shows a standby state and a stop state. The standby state is a state of waiting for an instruction of a liquid discharge operation. The stop state is a state before the standby state in a power ON state. A negative pressure is introduced into the first air chamber 63 of the first pressure adjustment valve 36 through the first gas channel 41. A positive pressure is introduced into the second air chamber 83 of the second pressure adjustment valve 37 through the second gas channel 42. As a result, the first pressure adjustment valve 36 and the second pressure adjustment valve 37 are both in the closed state. Therefore, the circulation of the liquid to the liquid discharge unit 12 is stopped.

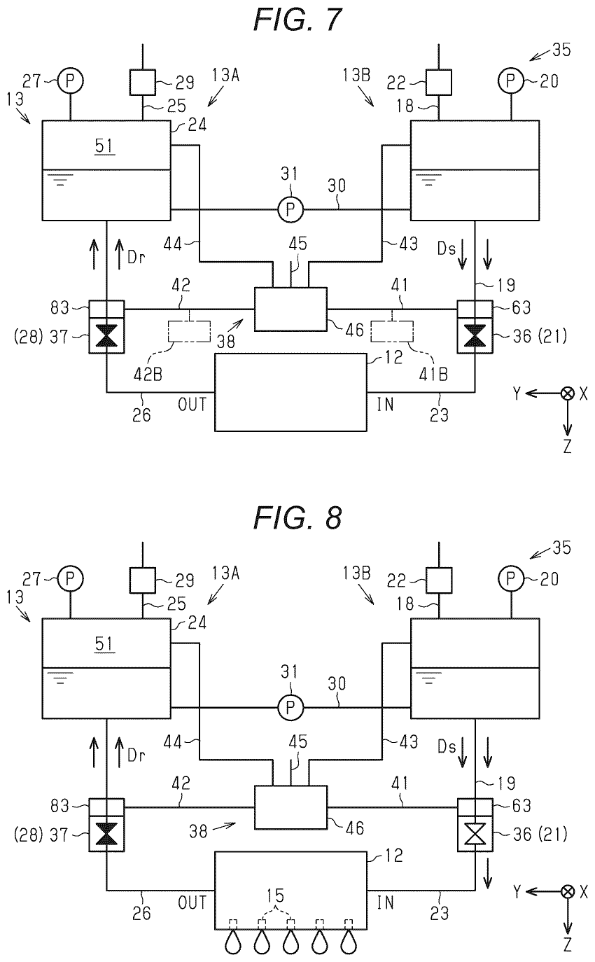

FIG. 7 shows a power supply OFF state. In the power supply OFF state, the pressurizing pump 20 and the depressurizing pump 27 are both stopped. When the pressure release valve 22 is switched to the open state, the inside of the first liquid storage portion 17 is opened to the atmosphere. When the pressure release valve 22 is switched to the open state, the inside of the second liquid storage portion 24 is opened to the atmosphere. The third gas channel 43 and the fourth gas channel 44 are opened to the atmosphere. Before the power supply is turned off, the two first valves 101 in the switching mechanism 46 are closed. A negative pressure is introduced into the first air chamber 63 of the first pressure adjustment valve 36 through the first gas channel 41. A positive pressure is introduced into the second air chamber 83 of the second pressure adjustment valve 37 through the second gas channel 42. As a result, while the power supply is turned off, both the first pressure adjustment valve 36 and the second pressure adjustment valve 37 are held in the closed state. Buffer chambers 41B and 42B indicated by two-dot chain lines in FIG. 7 may be provided. Since the buffer chambers 41B and 42B are provided, both the first pressure adjustment valve 36 and the second pressure adjustment valve 37 can be maintained in a closed state over a long period.

FIG. 8 shows a cleaning state. A positive pressure is introduced into the first air chamber 63 of the first pressure adjustment valve 36 through the first gas channel 41. A positive pressure is introduced into the second air chamber 83 of the second pressure adjustment valve 37 through the second gas channel 42. As a result, the first pressure adjustment valve 36 gets to the open state and the second pressure adjustment valve 37 gets to the closed state. The liquid supplied into the liquid discharge unit 12 is discharged from the nozzle 15. That is, cleaning is performed to forcibly discharge the liquid from the nozzle 15 of the liquid discharge unit 12. By the cleaning, an increased viscosity ink, air bubbles, and the like in the nozzle 15 are discharged together with the liquid. The liquid discharged from the nozzle 15 is received in, for example, a cap (not shown) of a maintenance device.

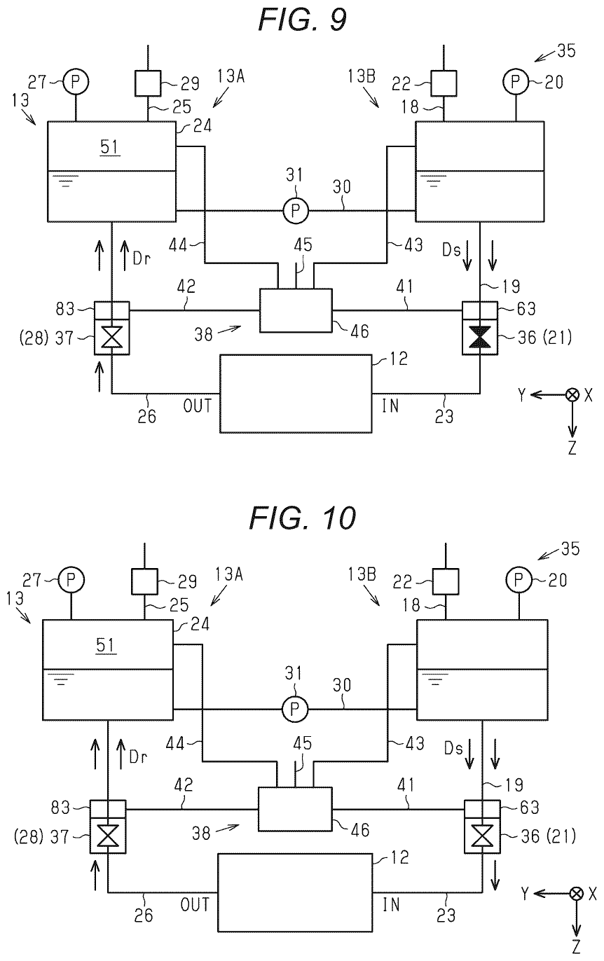

FIG. 9 shows a liquid removal state in the liquid discharge unit 12. A negative pressure is introduced into the first air chamber 63 of the first pressure adjustment valve 36 through the first gas channel 41. A negative pressure is introduced into the second air chamber 83 of the second pressure adjustment valve 37 through the second gas channel 42. As a result, the first pressure adjustment valve 36 gets to the closed state and the second pressure adjustment valve 37 gets to the open state. When the first pressure adjustment valve 36 gets to the closed state, the liquid in the liquid discharge unit 12 is collected in the second liquid storage portion 24. That is, the liquid in the liquid discharge unit 12 is forcibly removed. After the liquid is removed from the liquid discharge unit 12, for example, the liquid discharge unit 12 is replaced.

FIG. 10 shows a forced circulation. A positive pressure is introduced into the first air chamber 63 of the first pressure adjustment valve 36 through the first gas channel 41. A negative pressure is introduced into the second air chamber 83 of the second pressure adjustment valve 37 through the second gas channel 42. As a result, the first pressure adjustment valve 36 and the second pressure adjustment valve 37 are both in the open state. The liquid sending portion 31 is driven. The liquid is forcibly circulated in a path passing through the liquid discharge unit 12. For example, the air bubbles accumulated in a filter 141 (see FIG. 33) inside the liquid discharge unit 12 are forcibly discharged. That is, in the forced circulation, since an amount of a circulating liquid per unit time increases, the air bubbles accumulated in the filter 141 are forcibly discharged by a high flow velocity of the liquid.

### Advantages of First Embodiment

Advantages of the first embodiment will be described.

(1-1) Since the first valve mechanism 21 includes the first air chamber 63, the pressure can be applied via the first air chamber 63. Therefore, the state of the first opening and closing portion 66 can be switched between the first adjustment state and the first open state. The first adjustment state is a state in which the output pressure P2 is adjusted to the first set pressure SP1 (constant). The first open state is a state in which the pressure is adjusted to be higher than the first set pressure SP1 by maintaining the state in which the liquid channel 19 is opened. Therefore, the fluid can be made to flow by changing the pressure and the flow rate according to the control state.

By using the first valve mechanism 21, only one liquid channel 19 (the first liquid channel 23) is required, and thus a channel design can be simplified. For example, although it is possible to deal with a channel in which the pressure release valve and the on-off valve are arranged in parallel, the channel design is complicated. In addition, by using the second valve mechanism 28, only one liquid channel 19 (the second liquid channel 26) is required, and thus the channel design can be simplified. For example, although it is possible to deal with a channel in which the negative pressure release valve and the on-off valve are arranged in parallel, the channel design is complicated.

Further, by adopting the configuration using the valve mechanisms 21 and 28, it is possible to smoothly switch between the adjustment state and the open state. For example, in the case of a mechanical valve mechanism that moves a valve body by rotating a screw portion, it takes time to switch the state. The valve mechanisms 21 and 28 according to the embodiment are implemented to switch the state by switching the pressure of the air chambers 63 and 83, so that the state can be instantaneously switched.

(1-2) Since the second valve mechanism 28 includes the second air chamber 83, the pressure can be applied via the second air chamber 83. Therefore, the state of the second opening and closing portion 86 can be switched between the second adjustment state and the second open state. The second adjustment state is a state in which the output pressure P3 is adjusted to the second set pressure SP2 (constant). The second open state is a state in which the pressure is adjusted to be lower than the second set pressure SP2 by maintaining the state in which the liquid channel 19 is opened. Therefore, the fluid can be made to flow by changing the pressure and the flow rate according to the control state.

(1-3) A configuration in which an air chamber is provided in a self-sealing valve type pressure adjustment valve in the related art is also conceivable. That is, in contrast to the self-sealing valve type pressure adjustment valve in the related art, the pressure adjustment valve can be forcibly switched to the open state or the closed state by switching the pressure in the air chamber after adding the air chamber to the outside of the flexible film. However, when a self-sealing valve type pressure adjustment valve is used, after it is forcibly closed, the pressure of the fluid in the upstream chamber acts on the valve portion, and the valve portion cannot be opened unless a pressure higher than the set pressure is applied. In contrast, in the first valve mechanism 21, a force in the valve opening direction due to the atmospheric pressure, a biasing force (a compression force) in the first direction D1 (the valve opening direction) due to the first biasing portion 67, and a force in the closing direction based on the pressure of the fluid in the first downstream chamber 62 are applied to both surfaces of the first flexible film 64. Therefore, even after the air chamber is forcibly closed, the first opening and closing portion can be opened by returning the pressure in the air chamber to the atmospheric pressure. Therefore, it is possible to provide an air chamber to forcibly bring the valve into the closed state or the open state, while at the same time adjusting the output pressure P2 to the first set pressure SP1. Similarly, in the second valve mechanism 28, a force in a valve closing direction due to the atmospheric pressure, a biasing force (a pulling force) in the second direction D2 (the valve opening direction) due to the second biasing portion 87, and a force in the valve closing direction based on the negative pressure of the fluid in the second upstream chamber 81 are applied to both surfaces of the third flexible film 84. Even after the air chamber is forcibly closed, the second opening and closing portion can be opened by returning the pressure in the air chamber to the atmospheric pressure. Therefore, it is possible to provide an air chamber to forcibly bring the valve into the closed state or the open state, while at the same time adjusting the output pressure P2 to the first set pressure SP1.

(1-4) In the first valve mechanism 21, the first shaft portion 72 is inserted into the second flexible film 65. One end of the first shaft portion 72 is coupled to the first flexible film 64, and the other end of the first shaft portion 72 is coupled to the first valve portion 73. According to the configuration, the first shaft portion 72 can move following the first flexible film 64 and the second flexible film 65. The responsiveness of the first valve portion 73 that opens and closes according to a change in the pressure difference between the first upstream chamber 61 and the first downstream chamber 62 is improved. In the second valve mechanism 28, the second shaft portion 92 is inserted into the fourth flexible film 85. One end of the second shaft portion 92 is coupled to the third flexible film 84, and the other end of the second shaft portion 92 is coupled to the second valve portion 93. According to the configuration, the second shaft portion 92 can move following the third flexible film 84 and the fourth flexible film 85. The responsiveness of the second valve portion 93 that opens and closes according to a change in the pressure difference between the second upstream chamber 81 and the second downstream chamber 82 is improved.

(1-5) When the atmospheric pressure is applied to the outside of the first flexible film 64, the first valve mechanism 21 gets to the adjustment state in which the pressure is adjusted. The first valve mechanism 21 can be brought into a state in which pressure is adjusted by simply opening the outside of the first flexible film 64 (the first air chamber 63) to the atmosphere. Therefore, the pressure of the liquid can be easily controlled by the first valve mechanism 21. When the atmospheric pressure is applied to the outside of the third flexible film 84, the second valve mechanism 28 gets to the adjustment state in which the pressure is adjusted. The second valve mechanism 28 can be brought into a state in which pressure is adjusted by simply opening the outside of the third flexible film 84 (the second air chamber 83) to the atmosphere. Therefore, the pressure of the liquid can be easily controlled by the second valve mechanism 28.

(1-6) The liquid flowing device 13 (the first liquid flowing portion 13A) includes the first valve mechanism 21, the first liquid storage portion 17, the first liquid channel 23, the pressure varying mechanism 35, and the pressurizing pump 20 which is an example of a pressure generating unit. The pressure varying mechanism 35 varies a pressure of a fluid flowing through the first liquid channel 23. The pressurizing pump 20 applies a pressure to the first air chamber 63. According to the configuration, it is possible to cause the liquid to flow in the first liquid channel 23 by changing the pressure or the flow rate to a pressure or a flow rate according to the control state.

(1-7) The liquid flowing device 13 (the second liquid flowing portion 13B) includes the second valve mechanism 28, the second liquid storage portion 24, the second liquid channel 26, the pressure varying mechanism 35, and the depressurizing pump 27 which is an example of the pressure generating unit. The pressure varying mechanism 35 varies a pressure of a fluid flowing through the second liquid channel 26. The depressurizing pump 27 applies a pressure to the second air chamber 83. According to the configuration, it is possible to cause the liquid to flow in the second liquid channel 26 by changing the pressure or the flow rate to a pressure or a flow rate according to the control state.

(1-8) The liquid flowing device 13 includes the first valve mechanism 21 and the second valve mechanism 28. The first valve mechanism 21 includes the first inflow port 68, the first upstream chamber 61, the first communication port 69, the first downstream chamber 62, the first air chamber 63, the first opening and closing portion 66, the first biasing portion 67, the first shaft portion 72, and the first valve portion 73. The second valve mechanism 28 includes the second inflow port 89, the second upstream chamber 81, the second communication port 90, the second downstream chamber 82, the second air chamber 83, the second opening and closing portion 86, the second biasing portion 87, the second shaft portion 92, and the second valve portion 93. Therefore, the pressure and the flow rate can be changed according to the control state at a plurality of locations of the liquid channel 19 by a plurality of valve mechanisms 21 and 28. For example, a normal circulation, a standby state and a stop state, a power supply OFF state, and a forced circulation can be performed.

(1-9) The liquid discharge device 11 includes the liquid flowing device 13 and the liquid discharge unit 12 provided in the liquid channel 19. Therefore, the liquid can be made to flow by changing the pressure and the flow rate according to the control state. For example, in the liquid discharge device 11, it is possible to perform the normal circulation, the standby state and the stop state, the power supply OFF state, the cleaning, and liquid removal and the forced circulation in the liquid discharge unit 12.

(1-10) The liquid discharge device 11 includes the liquid flowing device 13 and the liquid discharge unit 12. The liquid channel 19 includes the first liquid channel 23 and the second liquid channel 26. The first valve mechanism 21 is located in the first liquid channel 23, and the second valve mechanism 28 is located in the second liquid channel 26. Therefore, by switching the valve mechanisms 21 and 28 by controlling the air pressure, the pressure of the liquid flowing into the liquid discharge unit 12 and the pressure of the liquid flowing out of the liquid discharge unit 12 can be changed to pressures and flow rates according to the control state.

(1-11) The liquid discharge device 11 includes the first liquid storage portion 17, the second liquid storage portion 24, the first liquid channel 23, the second liquid channel 26, the pressure varying mechanism 35, the first pressure adjustment valve 36, the second pressure adjustment valve 37, and the switching unit 38. The first pressure adjustment valve 36 can be switched between the first adjustment state and the first open state. In the first adjustment state, the pressure downstream of the first pressure adjustment valve 36 in the first liquid channel 23 is adjusted to the first set pressure SP1. In the first open state, the pressure downstream of the first pressure adjustment valve 36 is adjusted to a pressure higher than the first set pressure SP1 by maintaining the open state of the first liquid channel 23. The second pressure adjustment valve 37 can be switched between the second adjustment state and the second open state. In the second adjustment state, the pressure upstream of the second pressure adjustment valve 37 in the second liquid channel 26 is adjusted to the second set pressure SP2. In the second open state, the pressure upstream of the second pressure adjustment valve 37 is adjusted to a pressure lower than the second set pressure SP2 by maintaining the open state of the second liquid channel 26. Therefore, by providing the pressure adjustment valves 36 and 37 capable of switching between the adjustment state and the open state to circulate the fluid, the fluid can be circulated at a pressure and a flow rate according to the control state.

(1-12) The states of the first pressure adjustment valve 36 and the second pressure adjustment valve 37 are switched by the pressure acting on the switching unit 38. According to the configuration, the state can be easily switched by the action of the pressure.

(1-13) The first pressure adjustment valve 36 is switchable to the first closed state in which the closed state of the first liquid channel 23 is maintained. The second pressure adjustment valve 37 is switchable to the second closed state in which the closed state of the second liquid channel 26 is maintained. According to the configuration, it is possible to close the liquid channel 19 in a control state in which the supply to the liquid discharge unit 12 and the collection from the liquid discharge unit 12 are not performed.

(1-14) The switching unit 38 includes the first gas channel 41 coupled to the first pressure adjustment valve 36 and the second gas channel 42 coupled to the second pressure adjustment valve 37. The switching unit 38 includes the third gas channel 43 through which a pressurized gas flows and the fourth gas channel 44 through which a depressurized gas flows. Further, the switching unit 38 includes the switching mechanism 46 that switches a coupling state between the gas channels 41 to 44. According to the configuration, since the switching unit 38 can be shared by the first pressure adjustment valve 36 and the second pressure adjustment valve 37, the liquid discharge device 11 can be downsized.

(1-15) The pressure varying mechanism 35 includes the pressurizing pump 20 that pressurizes the first liquid storage portion 17 and the depressurizing pump 27 that depressurizes the second liquid storage portion 24. The gas pressurized by the pressurizing pump 20 flows through the third gas channel 43, and the gas decompressed by the depressurizing pump 27 flows through the fourth gas channel 44. According to the configuration, the configuration can be simplified by using a pressurizing force of the pressurizing pump 20 for circulation and a depressurizing force of the depressurizing pump 27 for circulation as the pressures to be used for switching the states of the pressure adjustment valves 36 and 37. Therefore, the liquid discharge device 11 and the liquid flowing device 13 can be downsized.

(1-16) The first pressure adjustment valve 36 gets to the first open state when the first gas channel 41 and the third gas channel 43 are coupled. The second pressure adjustment valve 37 gets to the second open state when the second gas channel 42 and the fourth gas channel 44 are coupled. According to the configuration, by coupling the first gas channel 41 and the third gas channel 43 and coupling the second gas channel 42 and the fourth gas channel 44 according to the control state, the pressure adjustment valves 36 and 37 can be set to the open state. Accordingly, the liquid channels 23 and 26 coupled to the liquid discharge unit 12 can be set to an open state. Therefore, the fluid can be circulated at a pressure other than the set pressures SP1 and SP2.

(1-17) The first pressure adjustment valve 36 is switchable to the first closed state in which the closed state of the first liquid channel 23 is maintained. The first pressure adjustment valve 36 gets to the first closed state when the first gas channel 41 and the fourth gas channel 44 are coupled. The second pressure adjustment valve 37 is switchable to the second closed state in which the closed state of the second liquid channel 26 is maintained. The second pressure adjustment valve 37 gets to the second closed state when the second gas channel 42 and the third gas channel 43 are coupled. According to the configuration, by coupling the first gas channel 41 and the fourth gas channel 44 and coupling the second gas channel 42 and the third gas channel 43 according to the control state, at least one of the first liquid channel 23 and the second liquid channel 26 can be brought into the closed state. For example, the liquid discharge device 11 can be set to a state suitable for the standby state, the stop state, and the power supply OFF state, or can perform operations such as cleaning and liquid removal in the liquid discharge unit 12.

(1-18) The switching unit 38 has the fifth gas channel 45 that is open to the atmosphere. The first pressure adjustment valve 36 gets to the first adjustment state when the first gas channel 41 and the fifth gas channel 45 are coupled. The second pressure adjustment valve 37 gets to the second adjustment state when the second gas channel 42 and the fifth gas channel 45 are coupled. According to the configuration, the adjustment state can be achieved simply by opening to the atmosphere. Therefore, the switching from the open state to the adjustment state can be simplified.

### Second Embodiment

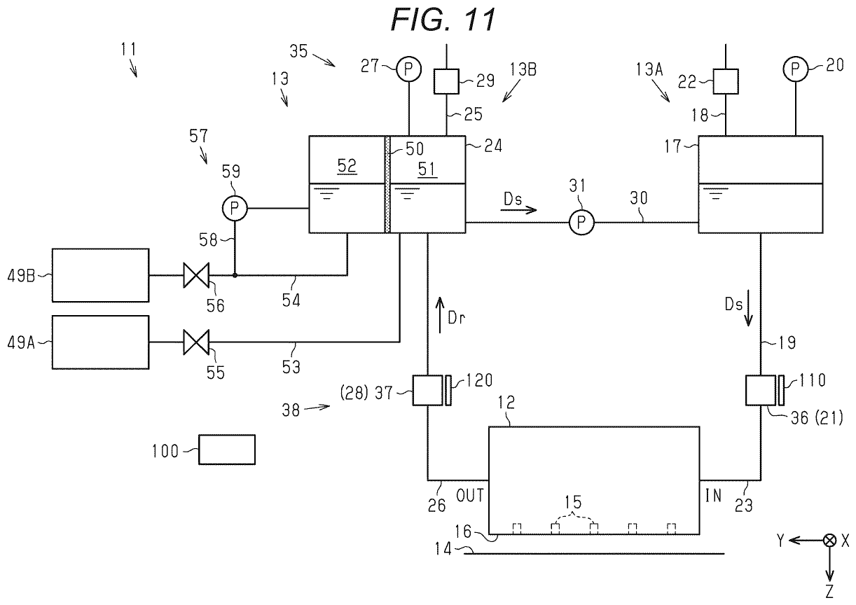

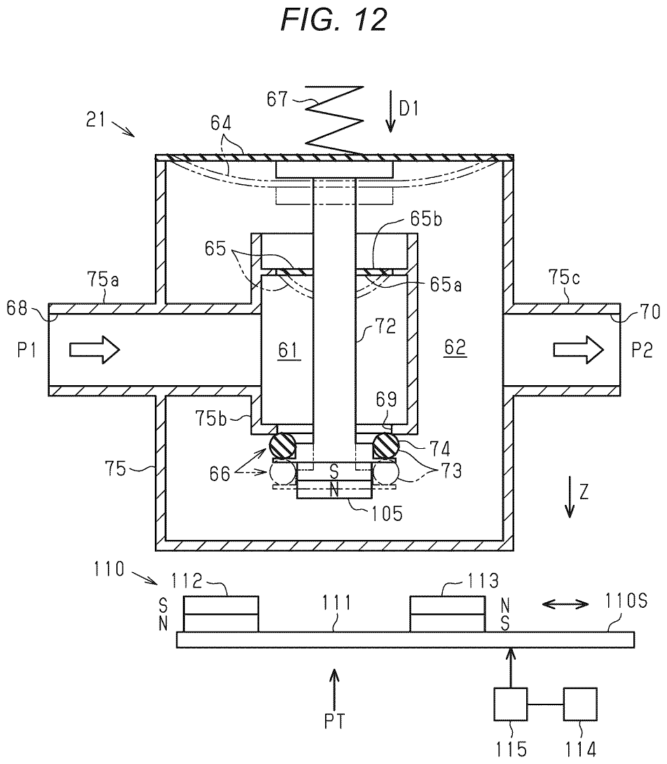

Next, the liquid discharge device 11, the liquid flowing device 13, and a valve mechanism according to a second embodiment will be described with reference to FIGS. 11 to 15. In the first embodiment, the valve mechanisms 21 and 28 are implemented to be switched by the action of the pressure to the air chambers 63 and 83, and the valve mechanisms 21 and 28 according to the embodiment are implemented to be switched by an action of a magnetic force. Components same as those of the first embodiment are denoted by the same reference numerals, and the description thereof is omitted.

As shown in FIG. 11, the configuration of the liquid discharge device 11 is basically the same as that of the first embodiment. Only the configuration for switching the states of the valve mechanisms 21 and 28 is different from the first embodiment.

That is, the liquid discharge device 11 includes the liquid flowing device 13 and the liquid discharge unit 12. The liquid channel 19 includes the first liquid channel 23 having a downstream end coupled to the liquid discharge unit 12 and the second liquid channel 26 having an upstream end coupled to the liquid discharge unit 12. The liquid flowing device 13 includes the first valve mechanism 21 which is an example of a valve mechanism, and the second valve mechanism 28 which is an example of a valve mechanism. The first valve mechanism 21 is the first pressure adjustment valve 36 that functions as a pressure adjustment valve. The second valve mechanism 28 is the second pressure adjustment valve 37 that functions as a negative pressure adjustment valve.

The liquid flowing device 13 includes the first liquid flowing portion 13A and the second liquid flowing portion 13B. Similarly to the first embodiment, the first liquid flowing portion 13A includes the first valve mechanism 21, the first liquid storage portion 17, the liquid channel 19 (the first liquid channel 23), and the pressure varying mechanism 35.

The first liquid flowing portion 13A according to the embodiment includes a first magnetic force generating portion 110 which is an example of a magnetic force generating portion. The liquid discharge device 11 includes the switching unit 38 that switches the state of the first pressure adjustment valve 36. The switching unit 38 according to the embodiment includes the first magnetic force generating portion 110. When the magnetic force acts on the switching unit 38, the state of the first pressure adjustment valve 36 is switched.

The first magnetic force generating portion 110 applies the generated magnetic force to the first opening and closing portion 66 (see FIG. 12) of the first valve mechanism 21. In the embodiment, the first opening and closing portion 66 of the first valve mechanism 21 has a magnetic force. The state of the first pressure adjustment valve 36 is switched by the action of the magnetic force from the first magnetic force generating portion 110. The first pressure adjustment valve 36 can be switched to a first adjustment state, a first open state, and a first closed state by the action of the magnetic force.

Similarly to the first embodiment, the second liquid flowing portion 13B includes the second valve mechanism 28, the second liquid storage portion 24, the liquid channel 19 (the second liquid channel 26), and the pressure varying mechanism 35. The second liquid flowing portion 13B according to the embodiment includes a second magnetic force generating portion 120 which is an example of a magnetic force generating portion. The liquid discharge device 11 includes the switching unit 38 that switches the state of the second pressure adjustment valve 37. The switching unit 38 according to the embodiment includes the second magnetic force generating portion 120. When the magnetic force acts on the switching unit 38, the state of the second pressure adjustment valve 37 is switched.

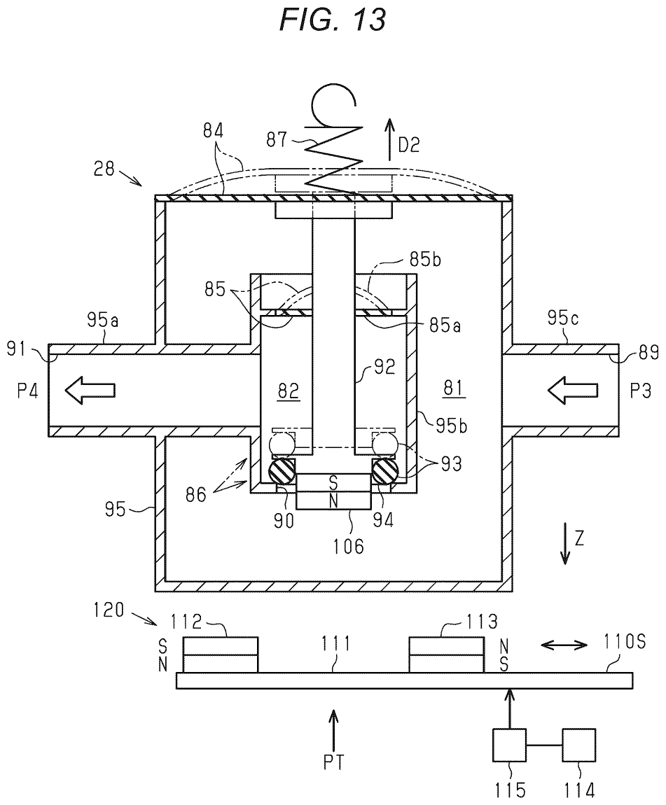

The second magnetic force generating portion 120 applies the generated magnetic force to the second opening and closing portion 86 (see FIG. 13) of the second valve mechanism 28. In the embodiment, the second opening and closing portion 86 of the second valve mechanism 28 has a magnetic force. The state of the second pressure adjustment valve 37 is switched by the action of the magnetic force from the second magnetic force generating portion 120. The second pressure adjustment valve 37 can be switched to a second adjustment state, a second open state, and a second closed state by the magnetic force.

As shown in FIG. 11, the liquid discharge device 11 and the liquid flowing device 13 are provided with the switching unit 38 using a magnetic force method, and therefore do not include the switching mechanism 46 for applying a pressure to the air chambers 63 and 83 or the gas channels 41 and 42 according to the first embodiment.

Next, the configurations of the valve mechanisms 21 and 28 according to the embodiment will be described with reference to FIGS. 12 to 15. The basic configurations of the first valve mechanism 21 and the second valve mechanism 28 are the same as those of the first embodiment. A force to be used for switching the states of the first valve mechanism 21 and the second valve mechanism 28 is different in that a magnetic force is adopted instead of the pressure of air.

As shown in FIG. 12, the first valve mechanism 21 includes the first upstream chamber 61, the first downstream chamber 62, the first flexible film 64, the second flexible film 65, the first opening and closing portion 66, and the first biasing portion 67 having the same configuration as that of the first embodiment. The first opening and closing portion 66 includes the first shaft portion 72 and the first valve portion 73. The first shaft portion 72 is inserted into the second flexible film 65. One end of the first shaft portion 72 is coupled to the first flexible film 64. The other end of the first shaft portion 72 is coupled to the first valve portion 73.

The first opening and closing portion 66 according to the embodiment has a magnetic force. The first valve mechanism 21 may include a magnet 105 in the first opening and closing portion 66. When a magnetic force from the outside is not applied to the first opening and closing portion 66, the first valve mechanism 21 gets to the adjustment state in which the pressure is adjusted. The first valve mechanism 21 is switched to any one of the first adjustment state, the first open state, and the first closed state by the first opening and closing portion 66 being displaced by the magnetic force from the outside.

The first magnetic force generating portion 110 that applies a magnetic force to the magnet 105 of the first opening and closing portion 66 is disposed on the outside of the housing of the first valve mechanism 21. The first magnetic force generating portion 110 is disposed at an outer position facing the magnet 105 provided in the first opening and closing portion 66 with respect to the first valve mechanism 21.

As shown in FIG. 13, the second valve mechanism 28 includes the second upstream chamber 81, the second downstream chamber 82, the third flexible film 84, the fourth flexible film 85, the second opening and closing portion 86, and the second biasing portion 87 having the same configuration as that of the first embodiment. The second opening and closing portion 86 includes the second shaft portion 92 and the second valve portion 93. The second shaft portion 92 is inserted into the fourth flexible film 85. One end of the second shaft portion 92 is coupled to the third flexible film 84. The other end of the second shaft portion 92 is coupled to the second valve portion 93.

The second opening and closing portion 86 has a magnetic force. The second valve mechanism 28 may include a magnet 106 in the second opening and closing portion 86. When the magnetic force from the outside is not applied to the second opening and closing portion 86, the second valve mechanism 28 gets to the second adjustment state in which the pressure is adjusted. The second valve mechanism 28 is switched to any one of the second open state or the second closed state by the second opening and closing portion 86 being displaced by the action of the magnetic force from the outside.

The second magnetic force generating portion 120 that applies a magnetic force to the magnet 106 of the second opening and closing portion 86 is disposed outside the housing of the second valve mechanism 28. The second magnetic force generating portion 120 is disposed at an outer position facing the magnet 106 provided in the second opening and closing portion 86 with respect to the second valve mechanism 28.

The magnetic force generating portions 110 and 120 may have the same configuration. The magnetic force generating portions 110 and 120 may adopt either of two types of methods having different configurations for applying the magnetic force. One of the methods of the magnetic force generating portions 110 and 120 is a magnet movement method in which the magnetic force acting on the magnets 105 and 106 is switched between approaching and separating the magnets. The other method is an electromagnet method in which a magnetic force acting on the magnets 105 and 106 is generated by an electromagnet.

### Magnetic Force Generating Portion Using Magnet Movement Method

First, the magnetic force generating portions 110 and 120 using the magnet movement method will be described with reference to FIGS. 12 and 13. In FIGS. 12 and 13, the configurations of the magnetic force generating portions 110 and 120 are substantially the same, and will be described with reference to FIG. 12.

As shown in FIG. 12, the first valve mechanism 21 includes the first opening and closing portion 66 having a magnetic force. Although the first valve mechanism 21 shown in FIG. 2 includes the air chamber 63, the first valve mechanism 21 includes the opening and closing portion 66 having a magnetic force instead of the air chamber 63.

Similarly to FIG. 2, the first valve mechanism 21 includes the first upstream chamber 61, the first downstream chamber 62, the first flexible film 64, the second flexible film 65, the first opening and closing portion 66, and the first biasing portion 67. The first opening and closing portion 66 includes the first shaft portion 72 and the first valve portion 73. The first opening and closing portion 66 has a magnetic force.

Specifically, the magnet 105 is fixed to the first valve portion 73 constituting the first opening and closing portion 66. In a housing forming the first downstream chamber 62 of the first valve mechanism 21, the first magnetic force generating portion 110 that applies a magnetic force to the magnet 105 is disposed at a position facing an outer side of a surface portion on an opposite side from the first flexible film 64.

The first magnetic force generating portion 110 includes a vehicle 110S, two magnets 112 and 113 fixed to the vehicle 110S, a drive source 114, and a power transmission mechanism 115. The vehicle 110S is implemented to be movable along a predetermined direction. The predetermined direction may be a direction intersecting a moving direction of the first opening and closing portion 66. In the example shown in FIG. 12, when the moving direction of the first opening and closing portion 66 is a Z direction, the predetermined direction is, for example, a direction along an XY plane. Since the vehicle 110S moves in the predetermined direction, the two magnets 112 and 113 can approach and separate from the magnet 105.

The drive source 114 moves the vehicle 110S in the predetermined direction. The drive source 114 is, for example, a motor or a cylinder.

The power transmission mechanism 115 is implemented to transmit power of the drive source 114 to the vehicle 110S. Examples of the power transmission mechanism 115 include a link mechanism, a belt power transmission mechanism, and a rack and pinion mechanism. When the drive source is implemented to linearly move such as a cylinder, the power transmission mechanism 115 may be eliminated, and a distal end portion of a linearly moving movable body such as a piston rod of the cylinder may be directly fixed to the vehicle 110S.

The two magnets 112 and 113 may be disposed at positions spaced apart from the vehicle 110S in the moving direction. The vehicle 110S is movable to an adjustment position, an opening position, and a closed position. Here, a position facing the magnet 105 is referred to as an acting position PT. The position of the vehicle 110S shown in FIG. 12 is the adjustment position. The adjustment position is a position at which a position corresponding to an interval 111 between the two magnets 112 and 113 is disposed at the acting position PT. The opening position is a position where the magnet 112 is disposed at the acting position PT. The closed position is a position where the magnet 113 is disposed at the acting position PT.

When the vehicle 110S is at the adjustment position where the interval 111 between the first magnet 112 and the second magnet 113 is located at the acting position PT shown in FIG. 12, the interval 111 faces the magnet 105. The magnetic force of the magnetic force generating portion 110 is not applied to the magnet 105 of the first valve portion 73. Therefore, the first valve mechanism 21 gets to the adjustment state without the magnetic force applied to the first opening and closing portion 66. A large positive input pressure P1 acts on the first inflow port 68. The first opening and closing portion 66 opens and closes the first communication port 69 such that the output pressure P2 acting on the first outflow port 70 is adjusted to the first set pressure SP1.

When the vehicle 110S moves to the opening position where the first magnet 112 is located at the acting position PT, a suction force due to the magnetic force is generated between the magnet 105 and the first magnet 112. Due to the suction force, the first valve portion 73 moves to the open position where the first communication port 69 is opened. In this manner, the first valve mechanism 21 is forcibly opened.

On the other hand, when the vehicle 110S moves to the closed position where the second magnet 113 is located at the acting position PT, a repulsive force due to the magnetic force is generated between the second magnet 113 and the magnet 105. Due to the repulsive force, the first valve portion 73 moves to the closed position where the first communication port 69 is closed. In this manner, the first valve mechanism 21 is forcibly closed.

In the second valve mechanism 28 shown in FIG. 13, the second opening and closing portion 86 has the magnet 105 instead of the second air chamber 83 in the second valve mechanism 28 shown in FIG. 3.

Similarly to FIG. 3, the second valve mechanism 28 includes the second upstream chamber 81, the second downstream chamber 82, the third flexible film 84, the fourth flexible film 85, the second opening and closing portion 86, and the second biasing portion 87. The second opening and closing portion 86 includes the second shaft portion 92 and the second valve portion 93. The second opening and closing portion 86 has a magnetic force.

In the example shown in FIG. 13, the magnet 106 is fixed to the second valve portion 93. The magnetic force generating portion 110 is provided on an outer side of a surface portion of the housing of the second valve mechanism 28 on the opposite side from the third flexible film 84. The magnetic force generation unit 110 has a configuration same as that of the magnetic force generating portion 110 shown in FIG. 12, and includes the vehicle 110S, the drive source 114, and the power transmission mechanism 115.

When the vehicle 110S is at the adjustment position where the interval 111 between the first magnet 112 and the second magnet 113 is located at the acting position PT shown in FIG. 13, the magnetic force of the magnetic force generating portion 110 is not applied to the magnet 106 of the second valve portion 93. Therefore, the second valve mechanism 28 is brought into the adjustment state. The second opening and closing portion 86 opens and closes the second communication port 90 so that the output pressure P3 is adjusted to the second set pressure SP2.

When the vehicle 110S moves to the closed position where the first magnet 112 is located at the acting position PT, the second valve portion 93 moves to the closed position where the first communication port 69 is closed by the suction force of the magnetic force acting between the magnet 106 and the first magnet 112. That is, the second valve mechanism 28 is forcibly closed.

On the other hand, when the vehicle 110S moves to the opening position where the second magnet 113 is located at the acting position PT, the second valve portion 93 moves to the opening position where the second communication port 90 is opened by the repulsive force of the magnetic force acting between the second magnet 113 and the magnet 106. In this manner, the second valve mechanism 28 is forcibly opened.

### Valve Mechanism Using Electromagnet Method

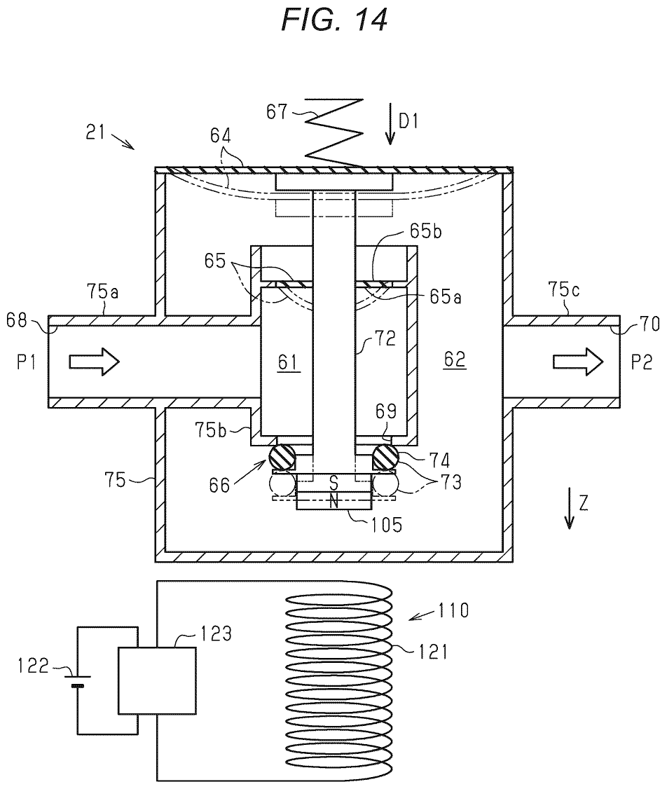

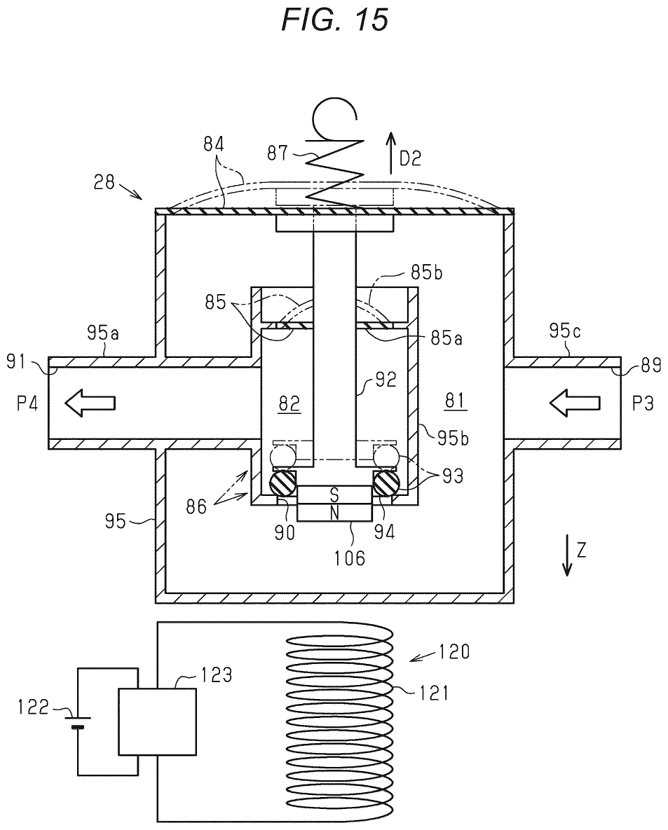

The configurations of the valve mechanisms 21 and 28 including the magnetic force generating portions 110 and 120 using a electromagnet method will be described with reference to FIGS. 14 and 15. The magnetic force generating portions 110 and 120 using the electromagnet method have a configuration different from that shown in FIGS. 12 and 13, whereas the configurations of the valve mechanisms 21 and 22 are the same as those using the magnet movement method. Therefore, the configurations of the magnetic force generating portions 110 and 120 using the electromagnet method will be mainly described below.

As shown in FIG. 14, the configuration of the first valve mechanism 21 is basically the same as that of FIG. 12. The first opening and closing portion 66 has a magnetic force. In the example shown in FIG. 14, the magnet 105 is fixed to the first valve portion 73. The first valve mechanism 21 includes the first magnetic force generating portion 110 on an outer side of a surface portion of the housing forming the first downstream chamber 62 on an opposite side from the first flexible film 64. The first magnetic force generating portion 110 includes a coil 121 constituting an electromagnet, a battery 122 that generates a current in the coil 121, and a switching circuit 123 that switches a direction of a current flowing through the coil 121. The magnet 105 is located at a position on an extension of an axis of the coil 121.

When no current flows through the coil 121, the coil 121 generates no magnetic force. Therefore, the first valve mechanism 21 gets to the first adjustment state. The first opening and closing portion 66 opens and closes the first communication port 69 such that the output pressure P2 acting on the first outflow port 70 is adjusted to the first set pressure SP1.

When a current flows through the coil 121 in the first direction, a repulsive force (a repulsion force) is generated between the magnet 105 and the coil 121 due to a magnetic force generated at an end portion of the coil 121 on the magnet 105 side. Due to the repulsive force, the first valve portion 73 moves to the closed position where the first communication port 69 is closed. In this manner, the first valve mechanism 21 gets to the first closed state in which the closed state is maintained.

On the other hand, when a current flows through the coil 121 in the second direction opposite to the first direction, a suction force (an attraction force) is generated between the magnet 105 and the coil 121 due to the magnetic force generated in the coil 121 on the magnet 105 side. Due to the suction force, the first valve portion 73 moves to the open position where the first communication port 69 is opened. In this manner, the first valve mechanism 21 gets to the first open state in which the open state is maintained.

The second valve mechanism 28 shown in FIG. 15 has a configuration same as that of the second valve mechanism 28 shown in FIG. 13, and the second opening and closing portion 86 has a magnetic force. The magnet 106 is fixed to the second valve portion 93. The second valve mechanism 28 includes the second magnetic force generating portion 120 having a configuration same as that of the first magnetic force generating portion 110 shown in FIG. 14 on the outer side of the surface portion of the housing on the opposite side from the third flexible film 84. The second magnetic force generating portion 120 includes the coil 121, the battery 122, and the switching circuit 123.

When no current flows through the coil 121, the coil 121 generates no magnetic force. Therefore, the second valve mechanism 28 gets to the adjustment state. In the adjustment state, the second opening and closing portion 86 opens and closes the second communication port 90 so that the output pressure P3 is adjusted to the second set pressure SP2.

When a current flows through the coil 121 in a first direction, a repulsive force (a repulsion force) is generated between the magnet 105 and the coil 121. Due to the repulsive force, the second valve portion 93 moves to the open position where the second communication port 90 is opened. In this manner, the second valve mechanism 28 gets to the second open state.

On the other hand, when a current flows through the coil 121 in the second direction opposite to the first direction, a suction force is generated between the magnet 105 and the coil 121. Due to the suction force, the second valve portion 93 moves to the closed position where the second communication port 90 is closed. In this manner, the second valve mechanism 28 gets to the second closed state.

### Functions of Second Embodiment

Next, functions of the second embodiment will be described.

The control unit 100 controls the first magnetic force generating portion 110 and the second magnetic force generating portion 120. The state of the first pressure adjustment valve 36 is switched by the action of the magnetic force generated by the first magnetic force generating portion 110. The first pressure adjustment valve 36 is switched to any one of the first adjustment state, the first open state, and the first closed state. The state of the second pressure adjustment valve 37 is switched by the action of the magnetic force generated by the second magnetic force generating portion 120.

The second pressure adjustment valve 37 is switched to any one of the second adjustment state, the second open state, and the second closed state.

Further, the liquid discharge device 11 performs various operations according to a combination of the states of the first pressure adjustment valve 36 and the second pressure adjustment valve 37. The control unit 100 switches the first pressure adjustment valve 36 and the second pressure adjustment valve 37 to the same states as those in FIGS. 5 to 10 in the first embodiment. Accordingly, similarly to the first embodiment, the liquid discharge device 11 performs operations of the normal circulation (FIG. 5), the standby state and the stop state (FIG. 6), the power supply OFF state (FIG. 7), the cleaning (FIG. 8), the liquid removal in the liquid discharge unit 12 (FIG. 9), and the forced circulation (FIG. 10).

### Advantages of Second Embodiment

Advantages of the embodiment will be described.

(2-1) Since the first opening and closing portion 66 of the first valve mechanism 21 has a magnetic force, the magnetic force can be applied. Therefore, the state of the first opening and closing portion 66 can be switched between the first adjustment state in which the output pressure P2 is adjusted to the first set pressure SP1 and the first open state in which the output pressure P2 is adjusted to a pressure higher than the first set pressure SP1 by maintaining the liquid channel 19 in the open state. Therefore, the liquid can be made to flow by changing the pressure and the flow rate according to the control state.

(2-2) Since the second opening and closing portion 86 of the second valve mechanism 28 has a magnetic force, the magnetic force can be applied. Therefore, the state of the second opening and closing portion 86 can be switched between the second adjustment state in which the output pressure P3 is adjusted to the second set pressure SP2 and the open state in which the output pressure P3 is adjusted to a pressure higher than the second set pressure SP2 by maintaining the liquid channel 19 in the open state. Therefore, the liquid can be made to flow by changing the pressure and the flow rate according to the control state.

(2-3) By simply eliminating the magnetic force acting from the outside on the opening and closing portions 66 and 86, the valve mechanisms 21 and 28 can be set to the adjustment state for adjusting the pressure. Therefore, the pressure of the liquid can be easily controlled by the valve mechanisms 21 and 28.

(2-4) The liquid flowing device 13 (the first liquid flowing portion 13A) includes the first magnetic force generating portion 110 that applies a magnetic force to the first opening and closing portion 66 of the first valve mechanism 21. Therefore, by applying the magnetic force to the first opening and closing portion 66, the liquid can be made to flow by changing the pressure and the flow rate according to the control state.

(2-5) The liquid flowing device 13 (the second liquid flowing portion 13B) includes the second magnetic force generating portion 120 that applies a magnetic force to the second opening and closing portion 86 of the second valve mechanism 28. Therefore, by applying the magnetic force to the second opening and closing portion 86, the liquid can be made to flow by changing the pressure and the flow rate according to the control state.

(2-6) The liquid flowing device 13 includes the first valve mechanism 21 including the first opening and closing portion 66 having a magnetic force, and the second valve mechanism 28 including the second opening and closing portion 86 having a magnetic force. By applying the magnetic force to the opening and closing portions 66 and 86, the liquid can be made to flow by changing the pressure and the flow rate according to the control state.

(2-7) The liquid discharge device 11 includes the liquid flowing device 13 having the magnetic force generating portions 110 and 120. Therefore, the pressure of the liquid flowing into the liquid discharge unit 12 and the pressure of the liquid flowing out of the liquid discharge unit 12 can be changed to pressures and flow rates according to the control state.

(2-8) The states of the first pressure adjustment valve 36 and the second pressure adjustment valve 37 are switched by the magnetic force acting on the switching unit 38. Therefore, the first pressure adjustment valve 36 and the second pressure adjustment valve 37 can be easily switched between their respective states by the action of the magnetic force.

### Third Embodiment

Next, a third embodiment of a valve mechanism, a liquid flowing device, and a liquid discharge device will be described with reference to the drawings. The third embodiment differs from the first embodiment in the liquid flowing device. Since the second embodiment is substantially the same as the first embodiment in other points, the same components are denoted by the same reference numerals, and a redundant description thereof will be omitted.

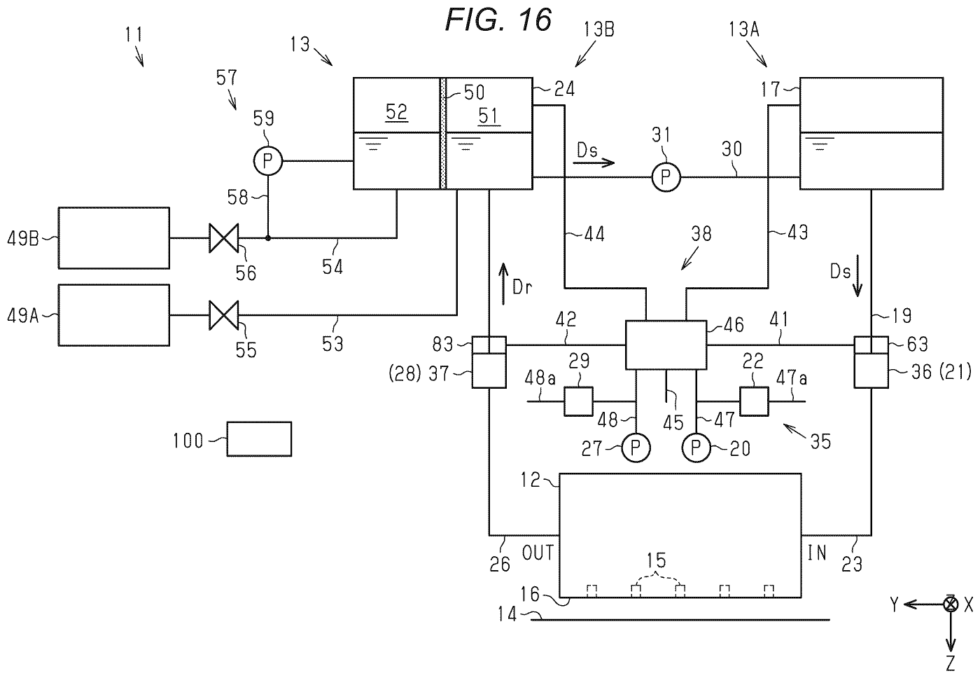

As shown in FIG. 16, the liquid discharge device 11 includes the liquid flowing device 13 as in the first embodiment. The liquid flowing device 13 includes the pressure varying mechanism and the switching unit 38. In the first embodiment, the pressure varying mechanism 35 is coupled to the liquid storage portions 17 and 24. The pressure varied by the pressure varying mechanism 35 is introduced into the switching mechanism 46 constituting the switching unit 38 via the liquid storage portions 17 and 24.

In the embodiment, the pressure varying mechanism 35 is coupled to the switching mechanism 46 constituting the switching unit 38. The pressure varying mechanism 35 includes the pressurizing pump 20 and the pressure release valve 22. The pressure varying mechanism 35 includes the depressurizing pump 27 and the negative pressure release valve 29.

The switching unit 38 includes the first gas channel 41, the second gas channel 42, the third gas channel 43, the fourth gas channel 44, the fifth gas channel 45, a sixth gas channel 47, and a seventh gas channel 48. The gas channels 41 to 45, 47, and 48 are coupled to the switching mechanism 46. The pressurizing pump 20 is coupled to the switching mechanism 46 through the sixth gas channel 47. The pressure release valve 22 is coupled to the switching mechanism 46 through a gas channel 47a or the like. The depressurizing pump 27 is coupled to the switching mechanism 46 through the seventh gas channel 48. The negative pressure release valve 29 is coupled to the switching mechanism 46 through a gas channel 48a or the like.

The pressurizing pump 20 is implemented to pressurize the switching mechanism 46. The depressurizing pump 27 is implemented to depressurize the switching mechanism 46.

To the switching mechanism 46, a positive pressure pressurized by the pressurizing pump 20, a negative pressure depressurized by the depressurizing pump 27, and an atmospheric pressure through the fifth gas channel 45 can be introduced. The switching mechanism 46 is implemented to be able to individually switch the pressure output to the first gas channel 41, the second gas channel 42, the third gas channel 43, and the fourth gas channel 44. The switching mechanism 46 is, for example, a selector valve.

Therefore, in the embodiment, the pressure varying mechanism 35 is coupled to the switching mechanism 46, and the pressure varying mechanism 35 switches between the pressure applied to the liquid storage portions 17 and 24 via the switching mechanism 46 and the pressure introduced into the air chambers 63 and 83 of the two pressure adjustment valves 36 and 37. Other configurations are the same as those of the first embodiment.

Similarly to the first embodiment, the control unit 100 controls the liquid discharge unit 12, the pumps 20, 27, and 59, the liquid sending portion 31, the switching mechanism 46, and the like.

### Configuration of Switching Unit 38

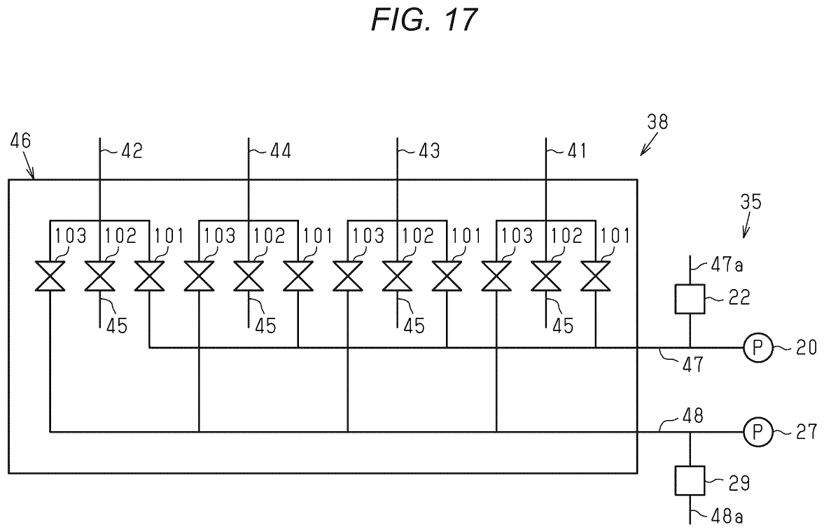

Next, a configuration of the switching mechanism 46 will be described with reference to FIG. 17. As shown in FIG. 17, the switching mechanism 46 constituting the switching unit 38 includes four valve groups each including the first valve 101, the second valve 102, and the third valve 103. The three valves 101 to 103 constituting the valve group have the same configuration as the switching mechanism 46 according to the first embodiment. The three valves 101 to 103 constituting the four valve groups are controlled by the control unit 100. The four valve groups are coupled to the first gas channel 41, the second gas channel 42, the third gas channel 43, and the fourth gas channel 44, respectively. That is, the three valves 101 to 103 constituting the four valve groups are coupled to the common gas channels 41 to 44, respectively. An upstream end of each first valve 101 is coupled to the pressurizing pump 20 through the sixth gas channel 47. An upstream end of each second valve 102 is coupled to the fifth gas channel 45. An upstream end of each third valve 103 is coupled to the depressurizing pump 27 through the seventh gas channel 48.

The pressure of the gas in each of the gas channels 41 to 44 is selected according to which of the first valve 101, the second valve 102, and the third valve 103 of each of the gas channels 41 to 44 is opened. For example, the pressure of the gas in the first gas channel 41 becomes a positive pressure when the first valve 101 is opened. The pressure of the gas in the first gas channel 41 becomes the atmospheric pressure when the second valve 102 is opened. The pressure of the gas in the first gas channel 41 becomes a negative pressure when the third valve 103 is opened. The pressures of the gases in the other three gas channels 42 to 44 are selected according to which of the three valves 101 to 103 is opened.

In this manner, the pressure of the gas supplied to the first pressure adjustment valve 36 through the first gas channel 41 by the switching mechanism 46 is switched to any one of the positive pressure, the atmospheric pressure, and the negative pressure. The pressure of the gas supplied to the second pressure adjustment valve 37 through the second gas channel 42 by the switching mechanism 46 is switched to any one of the positive pressure, the atmospheric pressure, and the negative pressure. The pressure of the gas supplied to the first liquid storage portion 17 through the third gas channel 43 by the switching mechanism 46 is switched to any one of the positive pressure, the atmospheric pressure, and the negative pressure. The pressure of the gas supplied to the second liquid storage portion 24 through the fourth gas channel 44 by the switching mechanism 46 is switched to any one of the positive pressure, the atmospheric pressure, and the negative pressure.

### Operation of Liquid Discharge Device 11

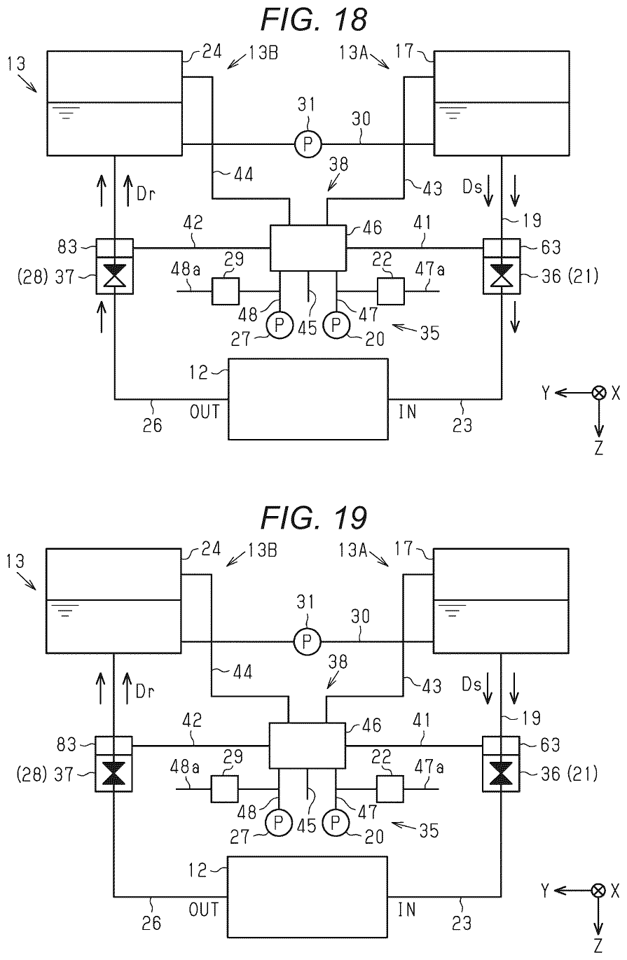

Next, an operation of the liquid discharge device 11 will be described with reference to FIGS. 18 to 27. In FIGS. 18 to 27, similarly to FIG. 5 and the like of the first embodiment, the three states of the first pressure adjustment valve 36 and the second pressure adjustment valve 37 are distinguished by a combination of white and black valve symbols therein. The three states include the adjustment state, the closed state, and the open state.

The switching mechanism 46 is switched and controlled by the control unit 100 (see FIG. 16). The switching mechanism 46 is supplied with the positive pressure (a pressurized air) from the pressurizing pump 20, the negative pressure (a decompressed air) from the depressurizing pump 27, and the atmospheric pressure through the fifth gas channel 45. The switching mechanism 46 adjusts the pressure output to each of the gas channels 41 to 44 by switching each of the internal valves 101 to 103.

The switching mechanism 46 adjusts the pressure of the air chamber 63 of the first pressure adjustment valve 36 through the first gas channel 41. The switching mechanism 46 adjusts the pressure of the air chamber 83 of the second pressure adjustment valve 37 through the second gas channel 42. The switching mechanism 46 adjusts the pressure in the first liquid storage portion 17 through the third gas channel 43. The switching mechanism 46 adjusts the pressure in the second liquid storage portion 24 through the fourth gas channel 44.

FIG. 18 shows a normal circulation. The first air chamber 63 of the first pressure adjustment valve 36 is opened to the atmosphere through the first gas channel 41. The second air chamber 83 of the second pressure adjustment valve 37 is opened to the atmosphere through the second gas channel 42. As a result, the first pressure adjustment valve 36 and the second pressure adjustment valve 37 are both in the adjustment state. The first pressure adjustment valve 36 adjusts the output pressure P2 to the first set pressure SP1. The second pressure adjustment valve 37 adjusts the output pressure P3 to the second set pressure SP2. Here, the first set pressure SP1 is a positive pressure, and the second set pressure SP2 is a negative pressure. The inside of the liquid discharge unit 12 is adjusted to a negative pressure. A relationship of P2>P3 may be satisfied. Therefore, the liquid is circulated by flowing in the supply direction Ds inside the liquid discharge unit 12. A recording operation of discharging the liquid onto the medium 14 is performed during the circulation of the liquid.

FIG. 19 shows a standby state and a stop state. A negative pressure is introduced into the first air chamber 63 of the first pressure adjustment valve 36 through the first gas channel 41. A positive pressure is introduced into the second air chamber 83 of the second pressure adjustment valve 37 through the second gas channel 42. As a result, the first pressure adjustment valve 36 and the second pressure adjustment valve 37 are both in the closed state. Therefore, in the standby state and the stop state, the circulation of the liquid to the liquid discharge unit 12 is stopped.

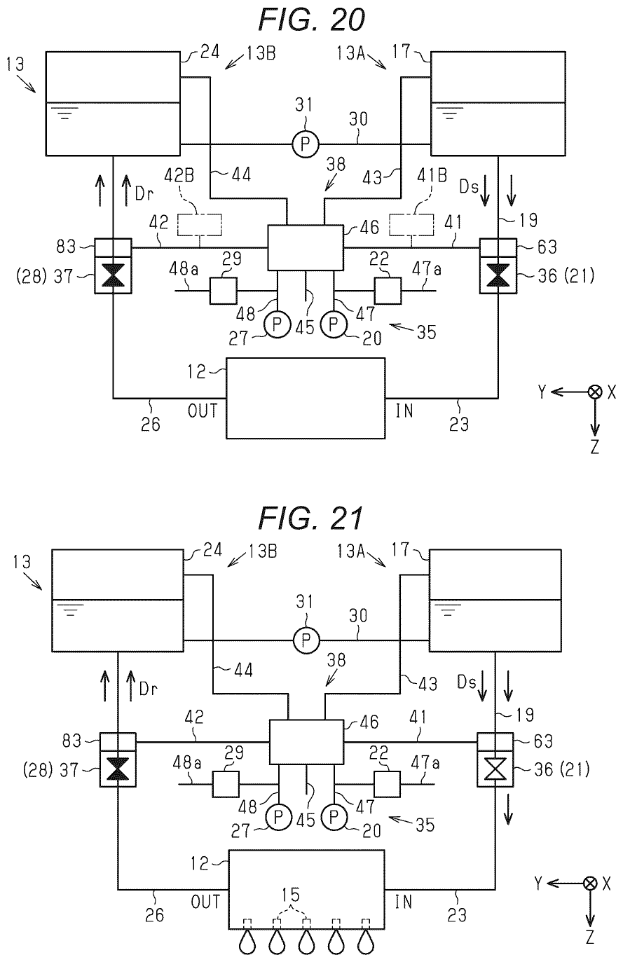

FIG. 20 shows a power supply OFF state. In the power supply OFF state, the pressurizing pump 20 and the depressurizing pump 27 are both stopped. The third gas channel 43 and the fourth gas channel 44 are opened to the atmosphere. The first liquid storage portion 17 and the second liquid storage portion 24 are both opened to the atmosphere. Before the power supply is turned off, the two first valves 101 in the switching mechanism 46 are closed. A negative pressure is introduced into the first air chamber 63 of the first pressure adjustment valve 36 through the first gas channel 41. A positive pressure is introduced into the second air chamber 83 of the second pressure adjustment valve 37 through the second gas channel 42. As a result, while the power supply is turned off, both the first pressure adjustment valve 36 and the second pressure adjustment valve 37 are held in the closed state. Buffer chambers 41B and 42B indicated by two-dot chain lines in FIG. 20 may be provided. Since the buffer chambers 41B and 42B are provided, both the first pressure adjustment valve 36 and the second pressure adjustment valve 37 can be maintained in a closed state over a long period.

FIG. 21 shows a cleaning state. A positive pressure is introduced into the first air chamber 63 of the first pressure adjustment valve 36 through the first gas channel 41. A positive pressure is introduced into the second air chamber 83 of the second pressure adjustment valve 37 through the second gas channel 42. As a result, the first pressure adjustment valve 36 gets to the open state and the second pressure adjustment valve 37 gets to the closed state. The liquid supplied into the liquid discharge unit 12 is discharged from the nozzle 15. That is, cleaning is performed to forcibly discharge the liquid from the nozzle 15 of the liquid discharge unit 12.

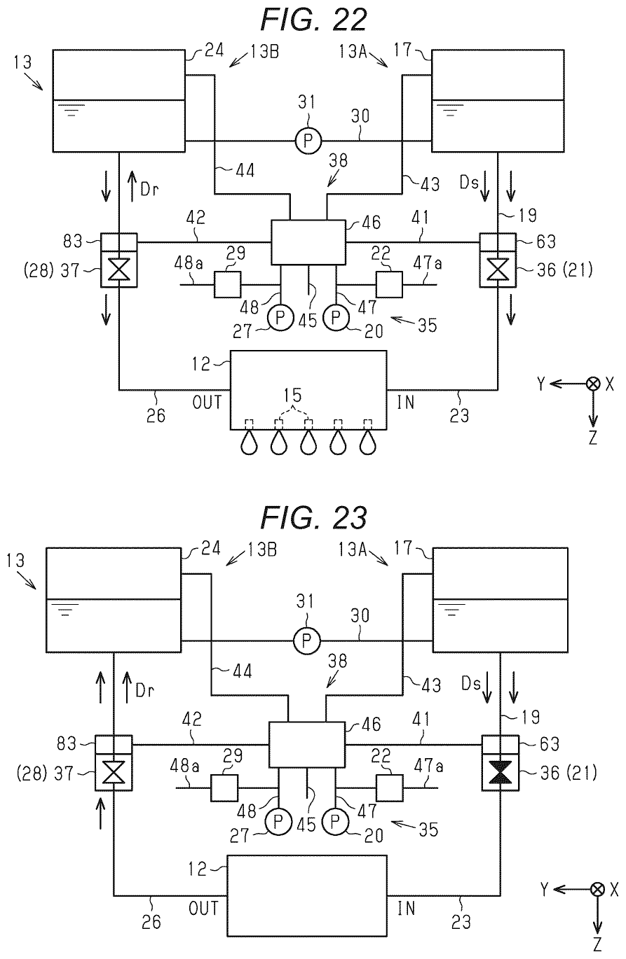

FIG. 22 shows a cleaning state according to another method different from that of FIG. 21. By the switching of the switching mechanism 46, the positive pressure is supplied to both the first liquid storage portion 17 and the second liquid storage portion 24. A positive pressure is introduced into the first air chamber 63 of the first pressure adjustment valve 36 through the first gas channel 41. A negative pressure is introduced into the second air chamber 83 of the second pressure adjustment valve 37 through the second gas channel 42. As a result, the first pressure adjustment valve 36 and the second pressure adjustment valve 37 are both in the open state. The positive pressure liquid from the first liquid storage portion 17 and the positive pressure liquid from the second liquid storage portion 24 are supplied to the liquid discharge unit 12. The liquid supplied into the liquid discharge unit 12 is discharged from the nozzle 15. At this time, the liquid from the first liquid storage portion 17 and the liquid from the second liquid storage portion 24 are supplied to the liquid discharge unit 12 from both sides. Therefore, a discharge flow rate of the liquid from the nozzle 15 is increased. That is, the cleaning stronger than the cleaning shown in FIG. 21 is performed.

FIG. 23 shows a liquid removal state in the liquid discharge unit 12. By the switching control of the switching mechanism 46, a positive pressure is supplied into the first liquid storage portion 17, and a negative pressure is supplied to the second liquid storage portion 24. A negative pressure is introduced into the first air chamber 63 of the first pressure adjustment valve 36 through the first gas channel 41. A negative pressure is introduced into the second air chamber 83 of the second pressure adjustment valve 37 through the second gas channel 42. As a result, the first pressure adjustment valve 36 gets to the closed state and the second pressure adjustment valve 37 gets to the open state. When the first pressure adjustment valve 36 gets to the closed state, the liquid in the liquid discharge unit 12 is collected in the second liquid storage portion 24. That is, the liquid in the liquid discharge unit 12 is forcibly removed into the second liquid storage portion 24 through the second liquid channel 26.

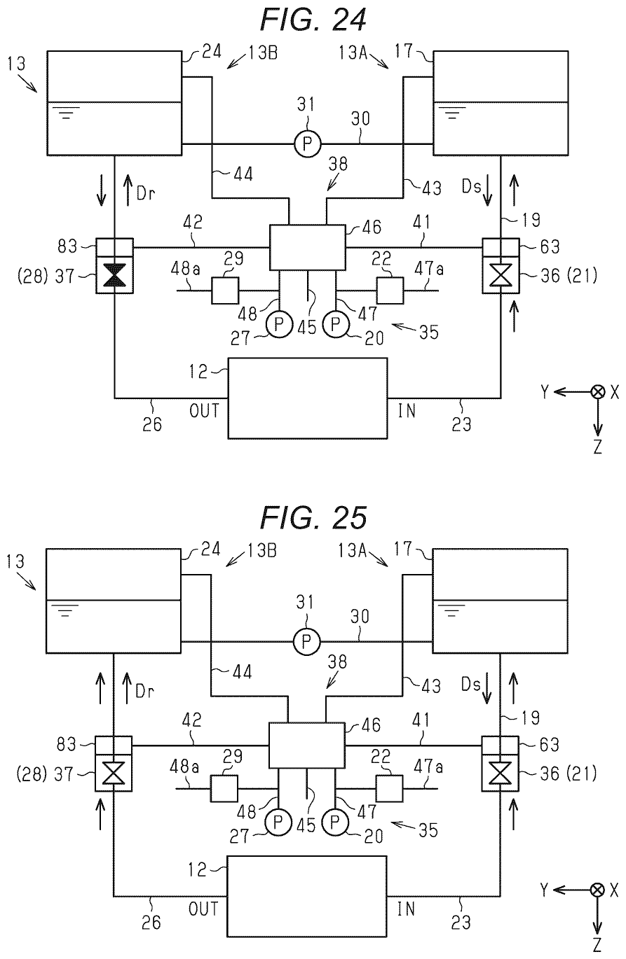

FIG. 24 shows a liquid removal state in the liquid discharge unit 12 according to another method different from that of FIG. 23. By the switching control of the switching mechanism 46, a negative pressure is supplied into the first liquid storage portion 17, and a positive pressure is supplied to the second liquid storage portion 24. A positive pressure is introduced into the first air chamber 63 of the first pressure adjustment valve 36 through the first gas channel 41. A positive pressure is introduced into the second air chamber 83 of the second pressure adjustment valve 37 through the second gas channel 42. As a result, the first pressure adjustment valve 36 gets to the open state and the second pressure adjustment valve 37 gets to the closed state. When the second pressure adjustment valve 37 gets to the closed state, the liquid in the liquid discharge unit 12 is collected in the first liquid storage portion 17. That is, the liquid in the liquid discharge unit 12 is forcibly removed into the first liquid storage portion 17 through the first liquid channel 23.

FIG. 25 shows a liquid removal state in the liquid discharge unit 12 according to another method different from that of FIG. 24. By the switching control of the switching mechanism 46, a negative pressure is supplied to both the first liquid storage portion 17 and the second liquid storage portion 24. A positive pressure is introduced into the first air chamber 63 of the first pressure adjustment valve 36 through the first gas channel 41. A negative pressure is introduced into the second air chamber 83 of the second pressure adjustment valve 37 through the second gas channel 42. As a result, the first pressure adjustment valve 36 and the second pressure adjustment valve 37 are both in the open state. The liquid in the liquid discharge unit 12 is collected in the first liquid storage portion 17 through the first liquid channel 23 and is collected in the second liquid storage portion 24 through the second liquid channel 26. That is, the liquid in the liquid discharge unit 12 is forcibly removed into the first liquid storage portion 17 and the second liquid storage portion 24 through the first liquid channel 23 and the second liquid channel 26 on both sides. Therefore, compared to the liquid removal methods shown in FIGS. 23 and 24, the liquid can be removed from the liquid discharge unit 12 in a shorter time.

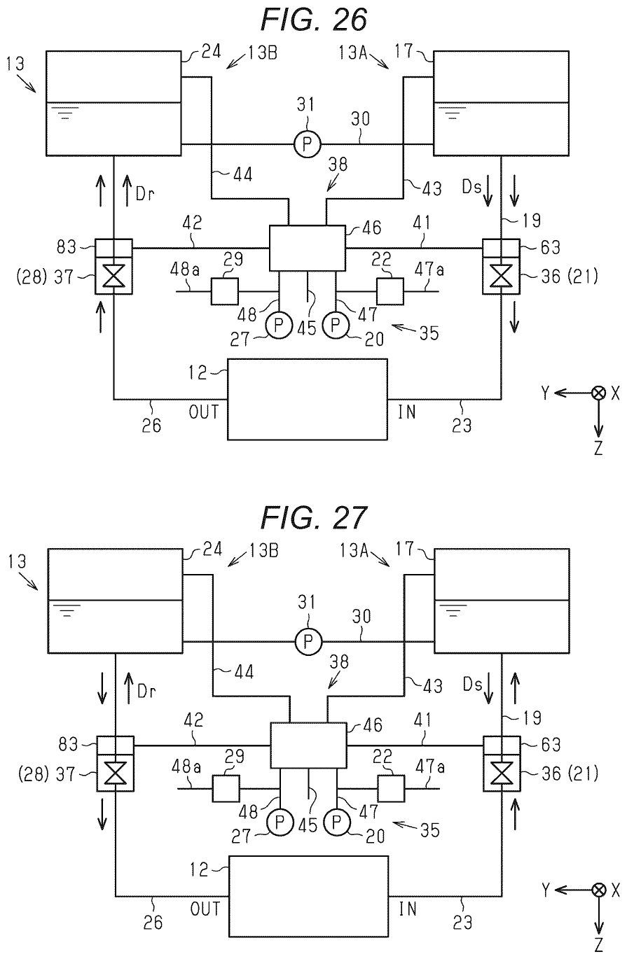

FIG. 26 shows a forced circulation. By the switching control of the switching mechanism 46, a positive pressure is supplied into the first liquid storage portion 17, and a negative pressure is supplied to the second liquid storage portion 24. A positive pressure is introduced into the first air chamber 63 of the first pressure adjustment valve 36 through the first gas channel 41. A negative pressure is introduced into the second air chamber 83 of the second pressure adjustment valve 37 through the second gas channel 42. As a result, the first pressure adjustment valve 36 and the second pressure adjustment valve 37 are both in the open state. The liquid sending portion 31 is driven. The liquid is forcibly circulated in a path passing through the liquid discharge unit 12. For example, the air bubbles accumulated in a filter 141 (see FIG. 33) inside the liquid discharge unit 12 are forcibly discharged. That is, in the forced circulation, since an amount of a circulating liquid per unit time increases compared to the liquid circulation during recording, the air bubbles accumulated in the filter 141 are forcibly discharged by a high flow velocity of the liquid. For example, the forced circulation may be performed when clogging or the like of the nozzle 15 is detected by a nozzle testing device (not shown). The forced circulation may be performed periodically or non-periodically when the recording is not in progress (for example, during standby).

FIG. 27 shows the forced circulation according to another method different from that of FIG. 26. In the forced circulation of the example, a direction in which the liquid circulates is opposite to a liquid circulation direction shown in FIG. 26. By the switching control of the switching mechanism 46, a negative pressure is supplied into the first liquid storage portion 17, and a positive pressure is supplied to the second liquid storage portion 24. A positive pressure is introduced into the first air chamber 63 of the first pressure adjustment valve 36 through the first gas channel 41. A negative pressure is introduced into the second air chamber 83 of the second pressure adjustment valve 37 through the second gas channel 42. As a result, the first pressure adjustment valve 36 and the second pressure adjustment valve 37 are both in the open state. The liquid sending portion 31 is driven. The liquid is forcibly circulated in a path passing through the liquid discharge unit 12. The liquid supplied from the second liquid storage portion 24 through the second liquid channel 26 is collected to the first liquid storage portion 17 through the liquid discharge unit 12 and the first liquid channel 23. For example, by performing the forced circulation in the direction opposite to the normal circulation direction, the air bubbles accumulated in the filter 141 in the liquid discharge unit 12 are efficiently discharged. That is, in the method shown in FIG. 26, the air bubbles are removed by forcibly passing the air bubbles accumulated in the filter 141. In contrast, in the method shown in FIG. 27, the air bubbles accumulated in the filter 141 can be relatively easily removed by a reverse flow.

### Advantages of Third Embodiment

Advantages of the third embodiment will be described. In addition to the effects (1-1) to (1-18) of the first embodiment, the following effects are obtained.

(3-1) The pressurizing pump 20 is coupled to the switching mechanism 46, and the switching mechanism 46 and the first liquid storage portion 17 are coupled through the third gas channel 43. The depressurizing pump 27 is coupled to the switching mechanism 46, and the switching mechanism 46 and the second liquid storage portion 24 are coupled through the fourth gas channel 44. Therefore, the switching mechanism 46 can pressurize and depressurize the first liquid storage portion 17 through the third gas channel 43. The switching mechanism 46 can pressurize and depressurize the second liquid storage portion 24 through the fourth gas channel 44. Therefore, it is possible to cause the liquid discharge device 11 and the liquid flowing device 13 to perform more operations than in the first embodiment, or to select the operation to be adopted from among more candidate operations. For example, it is possible to perform the cleaning state of the reverse flow (FIG. 22), the liquid removal state of the reverse flow in the liquid discharge unit 12 (FIG. 24), the liquid removal in the liquid discharge unit 12 in both the forward flow and the reverse flow (FIG. 25), and the forced circulation of the reverse flow (FIG. 27), or it is possible to select the operation as the operation to be adopted.

### Fourth Embodiment

Next, a fourth embodiment of a valve mechanism, a liquid flowing device, and a liquid discharge device will be described with reference to the drawings. Components same as those of the first embodiment are denoted by the same reference numerals, and a redundant description thereof will be omitted.

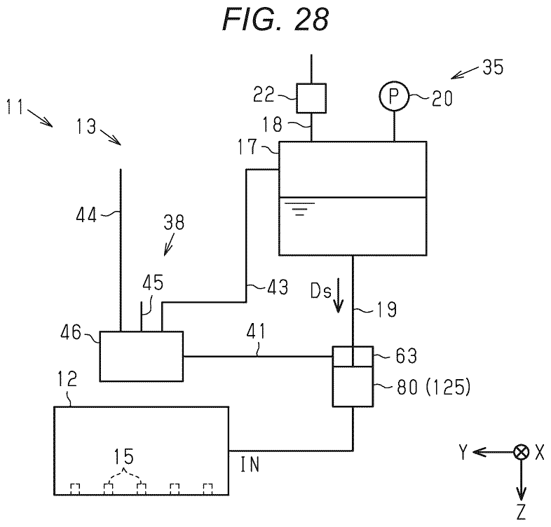

As shown in FIG. 28, the liquid discharge device 11 may include the liquid discharge unit 12 and the liquid flowing device 13 through which the liquid is not circulated. The liquid flowing device 13 may be a type other than a liquid circulation type. The liquid flowing device 13 does not include the second liquid storage portion 24, the second liquid channel 26, the second pressure adjustment valve 37, and the like, which are components necessary for collecting the liquid.

That is, the liquid discharge device 11 includes the liquid flowing device 13 and the liquid discharge unit 12 provided in the liquid channel 19. The liquid flowing device 13 includes a third valve mechanism 125 which is an example of a valve mechanism, the liquid storage portion 17, the liquid channel 19 which is an example of a fluid channel, the pressure varying mechanism 35, and the pressurizing pump 20 which is an example of a pressure generating unit. The liquid flowing device 13 includes the switching unit 38.

The liquid channel 19 includes only the first liquid channel 23 and does not include the second liquid channel 26. The liquid storage portion 17 stores a fluid. The liquid channel 19 is coupled to the liquid storage portion 17. The third valve mechanism 125 is provided in the liquid channel 19.

The pressure varying mechanism 35 varies a pressure of the liquid flowing through a liquid channel 19. The pressure varying mechanism 35 includes the pressurizing pump 20 and the pressure release valve 22. The pressurizing pump 20 pressurizes the liquid storage portion 17. When the pressure in the liquid storage portion 17 exceeds a set pressurized pressure, the pressure release valve 22 releases the air in the first liquid storage portion 17 to the outside, thereby maintaining the pressure in the liquid storage portion 17 at the set pressurized pressure.

The pressurizing pump 20, which is an example of a pressure generating unit, applies the pressure to the inside of the air chamber 63. The switching unit 38 switches the state of the negative pressure release valve 80 by switching the pressure in the air chamber 63 of the negative pressure release valve 80. The switching unit 38 includes the switching mechanism 46. The pressure that the pressurizing pump 20 pressurizes the liquid storage portion 17 is introduced into the switching mechanism 46. In this respect, the pressurizing pump 20 serves both as the pressure varying mechanism 35 and the pressure generating unit.

The switching mechanism 46 is, for example, a selector valve. The switching unit 38 includes the first gas channel 41, the third gas channel 43, the fourth gas channel 44, and the fifth gas channel 45 coupled to the switching mechanism 46. The switching mechanism 46 and the air chamber 63 of the negative pressure release valve 80 are coupled through the first gas channel 41. To the switching mechanism 46, a pressurized air is introduced through the third gas channel 43, and a negative pressure is introduced through the fourth gas channel 44. The switching mechanism 46 can communicate with the atmosphere through the fifth gas channel 45. The switching mechanism 46 switches the pressure in the air chamber 63 of the negative pressure release valve 80 through the first gas channel 41.

The third valve mechanism 125 constitutes the negative pressure release valve 80. The state of the negative pressure release valve 80 is switched by switching the pressure of the air introduced into the air chamber 63. The negative pressure release valve 80 is switched to a third adjustment state, a third open state, and a third closed state. In the third adjustment state, the negative pressure release valve 80 adjusts a downstream output pressure to the set pressure. The negative pressure release valve 80 in the third adjustment state has functions same as those in a self-sealing valve in the related art. The negative pressure release valve 80 can be switched between the third open state and the third closed state in addition to the third adjustment state in which a function similar to that of the self-sealing valve is performed.

The negative pressure release valve 80 is provided in the liquid channel 19. The negative pressure release valve 80 receives a positive pressure liquid supplied from the liquid storage portion 17 and outputs the liquid decompressed to a predetermined negative pressure. The negative pressure liquid output by the negative pressure release valve 80 is supplied to the liquid discharge unit 12. The inside of the liquid discharge unit 12 is maintained at a negative pressure. During standby or recording, the inside of the liquid discharge unit 12 is kept at a negative pressure, so that a meniscus of the liquid is formed inside the nozzle 15. Therefore, the liquid is appropriately discharged from the nozzle 15, and a liquid leakage from the nozzle 15 is prevented.

### Configuration of Third Valve Mechanism

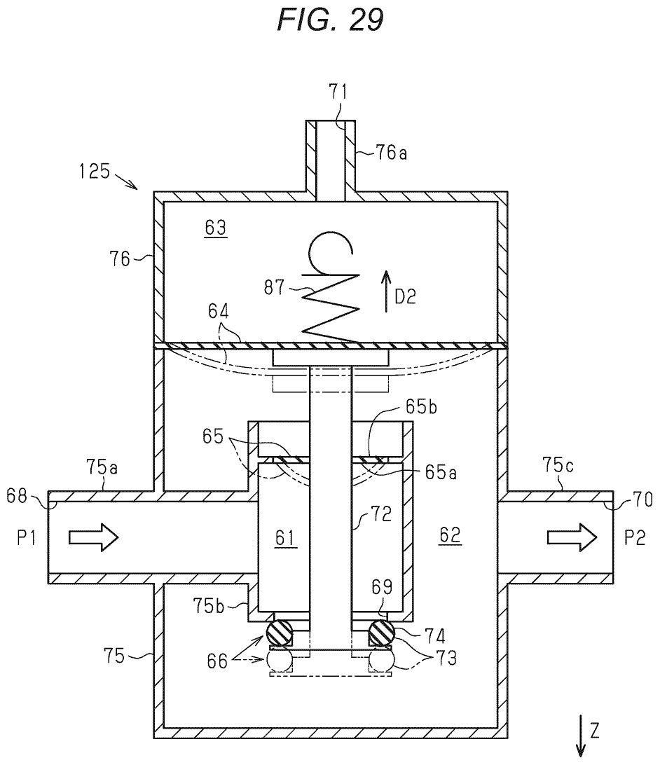

Next, the third valve mechanism 125, which is an example of a valve mechanism to be used in the negative pressure release valve 80, will be described with reference to FIG. 29. The third valve mechanism 125 has a configuration in which the first biasing portion 67 of the first valve mechanism 21 is replaced with the second biasing portion 87 which is an example of the biasing portion.

Similarly to the first valve mechanism 21 in the first embodiment, the third valve mechanism 125 includes the first upstream chamber 61, the first downstream chamber 62, the first air chamber 63, the first flexible film 64, the second flexible film 65, the first opening and closing portion 66, and the first biasing portion 67. The first opening and closing portion 66 includes the first shaft portion 72 and the first valve portion 73. The second biasing portion 87 biases the first flexible film 64 in the air chamber 63. The second biasing portion 87 biases the first flexible film 64 in a direction in which the volume of the first downstream chamber 62 increases. The second biasing portion 87 may be a tension spring.

The first shaft portion 72 is inserted into the second flexible film 65. One end of the first shaft portion 72 is coupled to the first flexible film 64. The other end of the first shaft portion 72 is coupled to the first valve portion 73. The first opening and closing portion 66 is movable between a closed position indicated by a solid line in FIG. 29 and an opening position indicated by a two-dot chain line in FIG. 29. In FIG. 29, a direction in which the liquid flows is indicated by a white arrow.

When the atmospheric pressure is applied to the outside of the first flexible film 64, the third valve mechanism 125 gets to the third adjustment state in which the pressure is adjusted. The third valve mechanism 125 gets to the third open state when a positive pressure is applied to the outside of the first flexible film 64. The third valve mechanism 125 gets to the third closed state when negative pressure acts on the outside of the first flexible film 64.

During recording or standby, the third valve mechanism 125 is switched to the third adjustment state. In the third adjustment state, the output pressure P2 of the third valve mechanism 125 is adjusted to a set pressure that is a negative pressure smaller than the input pressure P1. During cleaning, the third valve mechanism 125 is switched to the third open state. For example, the third valve mechanism 125 may be switched to the third closed state when the power supply is turned off.

### Advantages of Fourth Embodiment

Advantages of the embodiment will be described.

(4-1) Since the third valve mechanism 125 includes the first air chamber 63, the pressure can be applied via the first air chamber 63. Therefore, the state of the first opening and closing portion 66 can be switched between the adjustment state in which the output pressure is adjusted to a set pressure (constant) and the open state in which the output pressure is adjusted to a pressure higher than the set pressure by maintaining the liquid channel 19 in the open state. Therefore, the liquid can be made to flow by changing the pressure and the flow rate according to the control state.

(4-2) Since the pressure can be adjusted by simply opening the outside of the third flexible film 84 (the second air chamber 83) to the atmosphere, the pressure can be easily controlled.

(4-3) Since the liquid flowing device 13 has the third valve mechanism 125, it is possible to cause the fluid to flow by changing the pressure and the flow rate according to the control state.

### Modifications

The embodiment can be changed and implemented as explained below. The embodiment and the following modifications can be implemented in combination with each other as long as no technical inconsistencies are involved.

### First Modification

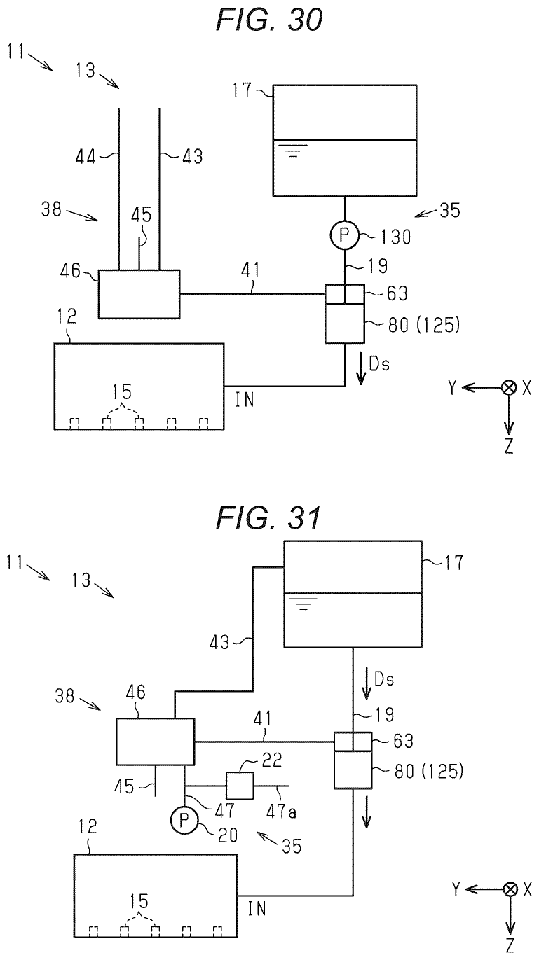

As shown in FIG. 30, a liquid pump 130 may be provided in the liquid channel 19. The liquid pump 130 constitutes the pressure varying mechanism 35 that varies a pressure of a liquid flowing through the liquid channel 19. The liquid pump 130 is provided at a position between the liquid storage portion 17 and the third valve mechanism 125 in the liquid channel 19. The liquid pump 130 causes the liquid in the liquid channel 19 to flow in the supply direction Ds. The negative pressure release valve 80, which is an example of the valve mechanism, is provided at a position downstream of the liquid pump 130 in the liquid channel 19. The air chamber 63 of the negative pressure release valve 80 is coupled to the switching mechanism 46 constituting the switching unit 38 through the first gas channel 41. The third gas channel 43 through which a pressurized gas flows, the fourth gas channel 44 through which a depressurized gas flows, and the fifth gas channel 45 that is opened to the atmosphere may be coupled to the switching mechanism 46. The pressure of the air introduced into the air chamber 63 of the negative pressure release valve 80 through the first gas channel 41 by the switching mechanism 46 is switched to any one of the atmospheric pressure, the positive pressure, and the negative pressure. When the air chamber 63 is at the atmospheric pressure, the negative pressure release valve 80 functions as a self-sealing valve that adjusts the output pressure to a set pressure (a negative pressure set value). For example, when a positive pressure is introduced into the air chamber 63 during cleaning, the negative pressure release valve 80 gets to the open state. In this state, the liquid pump 130 sends the liquid having a pressure higher than the set pressure to the liquid discharge unit 12, thereby performing the cleaning in which the liquid is forcibly discharged from the nozzle 15. In this way, the liquid pump 130 constituting the pressure varying mechanism 35 may be implemented not to also serve as a pressure generating unit that applies a pressure to the inside of the air chamber 63.

### Second Modification

As shown in FIG. 31, the liquid flowing device 13 according to the fourth embodiment may be implemented such that the switching mechanism 46 supplies the gas pressurized by the pressurizing pump 20 constituting the pressure varying mechanism 35 to the liquid storage portion 17 through the third gas channel 43. The pressurizing pump 20 is coupled to the switching mechanism 46 constituting the switching unit 38 through the gas channel 47. The pressure release valve 22 is provided in the gas channel 47a coupled to the gas channel 47. The switching mechanism 46 and the liquid storage portion 17 are coupled through the third gas channel 43. The pressure in a region of air above a liquid surface in the liquid storage portion 17 can be switched between a positive pressure and an atmospheric pressure through the third gas channel 43. For example, during recording or during standby, the inside of the liquid storage portion 17 is pressurized. The positive pressure liquid flows out from the liquid storage portion 17 to the liquid channel 19. At this time, the air chamber 63 gets to the atmospheric pressure, so that the negative pressure release valve 80 gets to the adjustment state. During cleaning, the inside of the liquid storage portion 17 is pressurized. When the air chamber 63 has a positive pressure, the negative pressure release valve 80 gets to the open state. By supplying the positive pressure liquid to the liquid discharge unit 12, the liquid is forcibly discharged from the nozzle 15. For example, when the power supply is turned off, the inside of the liquid storage portion 17 is at the atmospheric pressure. The negative pressure release valve 80 may be set to the closed state by causing the air chamber 63 to have a negative pressure.

### Third Modification

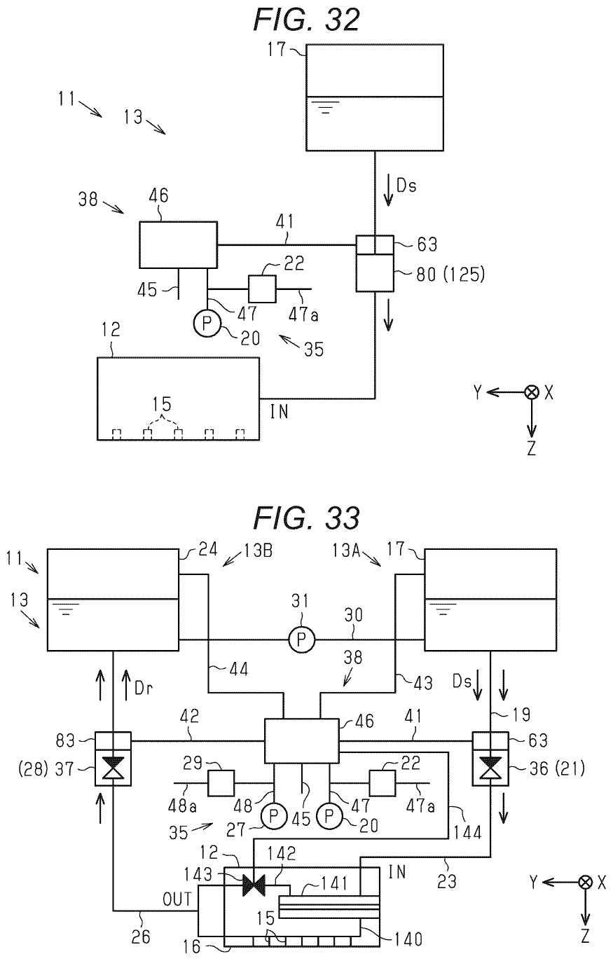

As shown in FIG. 32, the liquid flowing device 13 in the fourth embodiment may be implemented to supply the liquid from the liquid storage portion 17 to the liquid discharge unit 12 by a head difference between the liquid storage portion 17 and the liquid discharge unit 12. The pressurizing pump 20 may have only a function of a pressure generating unit that generates a pressure to be applied to the air chamber 63 of the negative pressure release valve 80. Cleaning can be performed by introducing a positive pressure into the air chamber 63 and opening the negative pressure release valve 80 to send the liquid pressurized by the head difference to the liquid discharge unit 12, or by suction cleaning, in which liquid is sucked from the nozzle 15 of the liquid discharge unit 12.

### Fourth Modification

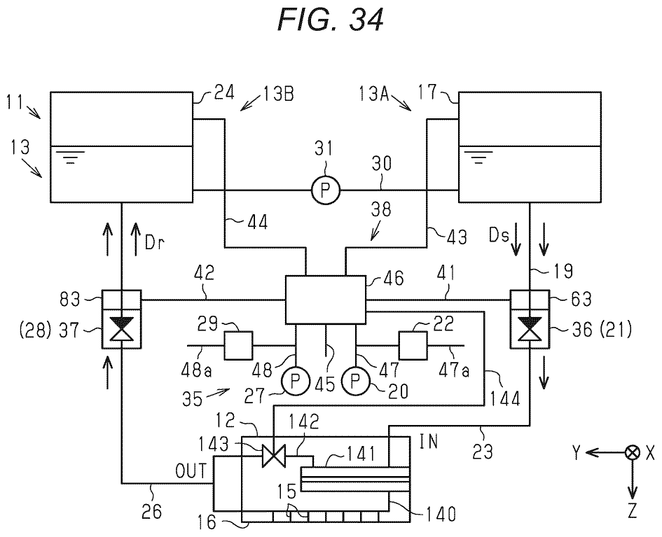

As shown in FIGS. 33 and 34, a mechanism for removing air bubbles accumulated in the filter 141 in the liquid discharge unit 12 may be provided. The liquid discharge unit 12 includes the filter 141 that filters the liquid supplied through the liquid channel 19. The filter 141 is provided in the liquid channel 19 in the liquid discharge unit 12. The filter 141 removes air bubbles, a foreign matter, and the like from the liquid. The liquid filtered by the filter 141 is supplied to each nozzle 15 through the channel 140. The channel 140 is a part of the liquid channel 19. The nozzle 15 discharges the liquid from which the air bubbles are removed. When the air bubbles accumulate in the filter 141, the supply of the liquid to the nozzle 15 and the circulation of the liquid are not smoothly performed. As shown in FIG. 33, the downstream end of the first liquid channel 23 and the upstream end of a bypass channel 142 face an upstream surface of the filter 141 at different positions. An on-off valve 143 is provided in the bypass channel 142. The on-off valve 143 and the switching mechanism 46 are coupled through an eighth gas channel 144. The switching mechanism 46 switches an open and close state of the on-off valve 143 by switching the pressure of the air supplied to the on-off valve 143 through the eighth gas channel 144. As shown in FIG. 33, during a normal circulation such as recording or standby, the first pressure adjustment valve 36 and the second pressure adjustment valve 37 are both in the adjustment state. The on-off valve 143 is closed. Therefore, the circulating liquid passing through the liquid discharge unit 12 is filtered by the filter 141. On the other hand, when the air bubbles or the like accumulate in the filter 141, a channel resistance of the filter 141 increases, and the liquid does not easily flow smoothly. At a regular or irregular cleaning timing, the control unit 100 controls the switching mechanism 46 to switch the on-off valve 143 from a closed state to an open state as shown in FIG. 34. As a result, the liquid flows along the surface on the upstream side of the filter 141 from the downstream end of the first liquid channel 23 toward the upstream end of the bypass channel 142. By the flow of the liquid, the air bubbles and the like accumulated on the surface on the upstream side of the filter 141 are removed from the filter 141. The cleaning timing may be determined by the control unit 100 based on a detection result of a detection unit such as a sensor that detects a state of accumulation of the air bubbles or the like in the filter 141.

### Fifth Modification

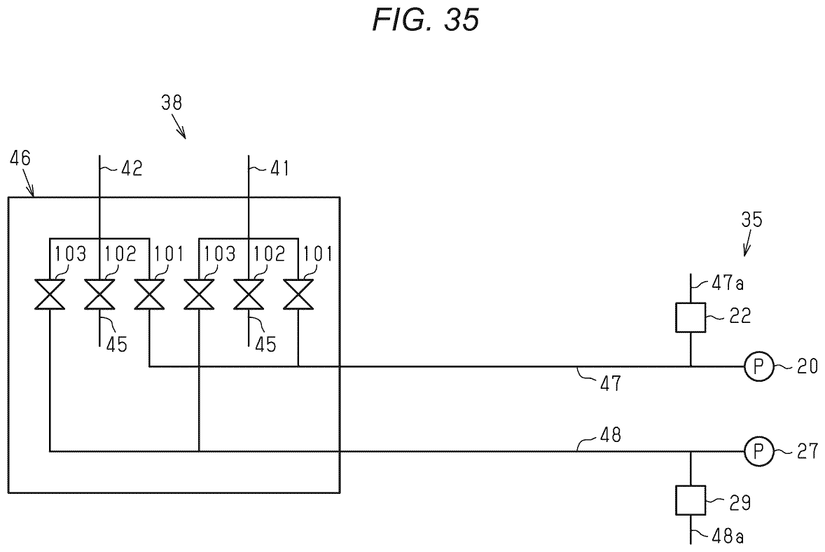

As shown in FIG. 35, the third gas channel 43 and the fourth gas channel 44, one end of which is coupled to the switching mechanism 46, may be coupled to the pressurizing pump 20 and the depressurizing pump 27 dedicated to switching the pressure adjustment valves 36 and 37. The switching mechanism 46 is coupled to the first gas channel 41 coupled to the air chambers 63 and 83 of the first pressure adjustment valve 36 and the second gas channel 42 coupled to the air chamber 83 of the second pressure adjustment valve 37. As described above, the pressurizing pump 20 and the depressurizing pump 27 may be implemented to constitute the pressure generating unit that generates the pressure applied to the air chambers 63 and 83, but not to serve as the pressure varying mechanism 35 that varies the pressure of the liquid flowing through the liquid channel 19. A pump that constitutes the pressure varying mechanism 35 that performs pressurization of the first liquid storage portion 17 or depressurization of the second liquid storage portion 24 may be separately provided.

### Sixth Modification

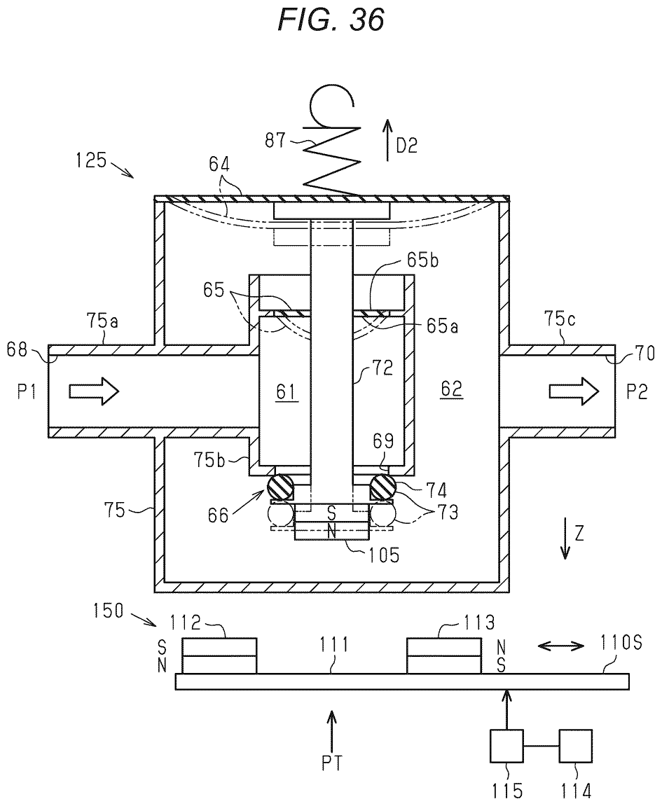

In the liquid discharge device 11 and the liquid flowing device 13 in the fourth embodiment (FIG. 28), the state of the third valve mechanism 125 may be switched by a magnetic force method in which a magnetic force is applied to the opening and closing portion 66 having a magnetic force, instead of the pressure method in which a pressure is applied to the air chamber 63. The switching unit 38 includes the magnetic force generating portion 150 instead of the first air chamber 63 as shown in FIG. 36. The liquid flowing device 13 including the negative pressure release valve 80 as the third valve mechanism 125 includes the third valve mechanism 125, the liquid storage portion 17, the liquid channel 19, and the pressure varying mechanism 35 as in the fourth embodiment shown in FIG. 28. The pressure varying mechanism 35 that varies the pressure of the liquid flowing through the liquid channel 19 includes the magnetic force generating portion 150 that applies a magnetic force to the opening and closing portion 66. The magnetic force generating portion 150 causes a magnetic force to be applied to the opening and closing portion 66 having a magnetic force, thereby varying the pressure of the liquid flowing through the liquid channel 19.

As shown in FIG. 36, the third valve mechanism 125 is basically the same as that of the fourth embodiment except for the air chamber 63. That is, the third valve mechanism 125 includes the upstream chamber 61, the downstream chamber 62, the second flexible film 65, the opening and closing portion 66, and the biasing portion 87. In the third valve mechanism 125 shown in FIG. 36, the opening and closing portion 66 has a magnetic force.

As shown in FIG. 36, the magnet 105 is fixed to the valve portion 73. The third valve mechanism 125 includes the magnetic force generating portion 150 at a position on an outer side of a surface portion of the housing forming the downstream chamber 62 on an opposite side from the first flexible film 64. The magnetic force generating portion 150 has a configuration same as that of the second embodiment.

When the vehicle 110S is at the adjustment position where the interval 111 between the first magnet 112 and the second magnet 113 is located at the acting position PT shown in FIG. 36, the magnetic force of the magnetic force generating portion 150 is not applied to the magnet 105 of the valve portion 73. Therefore, the third valve mechanism 125 gets to the adjustment state. In the adjustment state, the opening and closing portion 66 opens and closes the communication port 69 so that the output pressure P2 is adjusted to the first set pressure SP1.

When the vehicle 110S moves to the opening position where the first magnet 112 is located at the acting position PT, the valve portion 73 moves to the opening position where the communication port 69 is opened by the suction force of the magnetic force acting between the first magnet 112 and the magnet 105. In this manner, the third valve mechanism 125 gets to the open state. For example, during cleaning, the third valve mechanism 125 gets to the open state. When the vehicle 110S moves to the opening position where the first magnet 112 is located at the acting position PT, the valve portion 73 moves to the closed position where the communication port 69 is closed by the repulsive force of the magnetic force acting between the second magnet 113 and the magnet 105. In this manner, the third valve mechanism 125 gets to the closed state. For example, when the power supply is turned off, the third valve mechanism 125 gets to the closed state.

### Seventh Modification

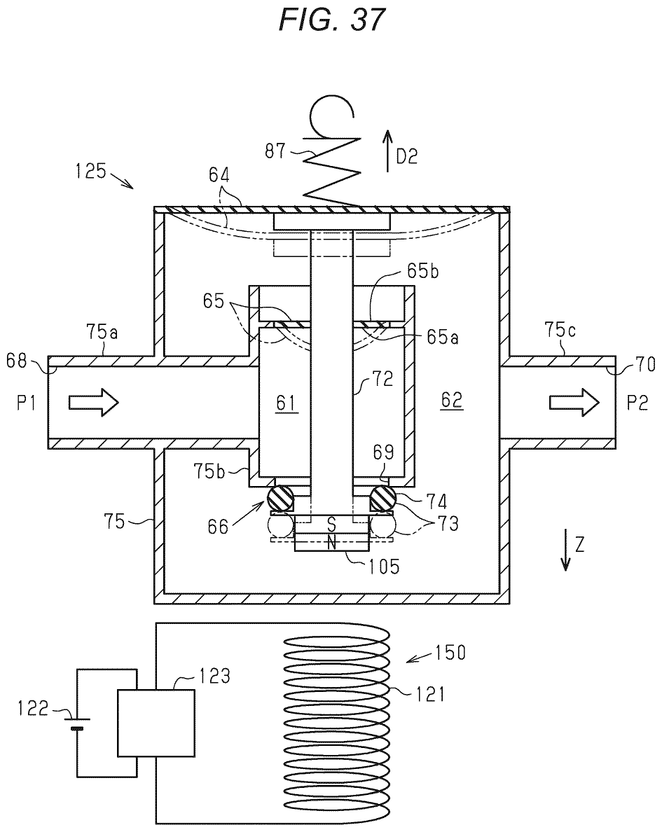

In the sixth modification, the third valve mechanism 125 may include the magnetic force generating portion 150 using the electromagnet method as shown in FIG. 37 instead of the magnetic force generating portion 150 using the magnet movement method as shown in FIG. 36. The magnetic force generating portion 150 of the third valve mechanism 125 has a configuration same as that shown in FIG. 14 in the second embodiment. The magnetic force generating portion 150 includes the switching circuit 123 that switches a direction of a current flowing through the coil 121 constituting the electromagnet, and the battery 122 that is a power supply coupled to the switching circuit 123. When no current flows through the coil 121, the magnetic force of the magnetic force generating portion 150 does not act on the magnet 105 of the valve portion 73. Therefore, the opening and closing portion 66 opens and closes the communication port 69 so that the output pressure P2 is adjusted to the first set pressure SP1. When a current flows through the coil 121 in the first direction, the valve portion 73 moves to the open position where the communication port 69 is opened by the suction force of the magnetic force. In this manner, the third valve mechanism 125 gets to the open state. For example, during cleaning, the third valve mechanism 125 gets to the open state. When a current flows through the coil 121 in the second direction opposite to the first direction, the valve portion 73 moves to the closed position where the communication port 69 is closed due to the repulsive force of the magnetic force. In this manner, the third valve mechanism 125 gets to the closed state. For example, when the power supply is turned off, the third valve mechanism 125 gets to the closed state.

### Eighth Modification

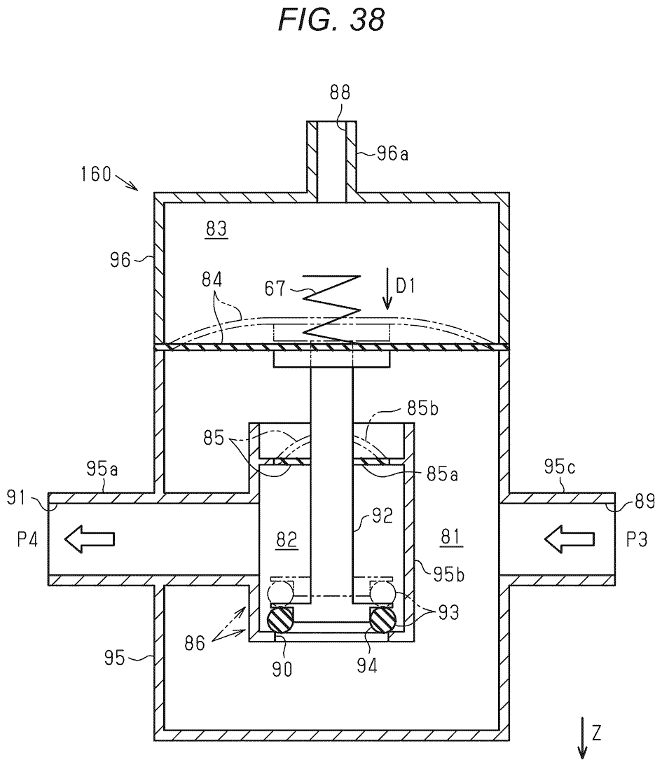

The state may be switched using a fourth valve mechanism 160 which is an example of the valve mechanism shown in FIG. 38. The fourth valve mechanism 160 functions as a pressure release valve in the adjustment state. The fourth valve mechanism 160 has a configuration in which the second biasing portion 87 is replaced with the first biasing portion 67 in the second valve mechanism 28. The configuration is the same as that of the second valve mechanism 28 except that an example of the biasing portion is the first biasing portion 67. That is, the fourth valve mechanism 160 includes the second upstream chamber 81, the second downstream chamber 82, the second air chamber 83, the third flexible film 84, the fourth flexible film 85, the second opening and closing portion 86, and the first biasing portion 67. Therefore, the members and the like same as those of the second valve mechanism 28 are denoted by the same reference numerals, and detailed description thereof will be omitted. The first biasing portion 67 biases the third flexible film 84 in a direction that reduces the volume of the upstream chamber 81. The first biasing portion 67 may be, for example, a compression spring. The direction in which the third flexible film 84 is displaced to reduce the volume of the upstream chamber 81 is the direction in which the valve portion 93 is closed. The fourth valve mechanism 160 gets to the adjustment state when the air chamber 83 is at the atmospheric pressure. When the fourth valve mechanism 160 gets to the adjustment state, the third flexible film 84 receives the atmospheric pressure and the biasing force of the first biasing portion 67 on the surface on the air chamber 83 side in the first direction D1. Therefore, in order to open the valve portion 73 in the closed state, it is necessary that a positive pressure that overcomes the atmospheric pressure and the biasing force of the first biasing portion 67 acts on the liquid in the upstream chamber 81. A position indicated by a solid line in FIG. 38 is a closed valve state. When the pressure P3 of the upstream chamber 81 becomes higher than the set positive pressure, the valve portion 73 is opened. A position indicated by a two-dot chain line in FIG. 38 is an open valve state. When the valve portion 73 opens, the liquid flows from the upstream chamber 81 to the downstream chamber 82 through the communication port 90. As a result, the pressure in the upstream chamber 81 decreases, and the valve portion 73 closes. In this manner, the opening and closing of the fourth valve mechanism 160 is adjusted so that the upstream output pressure P3 is maintained at the set pressure of the positive pressure. When the air chamber 83 is depressurized, the fourth valve mechanism 160 gets to the open state. When the air chamber 83 is pressurized, the fourth valve mechanism 160 gets to the closed state. By providing the air chamber 83 in such a pressure release valve, the fourth valve mechanism 160 may be switched among three states.

### Ninth Modification

The configuration for switching the states of the fourth valve mechanism 160 shown in FIG. 38 may be the opening and closing portion 86 having a magnetic force that can be switched by a magnetic force, instead of the air chamber 83 that can be switched by a pressure. In this case, the magnetic force generating portion 110 shown in FIG. 36 or the magnetic force generating portion 120 shown in FIG. 37 may be provided as the switching mechanism. The magnetic force generating portions 110 and 120 may switch the state of the fourth valve mechanism 160 by switching presence or absence of the magnetic force acting on the magnet 105 and a type of a magnetic pole. The magnet 105 is not limited to the valve portion 93, and may be provided in another portion constituting the opening and closing portion 86. For example, the magnet 105 may be provided at the second end portion of the shaft portion 92 on an opposite side from the first end portion on the valve portion 93 side, or in the vicinity of the second end portion. In this case, the magnetic force generating portions 110 and 120 may be disposed at positions on the outer side (an atmosphere side) facing the third flexible film 84.

### Other Modifications

In the liquid discharge device 11 and the liquid flowing device 13 shown in FIG. 1, FIG. 16, and the like, the third valve mechanism 125 shown in FIG. 29 may be used as the first pressure adjustment valve 36 instead of the first valve mechanism 21.

In the liquid discharge device 11 and the liquid flowing device 13 shown in FIG. 11 and the like, the first pressure adjustment valve 36 may be replaced with the first valve mechanism 21 using a magnetic force method, and the third valve mechanism 125 using the magnetic force method shown in FIGS. 36 and 37 may be used.

In the liquid discharge device 11 and the liquid flowing device 13 shown in FIGS. 1,11, 16, and the like, the first valve mechanism 21 and the second valve mechanism 28 may be a mixture of a pressure type having an air chamber and a magnetic type in which the opening and closing portion has a magnetic force.

In the liquid discharge device 11 and the liquid flowing device 13 shown in FIG. 1, FIG. 11, FIG. 16, FIG. 28, and the like, the fourth valve mechanism 160 shown in FIG. 38 may be used as the pressure release valve 22. Therefore, the fluid targeted by the fourth valve mechanism 160 may be a gas. According to the configuration, the pressure release valve 22 can be switched to the adjustment state, the open state, and the closed state. Therefore, in the pressure release valve 22, the fluid can be made to flow by changing the pressure and the flow rate according to the control state.

In the liquid discharge device 11 and the liquid flowing device 13 shown in FIGS. 1,11, 16, and 28, the third valve mechanism 125 may be used as the negative pressure release valve 29. Therefore, the fluid targeted by the second valve mechanism 28 may be a gas. According to the configuration, the negative pressure release valve 29 can be switched to the adjustment state, the open state, and the closed state. Therefore, in the negative pressure release valve 29, the fluid can be made to flow by changing the pressure and the flow rate according to the control state.

In each of the above embodiments, the valve mechanisms 21, 28, 125, and 160 may be switched between the adjustment state and the open state, or between the adjustment state and the closed state. Further, only the open state and the closed state may be used.

In the liquid discharge device 11 and the liquid flowing device 13 in the first to third embodiments, the first pressure adjustment valve 36 may be replaced with the first valve mechanism 21 functioning as a pressure adjustment valve, and may be replaced with the third valve mechanism 125 functioning as a self-sealing valve.

In the valve mechanisms 21, 28, 125, and 160, one ends of the shaft portions 72 and 92 may be directly or indirectly coupled to the flexible films 64 and 84.

The pressure may be adjusted to a pressure lower than the set pressure.

The switching mechanism 46 is not limited to the configuration in which the two pressure adjustment valves 36 and 37 are switched. For example, a first switching unit and a second switching unit corresponding to the pressure adjustment valves 36 and 37 may be collectively used as the switching unit. In this case, the first switching unit and the second switching unit may include a common pressure generating unit, or may individually include a first pressure generating unit and a second pressure generating unit. The first switching unit and the second switching unit may include a common magnetic force generating portion, or may individually include a first magnetic force generating portion and a second magnetic force generating portion.

In the second embodiment, the magnet 105 is not limited to being provided in the valve portion 73, and may be provided in the opening and closing portion 66. The magnet 105 may be provided in the shaft portion 72. For example, the magnet 105 may be provided at an end portion of the shaft portion 72 on the first flexible film 64 side. In this case, the magnetic force generating portions 110 and 120 may be disposed on the outer side facing the first flexible film 64. Further, the present disclosure is not limited to the configuration in which the magnets 105 are provided in the opening and closing portions 66 and 86, and the opening and closing portion 66 itself may have a magnetic force.

In the third embodiment, one of the pressurizing pump 20 and the depressurizing pump 27 may be coupled to one of the liquid storage portions 17 and 24, and the other may be coupled to the switching mechanism 46.

The liquid discharge device 11 may include one of the first valve mechanism 21 and the second valve mechanism 28. The liquid discharge device 11 may supply the liquid by controlling the pressurizing pump 20, the depressurizing pump 27, the pressure release valve 22, the negative pressure release valve 29, and the like.

In the first upstream chamber 61, a pressure receiving area of the second flexible film 65 may be different from a pressure receiving area of the first valve portion 73. In the second downstream chamber 82, a pressure receiving area of the fourth flexible film 85 may be different from a pressure receiving area of the second valve portion 93. The pressure receiving areas of the first valve mechanism 21 and the second valve mechanism 28 may be adjusted according to a posture, a type of fluid to be handled, ease of deformation of the second flexible film 65 or the fourth flexible film 85, and the like.

The first shaft portion 72 and the second flexible film 65 may be integrally formed. The second shaft portion 92 and the fourth flexible film 85 may be integrally formed.

A configuration may be used in which only the pressure adjustment valve is provided without circulation.

A configuration may be used in which only the negative pressure adjustment valve is provided as the valve mechanism without circulation.

A configuration may be used in which the negative pressure release valve (the self-sealing valve) and the negative pressure adjustment valve are provided with circulation. In this case, it is possible to perform, under the same control, standby stop, power supply OFF, cleaning, ink removal in a head, a forced circulation, and an air bubble discharge during printing.

Since the pressure release valve is provided with the air chamber and can be switched between three states similarly to the pressure control valve and other valves,
the switching mechanism may not be the selector valve. The pressure adjustment valves 36 and 37 may be switched by opening and closing individual switching dedicated valves provided for the respective pressure adjustment valves 36 and 37.

Although all of the pressure adjustment targets are controlled by the selector valve, which is an example of the switching mechanism 46, a part of the pressure adjustment targets may be controlled by certain component other than the selector valve.

The pressurizing pump 20 for circulation may be shared among the pressurized targets. The depressurizing pump 27 for circulation may be shared among the depressurized targets. For example, the pressurized targets are the first liquid storage portion 17 and the second liquid storage portion 24, and the depressurized targets are the first liquid storage portion 17 and the second liquid storage portion 24. The destination of the pressurized air (the positive pressure) from the pressurizing pump 20 may be selected by opening and closing valves provided in the gas channels coupling the pressurizing pump 20 to each of the first liquid storage portion 17 and the second liquid storage portion 24. The destination of the depressurized air (the negative pressure) from the depressurizing pump 27 may be selected by opening and closing valves provided in the gas channels coupling the depressurizing pump 27 to each of the first liquid storage portion 17 and the second liquid storage portion 24.

In each of the embodiments and the modifications, the fluid is a liquid, and the fluid may be a gas. The fluid discharge device may be a gas discharge device that discharges a gas. In this case, the gas discharge device includes a gas storage portion as an example of a fluid storage portion, a gas discharge unit as an example of a fluid discharge unit, and a gas channel coupling the gas storage portion and the gas discharge unit. The gas discharge device includes a valve mechanism provided in the gas channel. The valve mechanism may include an air chamber, and may be implemented to be switchable between the adjustment state and the open state by switching the pressure supplied to the air chamber. The valve mechanism may include an opening and closing portion having a magnetic force, and may be implemented to be switchable between the adjustment state and the open state depending on presence or absence of the magnetic force from the outside acting on the opening and closing portion.

The first valve mechanism 21 may be used as the negative pressure release valve 29. The second valve mechanism 28 may be used as the pressure release valve 22. The third valve mechanism 125 may be used as the negative pressure release valve 29. The fourth valve mechanism 160 may be used as the pressure release valve 22. Therefore, each of the valve mechanisms 21, 28, 125, and 160 may handle the gas as the fluid.

The pressure release valve 22 may be replaced with an air release valve. In this case, a detection unit such as a pressure sensor that detects the pressure in the first liquid storage portion 17 may be provided, and the air release valve may be opened when a detected pressure of the detection unit exceeds a set pressure. After the air release valve is opened, the air release valve is closed when the detected pressure of the detection unit is reduced to a set pressurized pressure or a pressurized pressure lower limit, the air release valve is closed. Similarly, an air release valve may be used instead of the negative pressure release valve 29. In this case, a detection unit such as a pressure sensor that detects the pressure in the second liquid storage portion 24 may be provided, and the air release valve may be opened when a detected pressure of the detection unit exceeds a set negative pressure on the negative side. After the air release valve is opened, the air release valve is closed when the detected pressure of the detection unit is increased to a set negative pressure or a negative pressure upper limit, the air release valve is closed.

The liquid discharge device 11 can be a liquid discharge device that ejects or discharges other liquids than an ink. The state of the liquid to be discharged from the liquid discharge device as a minute amount of droplet includes a particle state, a teardrop state, and a state of tailing like a thread. The liquid described here is only required to be a material which can be discharged from the liquid discharge device. For example, the liquid is only required to be in a liquid state of a substance, and includes a liquid material high or low in viscosity, sol, gel water, other inorganic solvents, organic solvents, solutions, and a fluid material such as liquid resin, liquid metal, and metal melt. The liquid includes not only the liquid as a state of a substance, but also a liquid in which particles of a functional material made of a solid such as a pigment or a metal particle are dissolved, dispersed, or mixed in a solvent. Representative examples of the liquid include the ink and the liquid crystal as described in the above embodiments. Here, the ink includes various types of liquid compositions such as general water-based ink, oil-based ink, gel ink, and hot melt ink. As a specific example of the liquid discharge device, there is a device that discharges a liquid containing a material such as an electrode material or a coloring material used in, for example, manufacture of a liquid crystal display, an electroluminescence display, a surface-emitting display, and a color filter in a dispersed or dissolved form. The liquid discharge device can be a device that discharges a bioorganic substance used for manufacturing a biochip, a device that is used as a precision pipette and discharges a liquid to be a sample, a textile printing device, a micro dispenser, or the like. The liquid discharge device can be a device that discharges lubricating oil to a precision machine such as a timepiece or a camera in a pinpoint manner, or a device that discharges a transparent resin liquid such as ultraviolet curing resin onto a substrate in order to form a minute hemispherical lens, an optical lens, or the like used for an optical communication element or the like. The liquid discharge device may be a device that discharges an etching solution such as acid or alkali in order to etch a substrate or the like.

### Definition

The expression “at least one” used in this specification means “one or more” of desired alternatives. For example, the expression “at least one” used in the present specification means “either one of alternatives” or “both of two alternatives” when the number of the alternatives is two. As another example, the expression “at least one” used in the present specification means “just one alternative” or “a combination of any two or more alternatives” when the number of the alternatives is three or more.

### Appendices

In the following description, technical ideas understood from the embodiments and the modifications described above and operational effects thereof will be described.

(A) A valve mechanism includes: an upstream chamber into which a fluid flows via an inflow port; a downstream chamber that is located downstream of the upstream chamber and communicates with the upstream chamber via a communication port; an air chamber that can communicate with an external space; a first flexible film that separates the downstream chamber and the air chamber from each other; a second flexible film that separates the upstream chamber and the downstream chamber from each other; an opening and closing portion that can open and close the communication port; and a biasing portion that biases the first flexible film in a direction in which a volume of the downstream chamber decreases. The opening and closing portion is provided across the upstream chamber and the downstream chamber and has a shaft portion that is movable following a displacement of the first flexible film and the second flexible film, and a valve portion that is coupled to the shaft portion and opens and closes the communication port.

According to the configuration, since the air chamber is provided, the pressure can be applied via the air chamber. Therefore, the state of the opening and closing portion can be switched between the adjustment state in which the output pressure is adjusted to a set pressure (constant) and the open state in which the output pressure is adjusted to a pressure higher than the set pressure by maintaining the fluid channel in the open state. Therefore, the fluid can be made to flow by changing the pressure and the flow rate according to the control state.

(B) A valve mechanism includes: an upstream chamber into which a fluid flows via an inflow port; a downstream chamber that is located downstream of the upstream chamber and communicates with the upstream chamber via a communication port; an air chamber that can communicate with an external space; a first flexible film that separates the upstream chamber and the air chamber from each other; a second flexible film that separates the upstream chamber and the downstream chamber from each other; an opening and closing portion that can open and close the communication port; and a biasing portion that biases the first flexible film in a direction in which a volume of the upstream chamber is increased. The opening and closing portion is provided across the upstream chamber and the downstream chamber and has a shaft portion that is movable following a displacement of the first flexible film and the second flexible film, and a valve portion that is coupled to the shaft portion and opens and closes the communication port.

According to the configuration, since the air chamber is provided, the pressure can be applied via the air chamber. Therefore, the state of the opening and closing portion can be switched between the adjustment state in which the output pressure is adjusted to a set pressure (constant) and the open state in which the output pressure is adjusted to a pressure lower than the set pressure by maintaining the fluid channel in the open state. Therefore, the fluid can be made to flow by changing the pressure and the flow rate according to the control state.

(C) A valve mechanism includes: an upstream chamber into which a fluid flows via an inflow port; a downstream chamber that is located downstream of the upstream chamber and communicates with the upstream chamber via a communication port; an air chamber that can communicate with an external space; a first flexible film that separates the downstream chamber and the air chamber from each other; a second flexible film that separates the upstream chamber and the downstream chamber from each other; an opening and closing portion that can open and close the communication port; and a biasing portion that biases the first flexible film in a direction in which a volume of the downstream chamber is increased. The opening and closing portion is provided across the upstream chamber and the downstream chamber and has a shaft portion that is movable in response to a displacement of the first flexible film and the second flexible film, and a valve portion that is coupled to the shaft portion and opens and closes the communication port.

According to the configuration, since the air chamber is provided, the pressure can be applied via the air chamber. Therefore, the state of the opening and closing portion can be switched between the adjustment state in which the output pressure is adjusted to a set pressure (constant) and the open state in which the output pressure is adjusted to a pressure higher than the set pressure by maintaining the fluid channel in the open state. Therefore, the fluid can be made to flow by changing the pressure and the flow rate according to the control state.

(D) A valve mechanism includes: an upstream chamber into which a fluid flows via an inflow port; a downstream chamber that includes a first flexible film and that is located downstream of the upstream chamber and communicates with the upstream chamber via a communication port; a second flexible film that separates the upstream chamber and the downstream chamber from each other; an opening and closing portion that can open and close the communication port; and a biasing portion that biases the first flexible film in a direction in which a volume of the downstream chamber decreases. The opening and closing portion is provided across the upstream chamber and the downstream chamber and has a shaft portion that is movable in response to a displacement of the first flexible film and the second flexible film, and a valve portion that is coupled to the shaft portion and opens and closes the communication port, and the opening and closing portion has a magnetic force.

According to the configuration, since the opening and closing portion has a magnetic force, the magnetic force can be applied. Therefore, the state of the opening and closing portion can be switched between the adjustment state in which the output pressure is adjusted to a set pressure (constant) and the open state in which the output pressure is adjusted to a pressure higher than the set pressure by maintaining the channel in the open state. Therefore, the fluid can be made to flow by changing the pressure and the flow rate according to the control state.

(E) A valve mechanism includes: an upstream chamber that includes a first flexible film and into which a fluid flows via an inflow port; a downstream chamber that includes a first flexible film and that is located downstream of the upstream chamber and communicates with the upstream chamber via a communication port; a second flexible film that separates the upstream chamber and the downstream chamber from each other; an opening and closing portion that can open and close the communication port; and a biasing portion that biases the first flexible film in a direction in which a volume of the upstream chamber is increased. The opening and closing portion includes a shaft portion that is provided across the upstream chamber and the downstream chamber and is movable following displacement of the first flexible film and the second flexible film, and a valve portion that is coupled to the shaft portion and opens and closes the communication port, and the opening and closing portion has a magnetic force.

According to the configuration, since the opening and closing portion has a magnetic force, the magnetic force can be applied. Therefore, the state of the opening and closing portion can be switched between the adjustment state in which the output pressure is adjusted to a set pressure (constant) and the open state in which the output pressure is adjusted to a pressure higher than the set pressure by maintaining the channel in the open state. Therefore, the fluid can be made to flow by changing the pressure and the flow rate according to the control state.

(F) A valve mechanism includes: an upstream chamber into which a fluid flows via an inflow port; a downstream chamber that includes a first flexible film and that is located downstream of the upstream chamber and communicates with the upstream chamber via a communication port; a second flexible film that separates the upstream chamber and the downstream chamber from each other; an opening and closing portion that can open and close the communication port; and a biasing portion that biases the first flexible film in a direction in which a volume of the downstream chamber is increased. The opening and closing portion is provided across the upstream chamber and the downstream chamber and has a shaft portion that is movable following a displacement of the first flexible film and the second flexible film, and a valve portion that is coupled to the shaft portion and opens and closes the communication port, and the opening and closing portion has a magnetic force.

According to the configuration, since the opening and closing portion has a magnetic force, the magnetic force can be applied. Therefore, the state of the opening and closing portion can be switched between the adjustment state in which the output pressure is adjusted to a set pressure (constant) and the open state in which the output pressure is adjusted to a pressure higher than the set pressure by maintaining the channel in the open state. Therefore, the fluid can be made to flow by changing the pressure and the flow rate according to the control state.

(G) In the valve mechanism according to any one of (A) to (F), the shaft portion may be inserted into the second flexible film, one end of the shaft portion may be coupled to the first flexible film, and the other end of the shaft portion may be coupled to the valve portion. According to the configuration, the shaft portion can move following the first flexible film and the second flexible film. The responsiveness of the valve portion that opens and closes according to a change in a pressure difference between the upstream chamber and the downstream chamber is improved.

(H) In the valve mechanism according to any one of (A) to (C), when an atmospheric pressure is applied to an outer side of the first flexible film, the valve mechanism may be in an adjustment state in which a pressure is adjusted. According to the configuration, the pressure can be adjusted by simply opening the outside of the first flexible film (the air chamber) to the atmosphere. Therefore, the pressure of the fluid can be easily controlled by the valve mechanism.

(I) In the valve mechanism according to any one of (D) to (F), when a magnetic force from the outside is not applied to the opening and closing portion, the valve mechanism may be in an adjustment state in which a pressure is adjusted. According to the configuration, the pressure can be adjusted by simply removing the magnetic force acting from the outside on the opening and closing portion. Therefore, the pressure of the fluid can be easily controlled by the valve mechanism.

(J) A fluid flow device includes: the valve mechanism disclosed in the above (A); a fluid storage portion that stores a fluid; a fluid channel coupled to the fluid storage portion and provided with the valve mechanism; a pressure varying mechanism that varies a pressure of the fluid flowing through the fluid channel; and a pressure generating unit that applies a pressure into the air chamber. According to the configuration, it is possible to cause the fluid to flow in the fluid channel by changing the pressure or the flow rate to a pressure or a flow rate according to the control state.

(K) A fluid flow device includes: the valve mechanism disclosed in the above (B); a fluid storage portion that stores a fluid; a fluid channel coupled to the fluid storage portion and provided with the valve mechanism; a pressure varying mechanism that varies a pressure of the fluid flowing through the fluid channel; and a pressure generating unit that applies a pressure into the air chamber. According to the configuration, it is possible to cause the fluid to flow in the fluid channel by changing the pressure or the flow rate to a pressure or a flow rate according to the control state.

(L) A fluid flow device includes: the valve mechanism disclosed in the above (C); a fluid storage portion that stores a fluid; a fluid channel coupled to the fluid storage portion and provided with the valve mechanism; a pressure varying mechanism that varies a pressure of the fluid flowing through the fluid channel; and a pressure generating unit that applies a pressure into the air chamber. According to the configuration, it is possible to cause the fluid to flow by changing the pressure or the flow rate according to the control state.

(M) A fluid flow device includes: the valve mechanism disclosed in the above (D); a fluid storage portion that stores a fluid; a fluid channel coupled to the fluid storage portion and provided with the valve mechanism; a pressure varying mechanism that varies a pressure of the fluid flowing through the fluid channel; and a magnetic force generating portion that applies a magnetic force to the opening and closing portion. According to the configuration, by applying the magnetic force to the opening and closing portion, the fluid can be made to flow by changing the pressure and the flow rate according to the control state.

(N) A fluid flow device includes: the valve mechanism disclosed in the above (E); a fluid storage portion that stores a fluid; a fluid channel coupled to the fluid storage portion and provided with the valve mechanism; a pressure varying mechanism that varies a pressure of the fluid flowing through the fluid channel; and a magnetic force generating portion that applies a magnetic force to the opening and closing portion. According to the configuration, by applying the magnetic force to the opening and closing portion, the fluid can be made to flow by changing the pressure and the flow rate according to the control state.

(O) A fluid flow device includes: the valve mechanism disclosed in the above (F); a fluid storage portion that stores a fluid; a fluid channel coupled to the fluid storage portion and provided with the valve mechanism; a pressure varying mechanism that varies a pressure of the fluid flowing through the fluid channel; and a magnetic force generating portion that applies a magnetic force to the opening and closing portion. According to the configuration, by applying the magnetic force to the opening and closing portion, the fluid can be made to flow by changing the pressure and the flow rate according to the control state.

(P) In the fluid flow device according to (J) or (L), the valve mechanism is a first valve mechanism, the inflow port is a first inflow port, the upstream chamber is a first upstream chamber, the communication port is a first communication port, the downstream chamber is a first downstream chamber, the air chamber is a first air chamber, the opening and closing portion is a first opening and closing portion, the biasing portion is a first biasing portion, the shaft portion is a first shaft portion, and the valve portion is a first valve portion, and the fluid flow device includes a second valve mechanism, the second valve mechanism includes a second upstream chamber into which a fluid flows via a second inflow port, and a second downstream chamber that is located downstream of the second upstream chamber and communicates with the second upstream chamber via a second communication port; a second air chamber capable of communicating with an external space, a third flexible film that separates the second upstream chamber and the second air chamber, a fourth flexible film that separates the second upstream chamber and the second downstream chamber, a second opening and closing portion capable of opening and closing the second communication port, and a biasing portion that biases the third flexible film in a direction in which a volume of the second upstream chamber is increased. The second opening and closing portion may include a second shaft portion provided across the second upstream chamber and the second downstream chamber and that is movable following a displacement of the third flexible film and the fourth flexible film, and a second valve portion coupled to the second shaft portion and opens and closes the second communication port. According to the configuration, by applying pressure to the air chamber, the pressure and flow rate can be changed according to the control state.

(Q) In the fluid flow device according to (M) or (N), the valve mechanism is a first valve mechanism, the inflow port is a first inflow port, the upstream chamber is a first upstream chamber, the communication port is a first communication port, the downstream chamber is a first downstream chamber, and the opening and closing portion is a first opening and closing portion, the biasing portion is a first biasing portion, the shaft portion is a first shaft portion, and the valve portion is a first valve portion, and the fluid flow device includes a second valve mechanism. The second valve mechanism has a third flexible film and includes a second upstream chamber into which a fluid flows via a second inflow port, and a second downstream chamber that is located downstream of the second upstream chamber and communicates with the second upstream chamber via a second communication port, a fourth flexible film that separates the second upstream chamber and the second downstream chamber, a second opening and closing portion that can opens and closes the second communication port, and a biasing portion that biases the third flexible film in a direction in which a volume of the second downstream chamber is increased. The second opening and closing portion may include a second shaft portion provided across the second upstream chamber and the second downstream chamber and that is movable following a displacement of the third flexible film and the fourth flexible film, and a second valve portion that is coupled to the second shaft portion and opens and closes the second communication port, and the second opening and closing portion may have a magnetic force. According to the configuration, by applying a magnetic force to the opening and closing portion, the pressure and flow rate can be changed according to the control state.

(R) A fluid discharge device includes the fluid flow device according to any one of (J) to (O), and a fluid discharge unit provided in the fluid channel. According to the configuration, it is possible to cause the fluid to flow by changing the pressure or the flow rate according to the control state.

(S) A fluid discharge device includes: the fluid flow device according to (P); and a fluid discharge unit capable of discharging the fluid. The fluid channel includes a first fluid channel having a downstream end coupled to the fluid discharge unit and a second fluid channel having an upstream end coupled to the fluid discharge unit, the first valve mechanism is located in the first fluid channel, and the second valve mechanism is located in the second fluid channel.

According to the configuration, by switching the valve mechanisms by controlling the air pressure, the pressure of the fluid flowing into the fluid discharge unit and the pressure of the fluid flowing out of the fluid discharge unit can be changed to pressures and flow rates according to the control state.

(T) A fluid discharge device includes: the fluid flow device according to (R); and a fluid discharge unit capable of discharging the fluid. The fluid channel includes a first fluid channel having a downstream end coupled to the fluid discharge unit and a second fluid channel having an upstream end coupled to the fluid discharge unit, the first valve mechanism is located in the first fluid channel, and the second valve mechanism is located in the second fluid channel.

According to the configuration, by switching the valve mechanisms by the action of the magnetic force, the pressure of the fluid flowing into the fluid discharge unit and the pressure of the fluid flowing out of the fluid discharge unit can be changed to pressures and flow rates according to the control state.

(U) A fluid discharge device includes: a fluid discharge unit that discharges a fluid; a first fluid storage portion that stores the fluid; a second fluid storage portion that stores the fluid; a first fluid channel that couples the first fluid storage portion and the fluid discharge unit; a second fluid channel that couples the second fluid storage portion and the fluid discharge unit; a pressure varying mechanism that varies a pressure of the fluid stored in the first fluid storage portion and the second fluid storage portion; a first pressure adjustment valve provided in the first fluid channel; and a second pressure adjustment valve provided in the second fluid channel; and a switching unit capable of switching states of the first pressure adjustment valve and the second pressure adjustment valve. The first pressure adjustment valve is switchable between a first adjustment state in which a pressure downstream of the first pressure adjustment valve in the first fluid channel path is adjusted to a first set pressure, and a first open state in which the pressure downstream of the first pressure adjustment valve is adjusted to a pressure higher than the first set pressure by maintaining a state in which the first fluid channel is opened, and the second pressure adjustment valve is switchable between a second adjustment state in which a pressure upstream of the second pressure adjustment valve in the second fluid channel is adjusted to a second set pressure, and a second open state in which the pressure upstream of the second pressure adjustment valve is adjusted to a pressure lower than the second set pressure by maintaining a state in which the second fluid channel is opened. According to the configuration, by providing the pressure adjustment valves capable of switching between the adjustment state and the open state to circulate the fluid, the fluid can be circulated at a pressure and a flow rate according to the control state.

(V) In the fluid discharge device according to (U), the states of the first pressure adjustment valve and the second pressure adjustment valve may be switched by a magnetic force applied by the switching unit. According to the configuration, the state can be easily switched by the action of the magnetic force.

(W) In the fluid discharge device according to (U), the states of the first pressure adjustment valve and the second pressure adjustment valve may be switched by a pressure applied by the switching unit. According to the configuration, the state can be easily switched by the action of the pressure.

(X) In the fluid discharge device according to any one of (U) to (W), the first pressure adjustment valve may be switchable to a first closed state in which a closed state of the first fluid channel is maintained, and the second pressure adjustment valve may be switchable to a second closed state in which a closed state of the second fluid channel is maintained. According to the configuration, it is possible to close the channel in a control state in which the supply to the fluid discharge unit and the collection from the fluid discharge unit are not performed.

(Y) In the fluid discharge device according to (W), the switching unit may include a first gas channel coupled to the first pressure adjustment valve, a second gas channel coupled to the second pressure adjustment valve, a third gas channel through which a pressurized gas flows, a fourth gas channel through which a depressurized gas flows, and a switching mechanism that switches a coupling state between the gas channels. According to the configuration, since the switching unit can be shared by the first pressure adjustment valve and the second pressure adjustment valve, the fluid discharge device can be downsized.

(Z) In the fluid discharge device according to the above (Y), the pressure varying mechanism may include a pressurizing pump that pressurizes the first fluid storage portion, and a depressurizing pump that depressurizes the second fluid storage portion, the third gas channel allows the gas pressurized by the pressurizing pump to flow therethrough, and the fourth gas channel allows the gas depressurized by the depressurizing pump to flow therethrough. According to the configuration, the configuration can be simplified by using a pressurizing force or a depressurizing force of the pressurizing pump or the depressurizing pump for circulation. The device can be downsized.

(ZA) In the fluid discharge device according to (Z), the first pressure adjustment valve may be in the first open state when the first gas channel and the third gas channel are coupled, and the second pressure adjustment valve may be in the second open state when the second gas channel and the fourth gas channel are coupled.

According to the configuration, by coupling the first gas channel and the third gas channel and coupling the second gas channel and the fourth gas channel according to the control state, the channel can be set to the open state. Therefore, the fluid can be circulated at a pressure other than the set pressure.

(ZB) In the fluid discharge device according to (ZA), the first pressure adjustment valve may be switchable to a first closed state in which a closed state of the first fluid channel is maintained, and may be set to the first closed state when the first gas channel and the fourth gas channel are coupled, and the second pressure adjustment valve may be switchable to a second closed state in which a closed state of the second fluid channel is maintained, and may be set to the second closed state when the second gas channel and the third gas channel are coupled. According to the configuration, by coupling the first gas channel and the fourth gas channel and coupling the second gas channel and the third gas channel according to the control state, the channel can be set to the closed state.

(ZC) In the fluid discharge device according to any one of (Y), (Z), (ZA), and (ZB), the switching unit may include a fifth gas channel that is opened to an atmosphere, the first pressure adjustment valve may be in the first adjustment state when the first gas channel and the fifth gas channel are coupled, and the second pressure adjustment valve may be in the second adjustment state when the second gas channel and the fifth gas channel are coupled. According to the configuration, the adjustment state can be achieved simply by opening to the atmosphere. Therefore, the switching from the open state to the adjustment state can be simplified.

What is claimed is:

1. A fluid discharge device comprising:
a fluid discharge unit configured to discharge a fluid;
a first fluid storage portion configured to store a fluid;
a second fluid storage portion configured to store a fluid;
a first fluid channel coupling the first fluid storage portion and the fluid discharge unit;
a second fluid channel coupling the second fluid storage portion and the fluid discharge unit;
a pressure varying mechanism configured to vary pressures of the fluids stored in the first fluid storage portion and the second fluid storage portion;
a first pressure adjustment valve provided in the first fluid channel;
a second pressure adjustment valve provided in the second fluid channel; and
a switching unit configured to switch states of the first pressure adjustment valve and the second pressure adjustment valve, wherein
the first pressure adjustment valve is switchable between
a first adjustment state in which a pressure downstream of the first pressure adjustment valve in the first fluid channel is adjusted to a first set pressure, and
a first open state in which the pressure downstream of the first pressure adjustment valve is adjusted to a pressure higher than the first set pressure by maintaining the first fluid channel in an open state, and
the second pressure adjustment valve is switchable between
a second adjustment state in which a pressure upstream of the second pressure adjustment valve in the second fluid channel is adjusted to a second set pressure, and
a second open state in which the pressure upstream of the second pressure adjustment valve is adjusted to a pressure lower than the second set pressure by maintaining the second fluid channel in an open state.

2. The fluid discharge device according to claim 1, wherein
the states of the first pressure adjustment valve and the second pressure adjustment valve are switched by a magnetic force applied by the switching unit.

3. The fluid discharge device according to claim 1, wherein
the states of the first pressure adjustment valve and the second pressure adjustment valve are switched by a pressure applied by the switching unit.

4. The fluid discharge device according to claim 1, wherein
the first pressure adjustment valve is switchable to a first closed state in which a closed state of the first fluid channel is maintained, and
the second pressure adjustment valve is switchable to a second closed state in which a closed state of the second fluid channel is maintained.

5. The fluid discharge device according to claim 3, wherein
the switching unit includes
a first gas channel coupled to the first pressure adjustment valve,
a second gas channel coupled to the second pressure adjustment valve,
a third gas channel through which a pressurized gas flows,
a fourth gas channel through which a depressurized gas flows, and
a switching mechanism that switches a coupling state between the gas channels.

6. The fluid discharge device according to claim 5, wherein
the pressure varying mechanism includes
a pressurizing pump that pressurizes the first fluid storage portion, and
a depressurizing pump that depressurizes the second fluid storage portion,
the third gas channel allows the gas pressurized by the pressurizing pump to flow therethrough, and
the fourth gas channel allows the gas depressurized by the depressurizing pump to flow therethrough.

7. The fluid discharge device according to claim 5, wherein
the first pressure adjustment valve gets to the first open state when the first gas channel and the third gas channel are coupled, and
the second pressure adjustment valve gets to the second open state when the second gas channel and the fourth gas channel are coupled.

8. The fluid discharge device according to claim 7, wherein
the first pressure adjustment valve is switchable to a first closed state in which a closed state of the first fluid channel is maintained, and gets to the first closed state when the first gas channel and the fourth gas channel are coupled, and
the second pressure adjustment valve is switchable to a second closed state in which a closed state of the second fluid channel is maintained, and gets to the second closed state when the second gas channel and the third gas channel are coupled.

9. The fluid discharge device according to claim 5, wherein
the switching unit includes a fifth gas channel that is opened to an atmosphere,
the first pressure adjustment valve gets to the first adjustment state when the first gas channel and the fifth gas channel are coupled, and
the second pressure adjustment valve gets to the second adjustment state when the second gas channel and the fifth gas channel are coupled.
